(19) United States
(12) Patent Application Publication
(10) Pub. No.: US 2008/0146772 A1
(43) Pub. Date: Jun. 19, 2008

(54) MATERIALS AND METHODS FOR CO-CRYSTAL CONTROLLED SOLID-STATE SYNTHESIS OF IMIDES AND IMINES

(75) Inventors: Michael J. Zaworotko, Tampa, FL (US); Miranda L. Cheney, Tampa, FL (US)

Correspondence Address: SENNIGER POWERS LLP, ONE METROPOLITAN SQUARE, 16TH FLOOR, ST LOUIS, MO, 63102, US

(73) Assignee: UNIVERSITY OF SOUTH FLORIDA, Tampa, FL (US)

(21) Appl. No.: 11/934,230

(22) Filed: Nov. 2, 2007

Related U.S. Application Data
(60) Provisional application No. 60/856,424, filed on Nov. 2, 2006.

(51) Int. Cl. C08G 69/02; C08G 73/10

(52) U.S. Cl. 528/332

(57) ABSTRACT

The subject invention pertains to methods for solid-state synthesis of imides and imines using co-crystals. The co-crystal formers utilized are substrates of condensation reactions and co-crystals can be obtained in high yield via methods such as slurrying, solvent evaporation, solvent crystallization, treatment with supercritical fluid(s), melting plus crystallization, slurry conversion, grinding of solids, blending of powders, heating of solids, solvent-drop grinding, or grinding plus melting.

### BACKGROUND OF THE INVENTION

A co-crystal is a species of a solid-phase composition that is a multiple component crystal in which all components are solid under ambient conditions when in their pure form. In solid-phase compositions these components consist of a target molecule or ion and a molecular co-crystal former(s) and when in a co-crystal they coexist at the molecular level within a single crystal.

Solid-phase compositions, such as co-crystals that comprise two or more molecules (co-crystal formers) (Almarsson et al., 2004) that are solids under ambient conditions represent a long-known (Wöhler, 1844) class of compositions. However, they remain relatively unexplored. A Cambridge Structural Database (CSD) (Allen et al., 1993) survey reveals that they represent less than 0.5% of published crystal structures. Nevertheless, their potential impact upon pharmaceutical formulation (Vishweshwar et al., 2006; Li et al., 2006; Remenar et al., 2003; Childs et al., 2004) and green chemistry (Anastas et al. 1998) is of topical and growing interest. In particular, that all components are solids under ambient conditions has important practical considerations since synthesis of co-crystals can be achieved via solid-state techniques (mechanochemistry) (Shan et al., 2002), and chemists can execute a degree of control over the composition of a co-crystal since they can invoke molecular recognition, especially hydrogen bonding, during the selection of co-crystal formers. These features distinguish solid-phase compositions, such as co-crystals, from another broad and well-known group of multiple component compounds—solvates. Solvates are much more widely characterized than co-crystals (1642 co-crystals are reported in the Cambridge Structural Database versus 10575 solvates; version 5.27 (May 2006) 3D coordinates, R<0.075, no ions, organics only), although this could change since most molecular compounds are solids under ambient conditions.

Whereas solid-state organic synthesis represents a well-established area of research (Tanaka et al., 2003; Tanaka et al., 2000; Kaupp et al., 2005), co-crystal controlled solid-state synthesis is limited to photodimerizations or photopolymerizations (MacGillivray et al., 2000; Fowler et al., 2000) and nucleophilic substitution (Etter et al., 1989). In the case of photodimerizations or photopolymerizations, one co-crystal former typically serves to align or “template” the reactant, which is the other co-crystal former. In the case of the nucleophilic substitution, both co-crystal formers are reactants; although there are examples of solid-state reactions in which the reactive moieties are in the same molecule and therefore generate polymeric structures (Foxman et al., 2000).

An increasingly important subset of co-crystals is pharmaceutical co-crystals, or co-crystals in which the target molecule or ion is an active pharmaceutical ingredient (API). The API typically bonds to the co-crystal former(s) through hydrogen bonds. Imides and imines are chemical moieties that are prevalent in biologically active molecules, such as pharmaceuticals. In fact, almost 200 imines and imides are listed in the Merck Index as biologically active (Merck Index, 13^{th} Edition, CD-version 13.4). Current preparation methods of imides and imines often leave unwanted by-products and may have yields that are lower than desired. Synthesis of imides and imines obtained in high yields and with little or no harmful by-products would be very advantageous and could lead to new biologically active compounds or better ways to prepare existing pharmaceuticals.

### BRIEF SUMMARY OF THE INVENTION

Among the various aspects of the present invention is the provision of processes for the preparation of condensation reaction products from solid-phase combinations of reactants and co-crystal compositions comprising combinations of reactants. One aspect of the subject invention concerns methods for solid-state synthesis of imides and imines using co-crystals. The co-crystal formers utilized are substrates of condensation reactions and they form co-crystals in high yield via methods such as slurrying, solvent evaporation, solvent crystallization, treatment with supercritical fluid(s), melting plus crystallization, slurry conversion, grinding of solids, blending of powders, heating of solids, melt crystallographic methods, solvent-drop grinding, or grinding/melting. Co-crystal controlled solid-state synthesis of imides occurs via co-crystals formed between anhydride and aromatic amine co-crystal formers, while co-crystal controlled solid-state synthesis of imines occurs via co-crystals formed between carbonyl and aromatic amine co-crystal formers. These methods are “green chemistry” approaches that leave very little unwanted by-products

Briefly, therefore, one aspect of the present invention is directed to a process for the preparation of a condensation reaction product and a small molecule by-product. The process comprises inducing a condensation reaction between a first reactant and a second reactant wherein the first and second reactants are different and members of a solid-phase combination.

The present invention is further directed to a co-crystal comprising a first reactant and a second reactant, the first and second reactants being different and capable of reacting in a condensation reaction to produce a condensation reaction product and a small molecule by-product.

Other objects and features will be in part apparent and in part pointed out hereinafter.

### BRIEF DESCRIPTION OF THE DRAWINGS

FIGS. 1A-1D show the reaction of 5-amino-1,3-benzenedicarboxylic acid and 1,4,5,8-naphthalenetetracarboxylic dianhydride (FIG. 1A), and the Thermogravimetric Analysis (TGA) results for that reaction (FIG. 1B), Infrared Spectroscopy (IR) results for that reaction (FIG. 1C), and Power X-Ray Diffraction (PXRD) results for that reaction (FIG. 1D).

FIGS. 2A-2C show the reaction of melamine and pyromellitic anhydride (FIG. 2A), the IR results for that reaction (FIG. 2B), and the PXRD results for that reaction (FIG. 2C) where the product is identified as mc331.

FIGS. 3A-3C show the reaction of 1,4-phenylenediamine and pyromellitic anhydride (FIG. 3A), the IR results for that reaction (FIG. 3B), and the PXRD results for that reaction (FIG. 3C) where the product is identified as mc335.

FIGS. 4A-4C show the reaction of 1,4-phenylenediamine and 3,3′,4,4′-biphenyltetracarboxylic dianhydride (FIG. 4A), the IR results for that reaction (FIG. 4B), and the PXRD results for that reaction (FIG. 4C) where the product is identified as mc347.

FIGS. 5A-5C show the reaction of triphenylmethylamine and 3,3′,4,4′-biphenyltetracarboxylic dianhydride (FIG. 5A), the IR results for that reaction (FIG. 5B), and the PXRD results for that reaction (FIG. 5C) where the product is identified as mc3725.

FIGS. 6A-6D show the reaction of 1-adamantylamine and maleic anhydride (FIG. 6A), the TGA results for that reaction (FIG. 6B), the, the IR results for that reaction (FIG. 6C), and the PXD results for that reaction (FIG. 6D) where the product is identified as mc3935.

FIGS. 7A-7D show the reaction of 5-amino-1,3-benzenedicarboxylic acid and 1,8-naphthalenedicarboxylic anhydride (FIG. 7A), the TGA results for that reaction (FIG. 7B), the IR results for that reaction (FIG. 7C), and the PXD results for that reaction (FIG. 7D).

FIGS. 8A-8D show the reaction of 3-aminobenzoic acid and 1,4,5,8-naphthalenetetracarboxylic dianhydride (FIG. 8A), the TGA results for that reaction (FIG. 8B), the IR results for that reaction (FIG. 8C), and the PXD results for that reaction (FIG. 8D).

FIGS. 9A-9C show the reaction of 1-adamantylamine and phthalic anhydride (FIG. 9A), the IR results for that reaction (FIG. 9B), and the PXRD results for that reaction (FIG. 9C).

FIGS. 10A-10C show the reaction of triphenylmethylamine and isophthalaldehyde (FIG. 10A), the IR results for that reaction (FIG. 10B), and the PXRD results for that reaction (FIG. 10C) where the product is identified as OG43.25.

FIGS. 11A-11C show the reaction of 1,5-naphthalenediamine and 4-nitrobenzaldehyde (FIG. 11A), the IR results for that reaction (FIG. 11B), and the PXRD results for that reaction (FIG. 11C) where the product is identified as OG43.13.

FIGS. 12A-12C show the reaction of triphenylmethylamine and terephthalaldehyde (FIG. 12A), the IR results for that reaction (FIG. 12B), and the PXRD results for that reaction (FIG. 12C) where the product is identified at OG43.19.

FIGS. 13A-13C show the reaction of triphenylmethylamine and 4-nitrobenzaldehyde (FIG. 13A), the IR results for that reaction (FIG. 13B), and the PXRD results for that reaction (FIG. 13C) where the product is identified as OG43.21.

FIGS. 14A-14C show the reaction of 1,5-naphthalenediamine and isophthaladehyde (FIG. 14A), the IR results for that reaction (FIG. 14B), and the PXRD results for that reaction (FIG. 14C) where the product is identified as OG43.23.

FIGS. 15A-15C show the reaction of 1,4-phenylenediamine and 4-nitrobenzaldehyde (FIG. 15A), the IR results for that reaction (FIG. 15B), and the PXRD results for that reaction.

FIGS. 15D and 15E show the packing diagrams for the two forms of the product of the reaction of 1,4-phenylenediamine and 4-nitrobenzaldehyde (FIG. 15C) where the product is identified as OG43.11.

FIGS. 16A-16D show the reaction of 2,6-lutidine with the product of the reaction of 3-aminobenzoic acid and 1,4,5,8-naphthalenetetracarboxylic dianhydride (FIG. 16A), the TGA results for that reaction (FIG. 16B), the IR results for that reaction (FIG. 16C), and the PXD results for that reaction (FIG. 16D).

FIG. 17A shows the reaction of 2-methyl-4-nitroaniline (MNA) and 1,4,5,8-naphthalenetetracarboxylic dianhydride (NTCDA) to form co-crystal 1 and imide 2.

FIG. 17B shows the IR spectra for the reaction of 2-methyl-4-nitroaniline (MNA) and

1,4,5,8-naphthalenetetracarboxylic dianhydride (NTCDA).

FIG. 17C shows the IR spectra of solvent drop grinds (SDG) for the reaction of 2-methyl-4-nitroaniline (MNA) and 1,4,5,8-naphthalenetetracarboxylic dianhydride (NTCDA) in chloroform, cyclohexane, DMSO, and DMF; all of which resulted in mixtures of NTCDA and MNA except for the DMF solvent drop grind which afforded co-crystal 1.

FIG. 17D shows the IR spectra of solvent drop grinds (SDG) for the reaction of 2-methyl-4-nitroaniline (MNA) and 1,4,5,8-naphthalenetetracarboxylic dianhydride (NTCDA) in ethyl acetate, methanol, toluene, and water. All solvent drop grinds resulted in mixtures of NTCDA and MNA.

FIG. 17E shows the IR spectrum of imide 2 generated from heating the DMF solvent drop grind of NTCDA and MNA for three hours at 180° C. to react the NTCDA and MNA. Imide 2 exhibits shifts in the carbonyl region to lower wavenumbers and shows a loss of NH₂ peaks when compared to pure NTCDA and pure MNA.

FIG. 17F shows the IR spectra of solvent drop grinds (SDG) containing NTCDA and MNA with chloroform, cyclohexane, DMSO, and DMF grinds after heating for three hours at 180° C. to react the NTCDA and MNA. All IR spectra show dehydration of NTCDA and MNA to imide 2.

FIG. 17G shows the IR spectra of solvent drop grinds (SDG) of NTCDA and MNA with ethyl acetate, methanol, toluene, and water after heating for three hours at 180° C. to react the NTCDA and MNA. All IR spectra show dehydration of NTCDA and MNA to imide 2.

FIG. 17H shows X-ray powder diffraction (XPD) patterns of solvent drop grinds for the reaction of 2-methyl-4-nitroaniline (MNA) and 1,4,5,8-naphthalenetetracarboxylic dianhydride (NTCDA) in water, toluene, methanol, ethyl acetate, DMSO, cyclohexane, and chloroform. Solvent drop grinds (SDG) with NTCDA and MNA show that they are mixtures of NTCDA and MNA when compared to the pure NTCDA and pure MNA XPD patterns. The DMF solvent drop grind (co-crystal 1) generates a slightly different XPD than the other solvent drop grinds and is identical to the simulated XPD pattern generated from the crystal structure of co-crystal 1.

FIG. 17I shows XPD patterns of water, toluene, methanol, ethyl acetate, DMSO, DMF, cyclohexane, and chloroform solvent drop grinds (SDG) with NTCDA and MNA after they are heated for three hours at 180° C. to react the NTCDA and MNA. The XPD patterns show formation of a new phase that is different from pure NTCDA and pure MNA.

FIG. 17J shows a UV-vis spectrum for the reaction of 2-methyl-4-nitroaniline (MNA) and 1,4,5,8-naphthalenetetracarboxylic dianhydride (NTCDA) of co-crystal 1 which exhibits a broad band at about 600 nm which is indicative of charge transfer. The methanol solvent drop grind (SDG) of NTCDA and MNA, pure NTCDA, and pure MNA are also shown for comparison.

FIG. 17K shows optical observation coupled with the DSC for the reaction of 2-methyl-4-nitroaniline (MNA) and 1,4,5,8-naphthalenetetracarboxylic dianhydride (NTCDA) of co-crystal 1 and indicates that the phase transition at 158.26° C. can be attributed to the conversion of co-crystal 1 to imide 2.

FIG. 17L shows optical observation coupled with the DSC for the reaction of 2-methyl-4-nitroaniline (MNA) and 1,4,5,8-naphthalenetetracarboxylic dianhydride (NTCDA) of the methanol solvent drop grind (SDG) of NTCDA and MNA and indicates that the phase transition at 129.67° C. was due to the conversion of a mixture of NTCDA and MNA to co-crystal 1. The phase transition at 155.60° C. was indicative of the co-crystal 1 converting to imide 2.

FIG. 17M shows a TGA for the reaction of 2-methyl-4-nitroaniline (MNA) and 1,4,5,8-naphthalenetetracarboxylic dianhydride (NTCDA) of co-crystal 1, and shows weight loss at 41.36° C., 177.68° C., and 315.61° C.

FIG. 17N shows a TGA for the reaction of 2-methyl-4-nitroaniline (MNA) and 1,4,5,8-naphthalenetetracarboxylic dianhydride (NTCDA) of a methanol solvent drop grind (SDG) of NTCDA and MNA which shows weight loss at 184.65° C., 320.24° C., and 331.79° C.

FIG. 18A shows the reaction of 1,4,5,8-naphthalenetetracarboxylic dianhydride (NTCDA) and 3-aminobenzoic acid (ABA) to form co-crystal 3 and imide 4.

FIG. 18B shows the IR spectrum for the reaction of 1,4,5,8-naphthalenetetracarboxylic dianhydride (NTCDA) and 3-aminobenzoic acid (ABA) of the DMF solvent drop grind (SDG) of NTCDA and ABA indicating the formation of co-crystal 3 via shifts in the carbonyl and amine regions when compared to pure NTCDA and pure ABA.

FIG. 18C shows IR spectra for the reaction of 1,4,5,8-naphthalenetetracarboxylic dianhydride (NTCDA) and 3-aminobenzoic acid (ABA) in chloroform, cyclohexane, DMSO, and DMF solvent drop grinds with NTCDA and ABA. The reactant of the DMF solvent drop grind (SDG) of NTCDA and ABA (co-crystal 3) exhibits a shift in the carbonyl and amine region with respect to pure NTCDA and ABA. Additional reactions of solvent drop grinds of NTCDA and ABA resulted in mixtures of NTCDA and ABA.

FIG. 18D shows the IR spectra for the reaction of 1,4,5,8-naphthalenetetracarboxylic dianhydride (NTCDA) and 3-aminobenzoic acid (ABA) in ethyl acetate, methanol, toluene, and water solvent drop grinds (SDG).

FIG. 18E shows an IR spectrum for the reaction of 1,4,5,8-naphthalenetetracarboxylic dianhydride (NTCDA) and 3-aminobenzoic acid (ABA) of imide 4 generated from heating the solvent drop grinds (SDG) of pure NTCDA and pure ABA for 14 hours at 150° C. Imide 4 shows shifts in the carbonyl and amine region comparatively to pure NTCDA and pure ABA.

FIG. 18F shows IR spectra for the reaction of 1,4,5,8-naphthalenetetracarboxylic dianhydride (NTCDA) and 3-aminobenzoic acid (ABA) in NTCDA and ABA solvent drop grinds (SDG) with chloroform, cyclohexane, DMSO, and DMF after heating for 14 hours at 150° C. All solvent drop grinds of NTCDA and ABA resulted in formation of imide 4.

FIG. 18G shows IR spectra for the reaction of 1,4,5,8-naphthalenetetracarboxylic dianhydride (NTCDA) and 3-aminobenzoic acid (ABA) in NTCDA and ABA solvent drop grinds (SDG) with ethyl acetate, methanol, toluene, and water grinds heated for 14 hours at 150° C. Heating of all solvent drop grinds of NTCDA and ABA resulted in formation of imide 4.

FIG. 18H shows and IR spectrum for the reaction of 1,4,5,8-naphthalenetetracarboxylic dianhydride (NTCDA) and 3-aminobenzoic acid (ABA) in the 1,4-Dioxane solvate of co-crystal 3 after heating for 24 hours at 250° C. and indicates conversion of 3 to imide 4. The conversion can be seen by comparison of the similarities found between the heated 1,4-dioxane solvate of the co-crystal and the IR spectrum of the NTCDA and ABA chloroform solvent drop grind (SDG) after heating for 14 hours at 150° C.

FIG. 18I shows XPD patterns for the reaction of 1,4,5,8-naphthalenetetracarboxylic dianhydride (NTCDA) and 3-aminobenzoic acid (ABA) in water, toluene, methanol, ethyl acetate, DMSO, cyclohexane, and chloroform. Solvent drop grinds (SDG) with NTCDA and ABA show that they are mixtures of NTCDA and ABA when compared to the pure NTCDA and ABA XPD patterns. The DMF solvent drop grind (co-crystal 3) generates a slightly different XPD than the other solvent drop grinds.

FIG. 18J shows XPD patterns for the reaction of 1,4,5,8-naphthalenetetracarboxylic dianhydride (NTCDA) and 3-aminobenzoic acid (ABA) in all solvent drip grinds (SDG) heated for 14 hours at 150° C. against starting materials. This illustrates that all grinds converted to the imide.

FIG. 18K shows a UV-vis spectrum for the reaction of 1,4,5,8-naphthalenetetracarboxylic dianhydride (NTCDA) and 3-aminobenzoic acid (ABA) of co-crystal 3 that exhibits a broad band at about 550 nm which is indicative of charge transfer. The methanol solvent drop grind (SDG) of NTCDA and ABA, pure NTCDA, and pure ABA are also shown for comparison.

FIG. 18L shows optical observation coupled with the DSC for the reaction of 1,4,5,8-naphthalenetetracarboxylic dianhydride (NTCDA) and 3-aminobenzoic acid (ABA) of the co-crystal 3 and indicates that the phase transition at 127.34° C. was due to the dehydration of co-crystal 3 to imide 4 (gold).

FIG. 18M shows the DSC for the reaction of 1,4,5,8-naphthalenetetracarboxylic dianhydride (NTCDA) and 3-aminobenzoic acid (ABA) of the methanol solvent drop grind (SDG) of NTCDA and ABA that exhibits two phase transitions at 155.65° C. and 167.52° C.

FIG. 18N shows a TGA for the reaction of 1,4,5,8-naphthalenetetracarboxylic dianhydride (NTCDA) and 3-aminobenzoic acid (ABA) of co-crystal 3 which shows weight loss at 102.17° C., 152.04° C., 324.84° C., 372.44° C., 394.08° C., 422.34° C., and 467.03° C.

FIG. 18O shows a TGA for the reaction of 1,4,5,8-naphthalenetetracarboxylic dianhydride (NTCDA) and 3-aminobenzoic acid (ABA) of methanol solvent drop grind (SDG) with NTCDA and ABA which exhibits weight loss at 165.16° C., 374.34° C., 397.18° C., and 470.69° C.

FIGS. 19A and 19B show the IR results for the reaction of 1,4-phenylenediamine and 9-anthraldehyde (FIG. 19A), and the PXRD results for that reaction (FIG. 19B).

FIGS. 20A and 20B show the IR results for the reaction of 1,5-Naphthalenediamine and 9-anthraldehyde (FIG. 20A), and the PXRD results for that reaction (FIG. 20B).

FIGS. 21A and 21B show the IR results for the reaction of 1-adamantylamine and 9-anthraldehyde (FIG. 21A), and the PXRD results for that reaction (FIG. 21B).

FIGS. 22A and 22B show the IR results for the reaction of 1,4-phenylenediamine and o-nitrocinnamaldehyde (FIG. 22A), and the PXRD results for that reaction (FIG. 22B).

FIGS. 23A and 23B show the IR results for the reaction of 1,5-naphthalenediamine and o-nitrocinnamaldehyde (FIG. 23A), and the PXRD results for that reaction (FIG. 23B).

FIGS. 24A and 24B show the IR results for the reaction of 1-adamantylamine and o-nitrocinnamaldehyde (FIG. 24A), and the PXRD results for that reaction (FIG. 24B).

FIGS. 25A and 25B show the IR results for the reaction of Triphenylmethylamine and o-nitrocinnamaldehyde (FIG. 25A), and the PXRD results for that reaction (FIG. 25B).

### DETAILED DISCLOSURE OF THE INVENTION

The subject invention concerns methods for solid-phase synthesis of condensation reaction products.

The invention further concerns co-crystal compositions comprising co-crystal formers that are substrates of condensation reactions. Condensation reaction products include, but not limited to, imides and polyimides, imines and polyimines, amides and polyamides, secondary amines and diamines, esters and polyesters, lactams and pyrrolidones, and the oligomers or polymers thereof.

The co-crystals from these co-crystal formers can be obtained in high yield via methods such as slurrying, solvent evaporation, solvent crystallization, treatment with supercritical fluid(s), melting plus crystallization, slurry conversion, grinding of solids, blending of powders, heating of solids, melt crystallographic methods, solvent-drop grinding, or grinding/melting.

In one embodiment, two or more solid co-crystal formers are milled, optionally in the presence of a small amount of solvent, or optionally with no solvent at all. This leads to the formation of a co-crystal either directly or by heating. The co-crystal then converts by condensation when heated to form a reaction product. In one embodiment, the reaction product is selected from imides and polyimides, imines and polyimines, amides and polyamides, secondary amines and diamines, esters and polyesters, lactams and pyrrolidones. This reaction gives only a small molecule such as water, an alcohol or hydrochloric acid as a by-product and will have only a very small amount of solvent waste if solvent was used.

Co-crystals can be prepared, for example, via solvent drop grinding, i.e. wherein two or more solid co-crystal formers are milled in the presence of a small amount of solvent (Shan et al., 2002; Trask et al., 2005; Bis et al., 2006). A selected group of anhydrides and primary amines were investigated to determine if they form co-crystals via solvent drop grinding under ambient conditions and if the ground mixtures so obtained can be converted to imides simply by applying heat. The majority of reactants studied were observed to form imides after heating. In a specific embodiment, two combinations of co-crystal formers were isolated as co-crystals that resulted in high yield, low waste formation of imides.

In another embodiment, two or more solid-phase combination formers are milled, optionally in the presence of a small amount of solvent, or optionally with no solvent at all. It is believed that under certain conditions, for example either directly or by heating, this may lead to the formation of a solid-phase combination that is not a co-crystal. Solid-phase combinations can be in the form of, for example, a paste or free-flowing particulate mass. The solid-phase combination can convert by condensation when heated to a reaction product. In one embodiment, the reaction products are selected from imides and polyimides, imines and polyimines, amides and polyamides, secondary amines and diamines, esters and polyesters, lactams and pyrrolidones, and polymers thereof. This reaction gives only a small molecule such as water, an alcohol or hydrochloric acid as a by-product and will have only a very small amount of solvent waste if solvent was used. Solid-phase combinations that are not co-crystals could be prepared, for example, via solvent drop grinding, i.e. wherein two or more solid co-crystal formers are milled in the presence of a small amount of solvent.

A general co-crystal controlled solid-state synthesis reaction for formation of imides from a solid phase combination, such as a co-crystal, is shown in Scheme I:

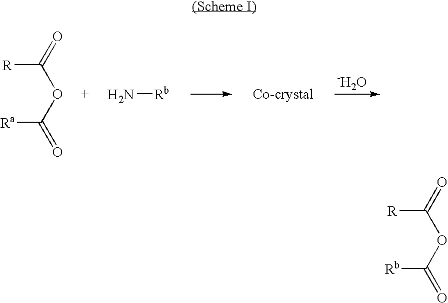

where R and R^{a} each represent, independently, an organic group, including, but not limited to, an aliphatic, an aromatic, a thiol, an amine, an aldehyde, a carboxylic acid, an acid anhydride, or hydrogen, and wherein R and R^{a} optionally can be joined to form a monocyclic or multicyclic ring structure; and where R^{b} represents an organic carbon containing group which is either aromatic or contains one or more aromatic groups and where the aromatic group or groups may contain additional organic carbon containing groups, including, but not limited to, aliphatic groups, thiols, and amines. In one embodiment, R, R^{a}, and R^{b} represents, independently, hydrocarbon or substituted hydrocarbon such as an alkyl, alkoxy, cycloalkyl, cycloalkoxy, aryloxy, alkylcarbonyl, alkoxycarbonyl, cycloalkylcarbonyl, cycloalkoxycarbonyl, heteroalkyl, heterocycloalkyl, heteroaryl, arylcarbonyl, heteroarylcarbonyl, heterocycloalkylcarbonyl, aryloxycarbonyl, heteroaryloxycarbonyl, heterocycloalkoxy, or heterocycloalkoxycarbonyl, any of which can be optionally substituted with alkyl, alkoxy, cycloalkyl, cycloalkoxy, aryloxy, alkylcarbonyl, alkoxycarbonyl, cycloalkylcarbonyl, cycloalkoxycarbonyl, heteroalkyl, heterocycloalkyl, heteroaryl, arylcarbonyl, heteroarylcarbonyl, heterocycloalkylcarbonyl, aryloxycarbonyl, heteroaryloxycarbonyl, heterocycloalkoxy, or heterocycloalkoxycarbonyl, —OH, —NO₂, —NH₂, —COOH, a halogen, and/or —CH₃.

A general co-crystal controlled solid-state synthesis reaction for formation of imines from a solid-phase combination, such as a co-crystal, is shown in Scheme II:

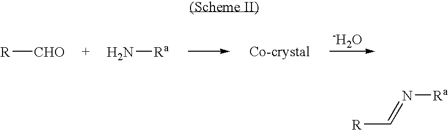

where R represents an organic carbon containing group, including, but not limited to, an aliphatic, an aromatic, a thiol, an amine, an aldehyde, a carboxylic acid, an acid anhydride, or hydrogen, and where R^{a} represents an organic carbon containing group which is either aromatic or contains one or more aromatic groups and where the aromatic group or groups may contain additional organic carbon containing groups, including, but not limited to, aliphatics, thiols, and amines. In one embodiment, R and R^{a} represents, independently, hydrocarbon or substituted hydrocarbon such as an alkyl, alkoxy, cycloalkyl, cycloalkoxy, aryloxy, alkylcarbonyl, alkoxycarbonyl, cycloalkylcarbonyl, cycloalkoxycarbonyl, heteroalkyl, heterocycloalkyl, heteroaryl, arylcarbonyl, heteroarylcarbonyl, heterocycloalkylcarbonyl, aryloxycarbonyl, heteroaryloxycarbonyl, heterocycloalkoxy, or heterocycloalkoxycarbonyl, any of which can be optionally substituted with alkyl, alkoxy, cycloalkyl, cycloalkoxy, aryloxy, alkylcarbonyl, alkoxycarbonyl, cycloalkylcarbonyl, cycloalkoxycarbonyl, heteroalkyl, heterocycloalkyl, heteroaryl, arylcarbonyl, heteroarylcarbonyl, heterocycloalkylcarbonyl, aryloxycarbonyl, heteroaryloxycarbonyl, heterocycloalkoxy, or heterocycloalkoxycarbonyl, —OH, —NO₂, —NH₂, —COOH, a halogen, and/or —CH₃.

A general controlled solid-state synthesis reaction for formation of amides from a solid-phase combination, such as a co-crystal, is shown in Scheme III:

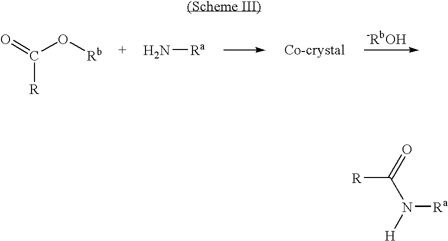

where R and R^{a} are as described in Scheme II, and R^{b} is alkyl, preferably C₁ to C₈ alkyl, more preferably lower alkyl, most preferably methyl.

A general controlled solid-state synthesis reaction for formation of esters from a solid-phase combination, such as a co-crystal, is shown in Scheme IV:

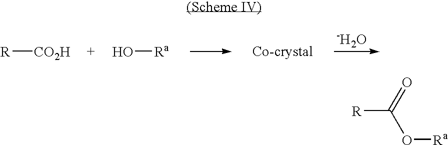

where R and R^{a} are as described in Scheme II.

A general controlled solid-state synthesis reaction for formation of secondary amines from a solid-phase combination, such as a co-crystal, is shown in Scheme V:

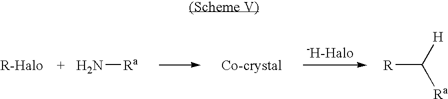

where R and R^{a} are as described in Scheme II and halo means the halogen elements fluorine (F), chlorine (Cl), bromine (Br), and iodine (I). In a preferred embodiment, halo is chloro.

A general controlled solid-state synthesis reaction for formation of lactams from lactones from a solid-phase combination, such as a co-crystal, is shown in Scheme VI:

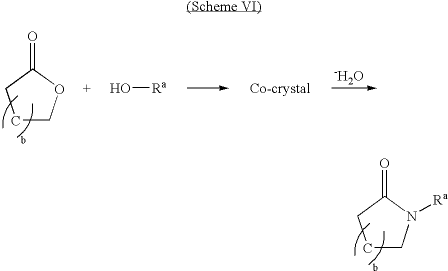

where R^{a} is as described in Scheme II and b is from 0 to 3. When b is 0, four-membered lactams (β-lactam) are formed; when b is 1, five-membered lactams (γ-lactam) are formed; when b is 2, six-membered lactams (γ-lactam) are formed; and when b is 3, seven-membered lactams (ε-lactam) are formed.

In one embodiment, a first reactant, a second reactant, a condensation reaction product and a small molecule condensation reaction by-product are selected from combinations A1 to I1 listed in Table 1.

TABLE 1

| | | | Condensation | Small |
|---|---|---|---|---|
| | First | Second | reaction | molecule |
| Combination | Reactant | Reactant | product | by-product |
| A1 | ester | amine | amide | alcohol |
| B1 | acid halide | amine | amide | HX, X is a |
| | | | | halogen |
| C1 | carboxylic | amine | amide | water |
| | acid | | | |
| D1 | halide | amine | secondary | HX, X is a |
| | | | amine | halogen |
| E1 | carboxylic | alcohol | ester | water |
| | acid | | | |
| F1 | anhydride | amine | imide | water |
| G1 | aldehyde | amine | imine | water |
| H1 | ketone | amine | imine | water |
| I1 | lactone | amine | lactam | water |

Although not specified in Table 1, the first reactant or second reactant may be polyfunctional. Thus, for example, a diamine may be reacted with two equivalents of an anhydride to form a diimide. By way of further example, a diester may be reacted with two equivalents of a monoamine to form a diamide. Stated more generally, the condensation reaction product may consist of a single residue of the first reactant and a single residue of a second reactant (e.g., a monoanhydride reacting with a monoamine to form an imide), a single residue of the first or second reactant and at least two residues of the other (e.g., a dianhydride reacting with two equivalents of a monoamine to form a diimide), or at least two residues of each of the first and second reactants (e.g., a dianhydride reacting with a diamine) to form an oligomer or polymer. Table 2 identifies, for example in combinations A2 to H2, a range of condensation polymers (or the corresponding oligomers) that may be derived from difunctional first and second reactants. For some end uses, even greater degrees of polyfunctionality may be desired (e.g., a triamine, tetraamine, pentaamine); thus, a polyfunctional first reactant may be reacted with a monofunctional second reactant, a monofunctional first reactant may be reacted with a polyfunctional second reactant, or a polyfunctional first reactant may be reacted with a polyfunctional second reactant.

TABLE 2

| | | | Condensation | Small |
|---|---|---|---|---|
| | First | Second | reaction | molecule |
| Combination | Reactant | Reactant | product | by-product |
| A2 | diester | diamine | polyamide | alcohol |
| B2 | diacid | diamine | polyamide | HX, X is |
| | halide | | | a halogen |
| C2 | dicarboxylic | diamine | polyamide | water |
| | acid | | | |
| D2 | halide | diamine | diamine | HX, X is |
| | | | | a halogen |
| E2 | dicarboxylic | diol | polyester | water |
| | acid | | | |
| F2 | dianhydride | diamine | polyimide | water |
| G2 | dialdehyde | diamine | polyimine | water |
| H2 | diketone | diamine | polyimine | water |

In one embodiment, the first reactant and the second reactant are monomers and the condensation reaction product is a condensation polymer of the first and second reactions.

Condensation reaction products typically contain the residue of one, two or more reactants. Condensation reaction product purity can suitably be 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9% or even 99.95% or more.

Co-crystals can be produced by methods including, but not limited to, slurrying, solvent evaporation, solvent crystallization, treatment with supercritical fluid(s), melting plus crystallization, slurry conversion, grinding of solids, blending of powders, heating of solids, solvent-drop grinding, or grinding plus melting. In one embodiment, the co-crystal is produced by solvent drop grinding of the two or more solid co-crystal formers, followed by heating, e.g., heating above the melting point of one of the co-crystal formers. In one embodiment, the heating is between about 20° C. and 200° C., between about 50° C. and 160° C. or even between about 100° C. and 160° C. In an exemplified embodiment, the heating is at about 150° C. In one embodiment, a method of the present invention comprises producing a co-crystal from two or more solid co-crystal formers, wherein one of the co-crystal former compounds is an amine, NH₂R, wherein R is any carbon containing group, and another co-crystal former is an anhydride or carbonyl (C═O) containing compound. Following co-crystal formation, the co-crystal is heated to a sufficient temperature and for a sufficient period of time so as to affect a condensation reaction wherein a covalent bond formation occurs between the co-crystal molecules with concomitant loss of H₂O or other small molecules. The heating can be from about 25° C. to about 300° C. or higher or even from about 75° C. to about 300° C. or higher, and more typically from about 25° C. to about 200° C. or form about 120° C. to about 180° C. Typically, the co-crystal is heated for one to several hours, for example, from between about one hour to four hours or more. In one embodiment, the co-crystal is heated for about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, or 150 hours or more. In an alternative embodiment, the co-crystal is exposed to microwave radiation of sufficient intensity and for a sufficient period of time so as to affect a condensation reaction wherein a covalent bond formation occurs between the co-crystal molecules with concomitant loss of water, an alcohol, hydrochloric acid or other small molecules.

In an exemplified embodiment a co-crystal of NTCDA and ABA is heated for about 24 hours at about 150° C. The imide or imine produced by the methods of the present invention can then be identified, isolated and further modified, as necessary.

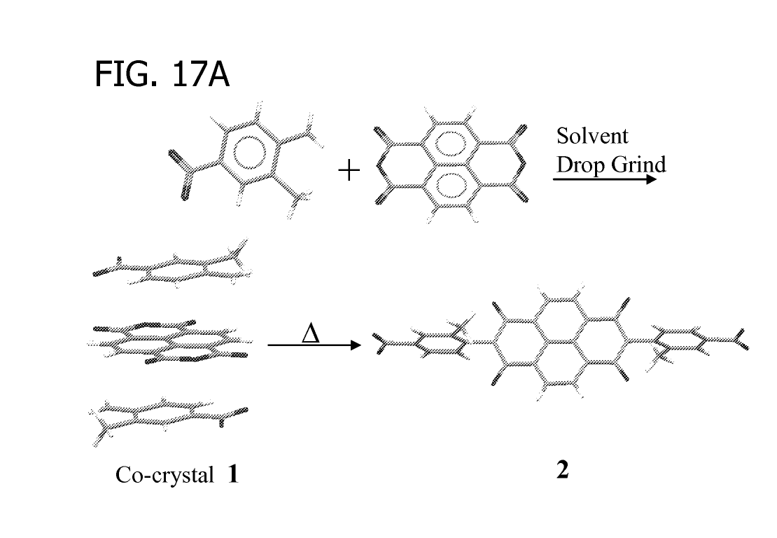

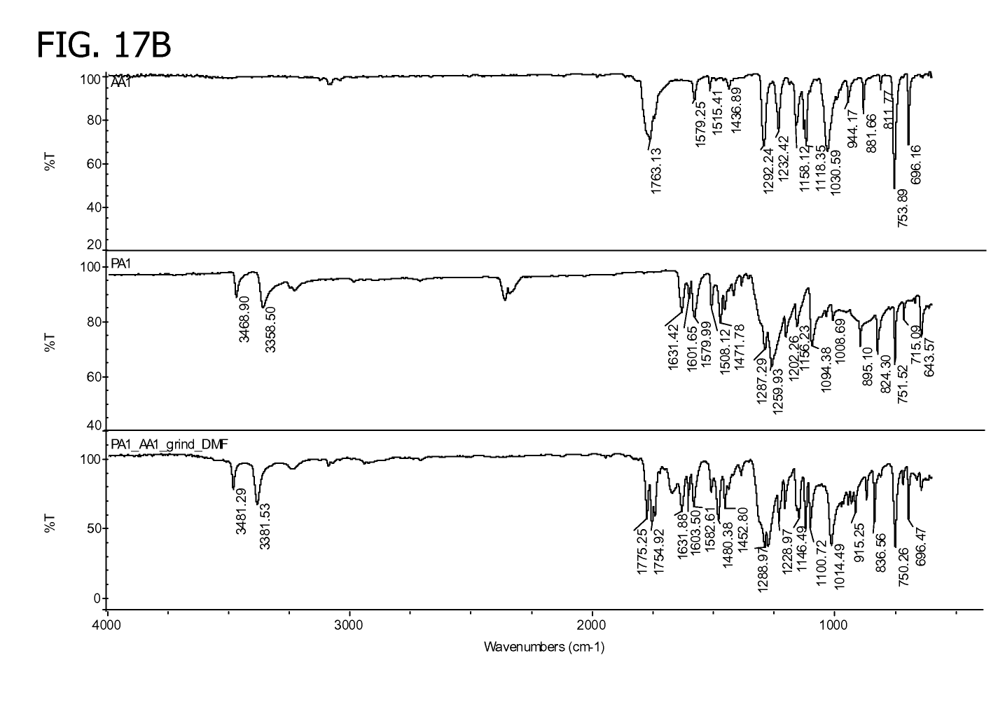

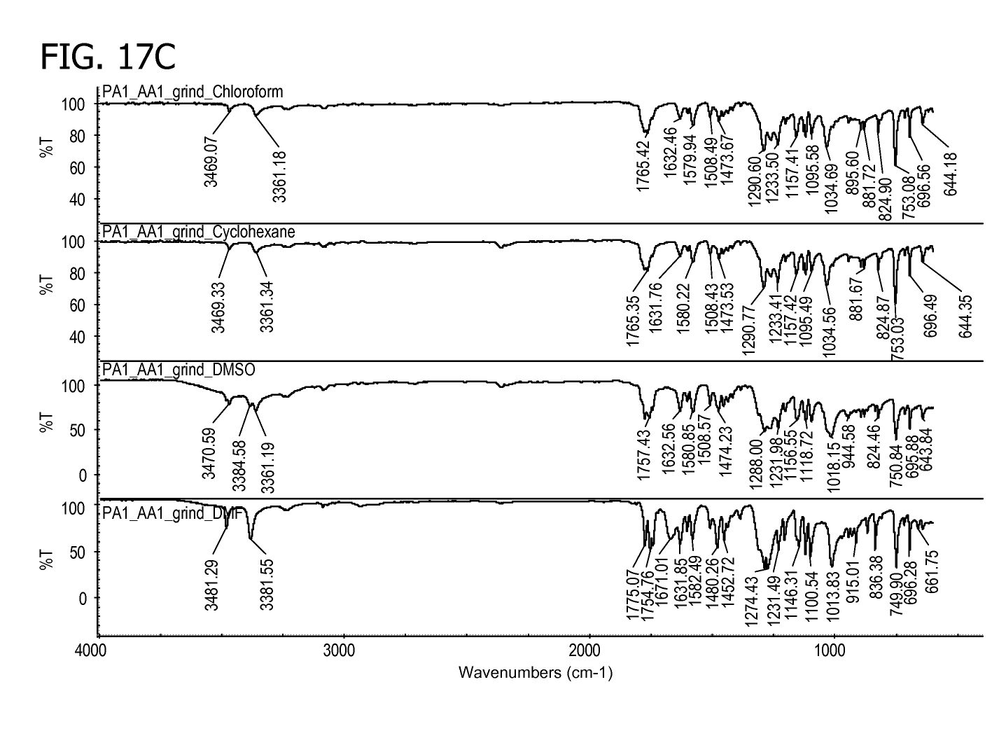

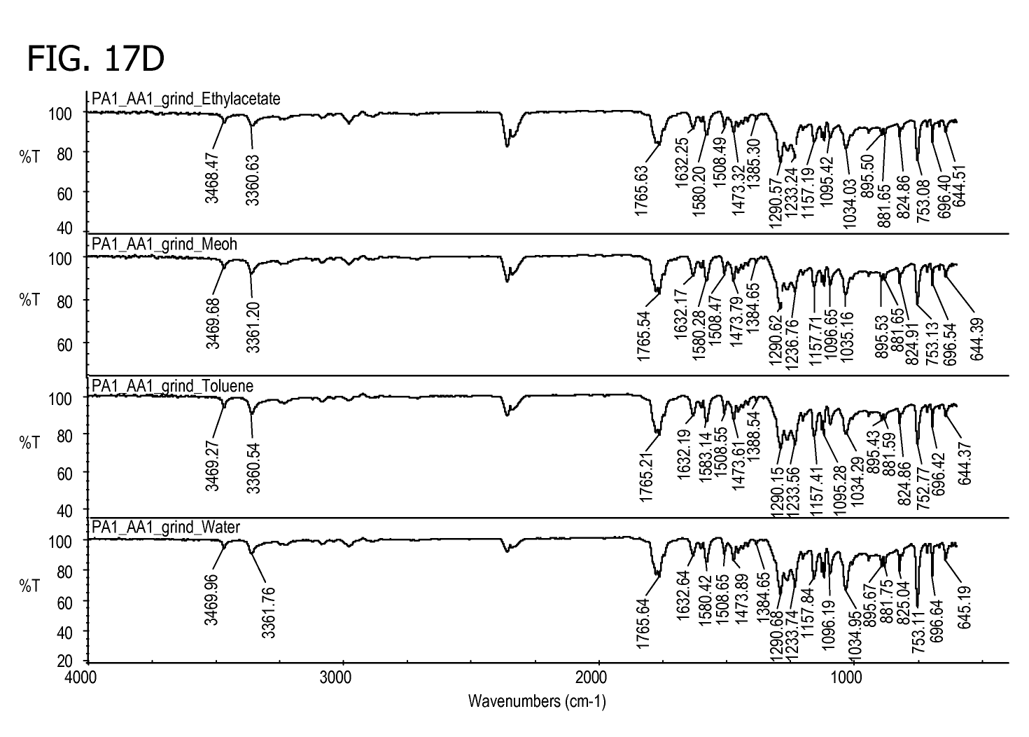

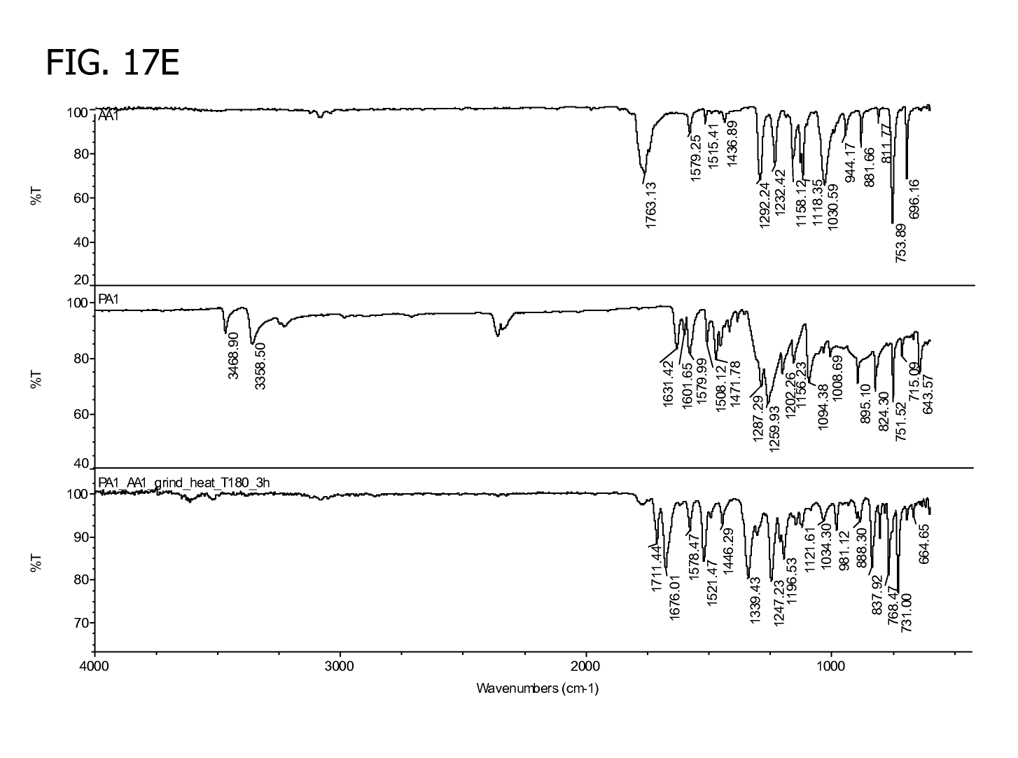

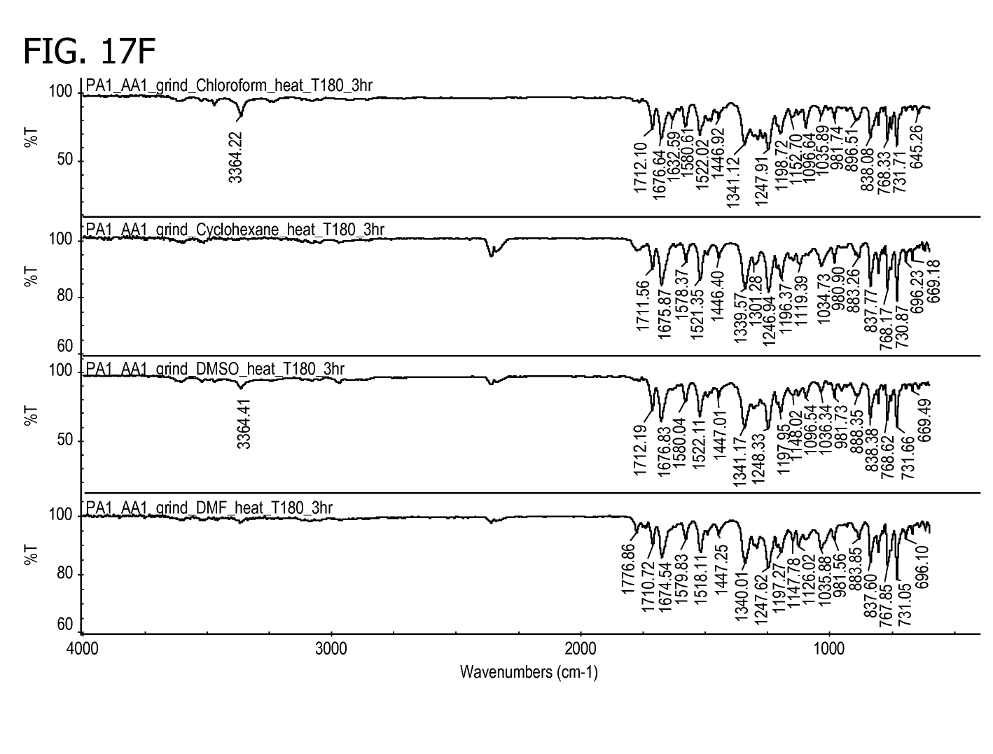

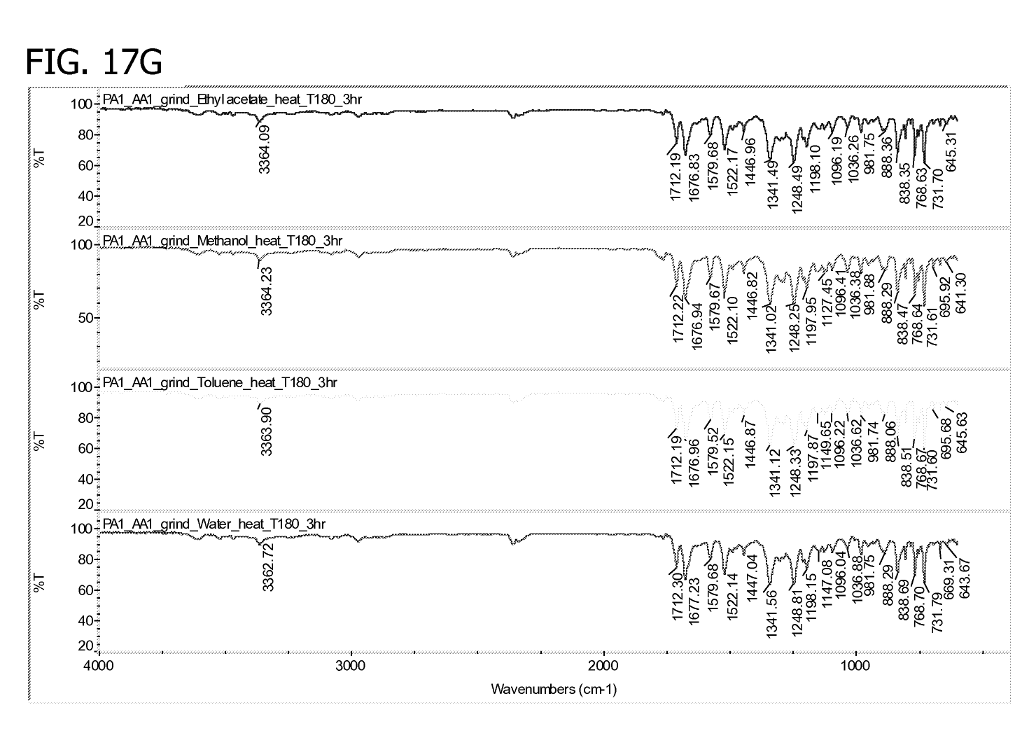

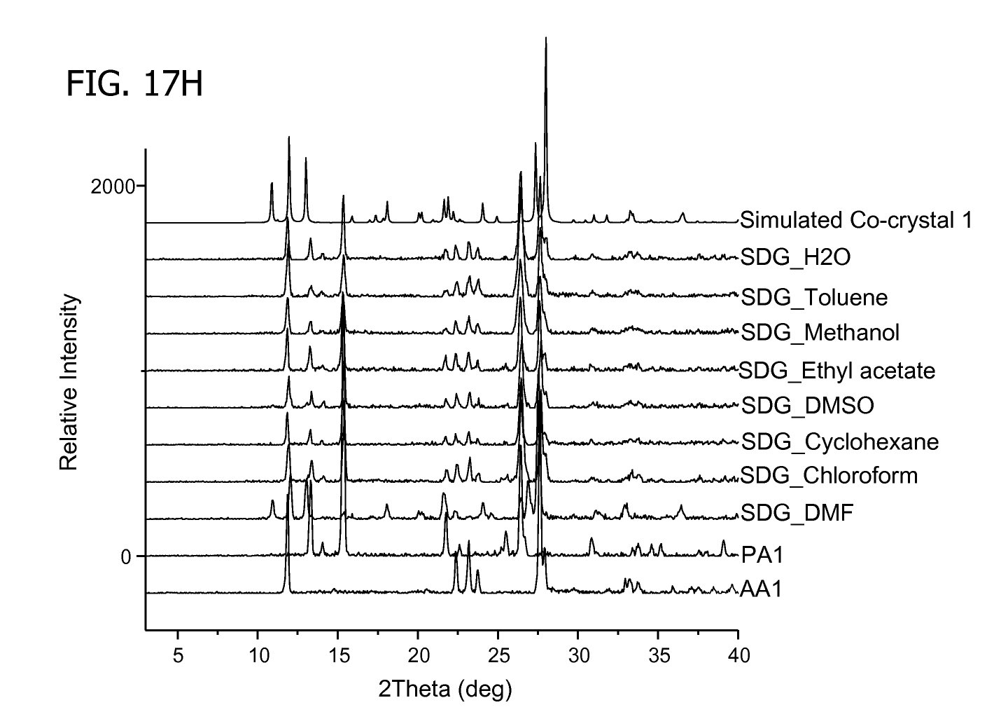

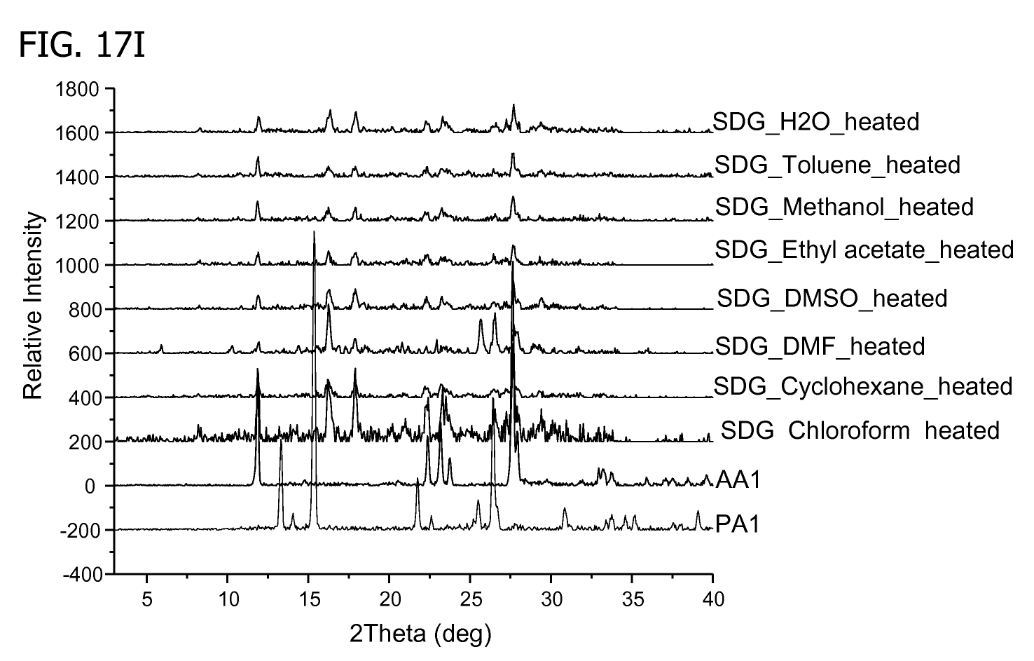

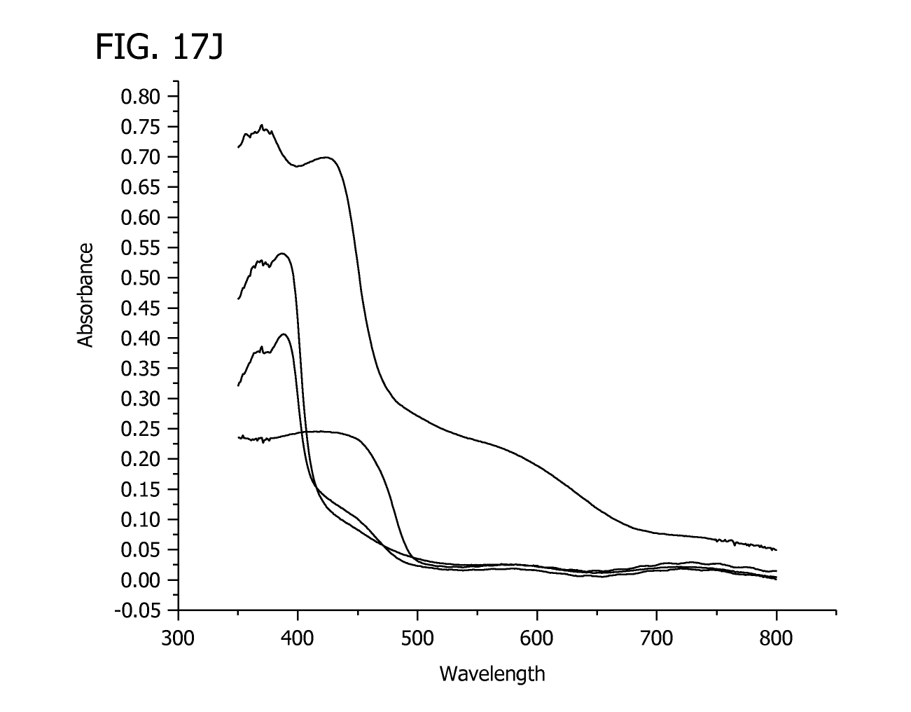

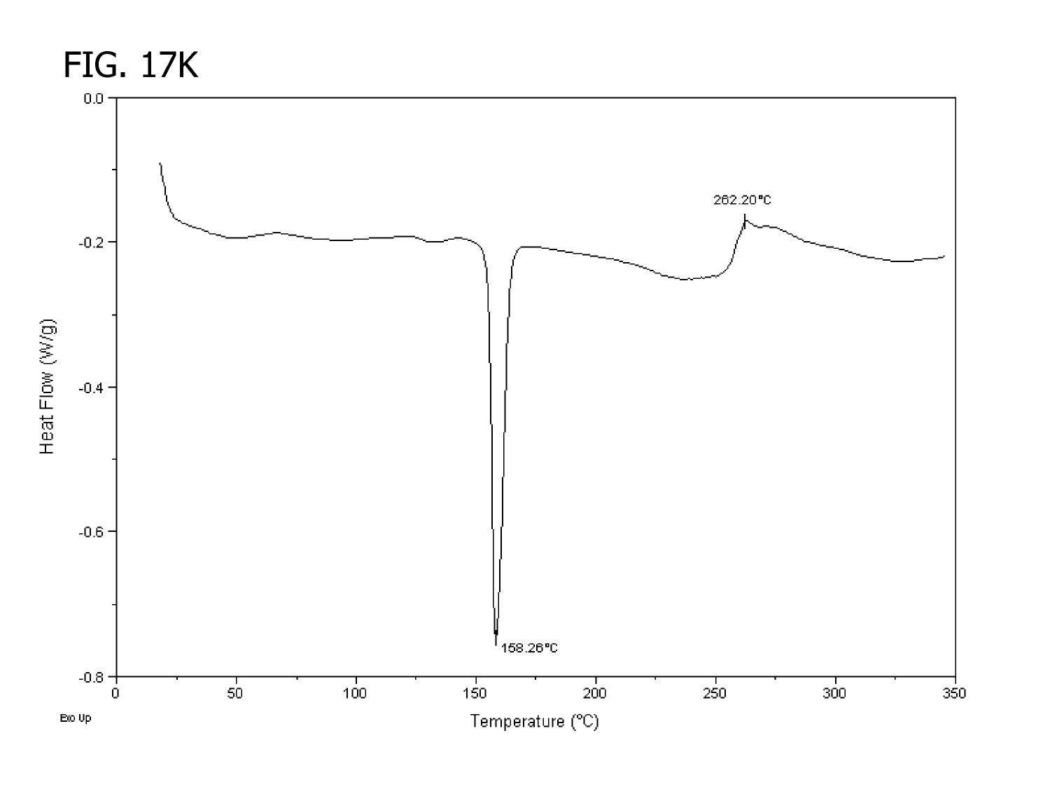

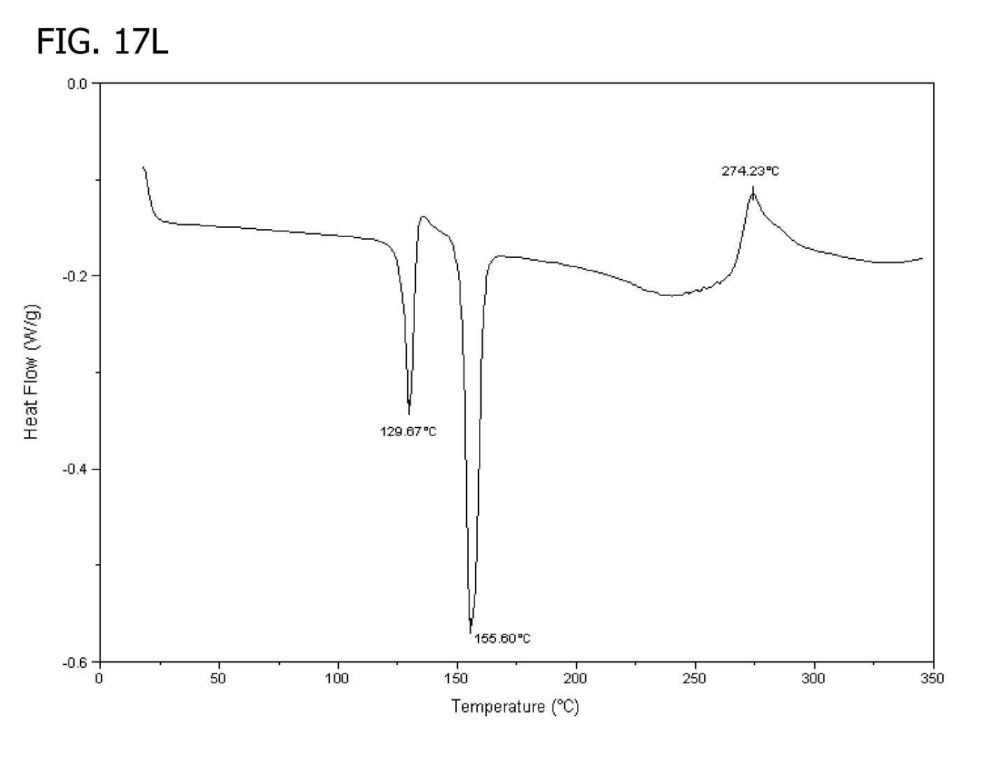

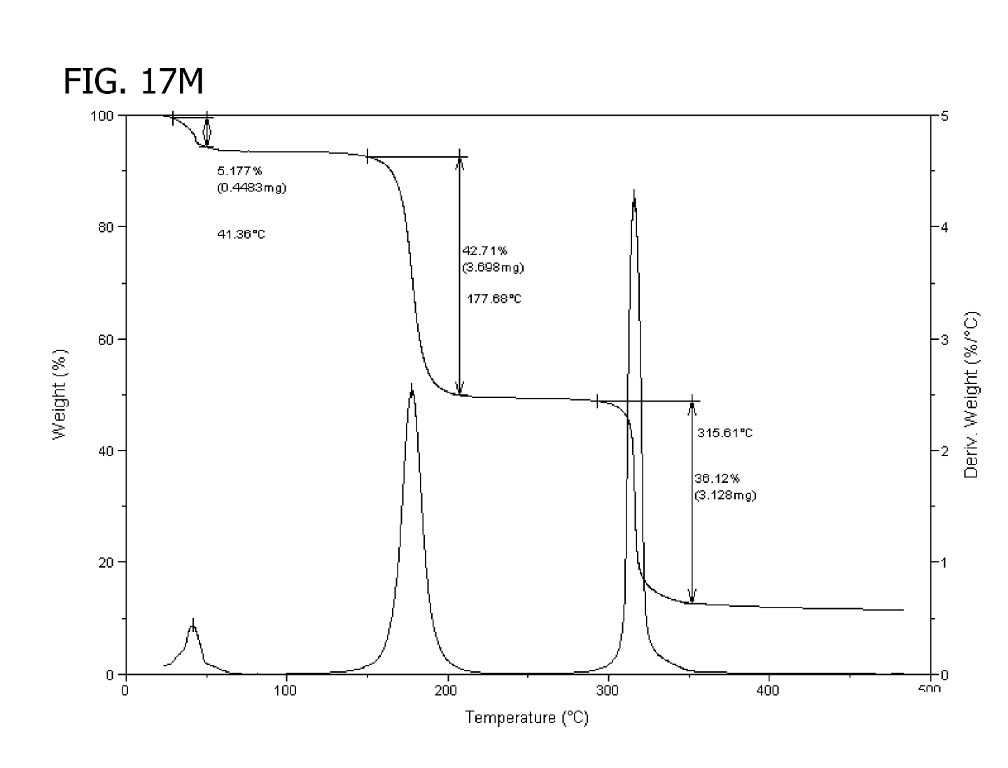

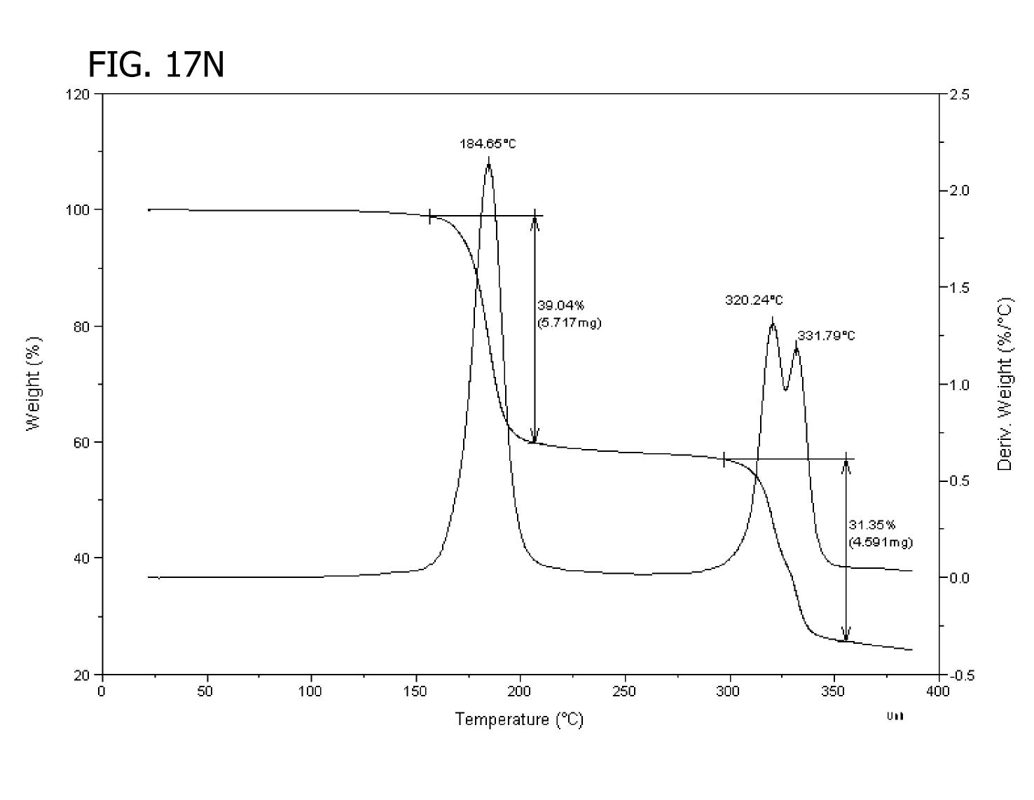

In another exemplified embodiment, 1,4,5,8-naphthalenetetracarboxylic dianhydride (NTCDA) and 2-methyl-4-nitroaniline (MNA) form a 1:2 co-crystal which converts cleanly to diimide when heated at about 18° C. for about 3 hours (75% yield) (see FIG. 17A). The diimide was recrystallized from dimethylformamide (DMF) or dimethylsulfoxide (DMSO), affording solvated single crystals of the diimide. The co-crystal can be prepared from any of the methods described herein including, but not limited to, solution, solvent-drop grinding, or solvent-drop grinding followed by heat, and is sustained by charge transfer interactions between the aromatic rings of NTCDA and MNA which are separated by a centroid-plane distances of about 3.32 Å. The amino moieties form infinite chains along the b-axis via amine-nitro hydrogen bonds (NH . . . O, 2.946 Å). The purple color exhibited by the co-crystal contrasts to the pale yellow starting materials and orange product and is indicative of charge transfer. Additionally, the solid-state UV-vis spectrum of the co-crystal exhibits a broad band at about 600 nm, as seen in FIG. 17J.

Solvent drop grinding with other solvents affords mixtures of NTCDA and MNA. Heating of these mixtures at about 150° C., above the melting point of MNA, results in formation of a co-crystal and additional heating at about 180° C. for three hours produces a diimide. Formation of the co-crystal is a key step for facilitating or even controlling the condensation process.

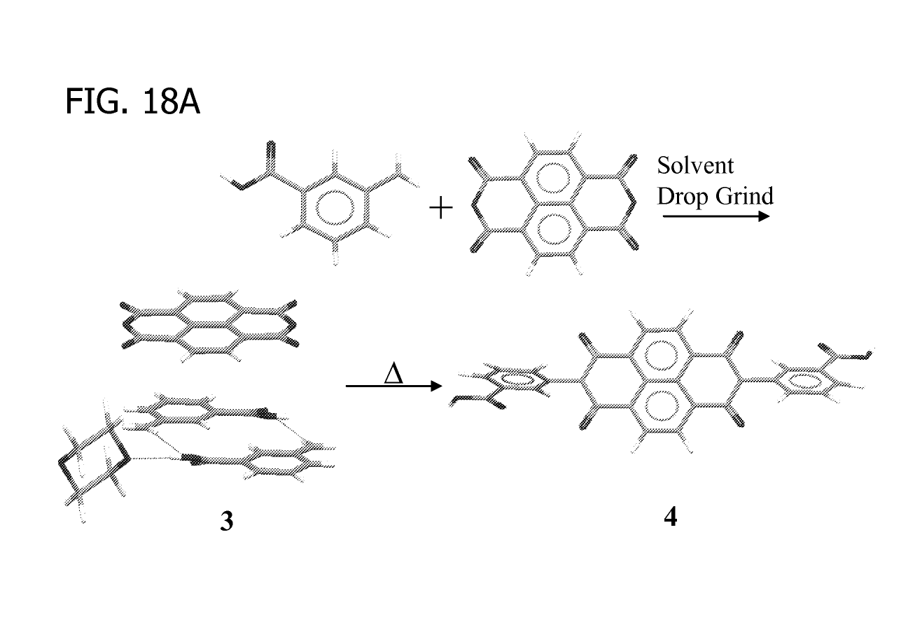

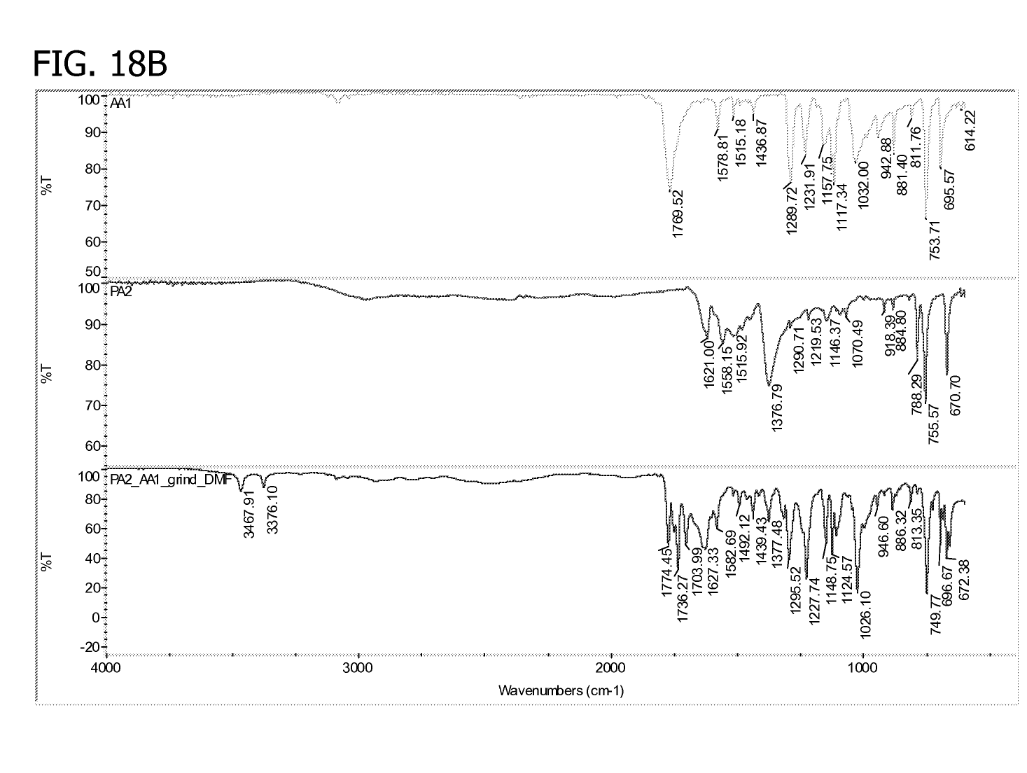

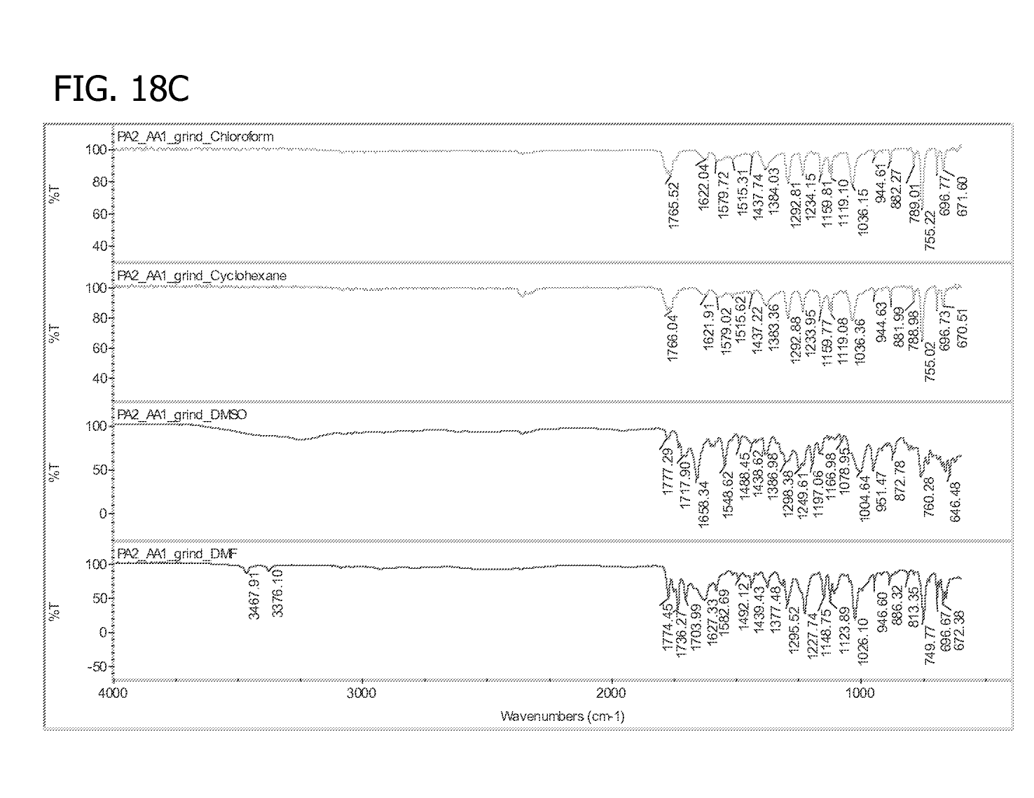

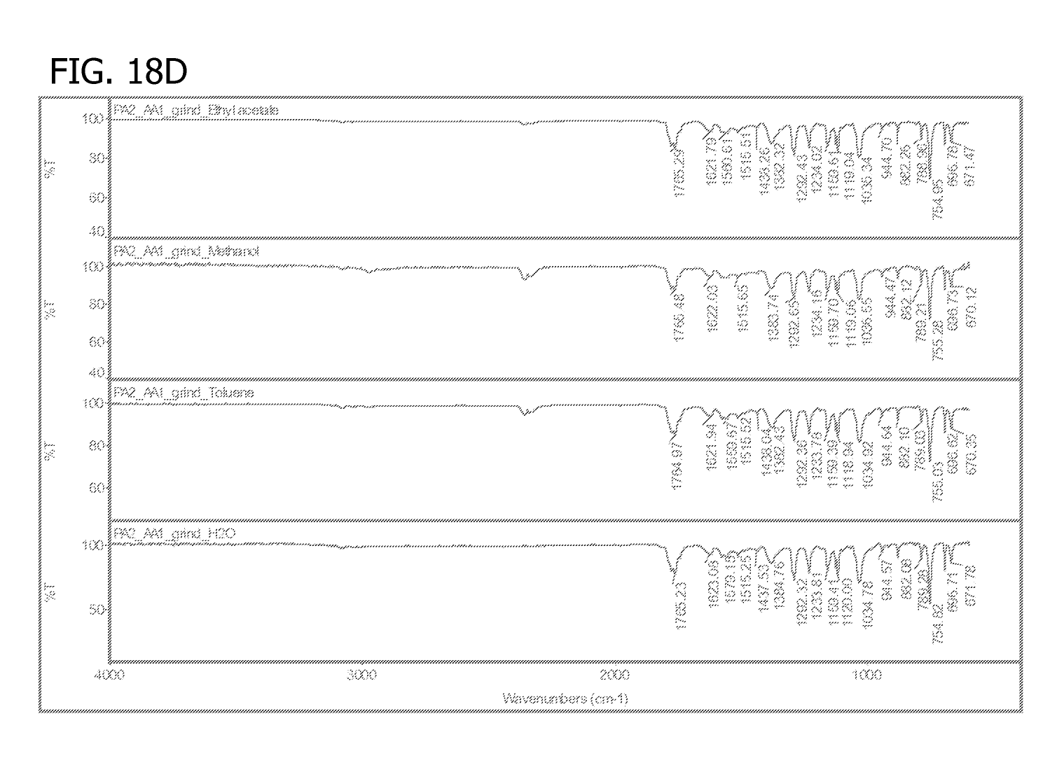

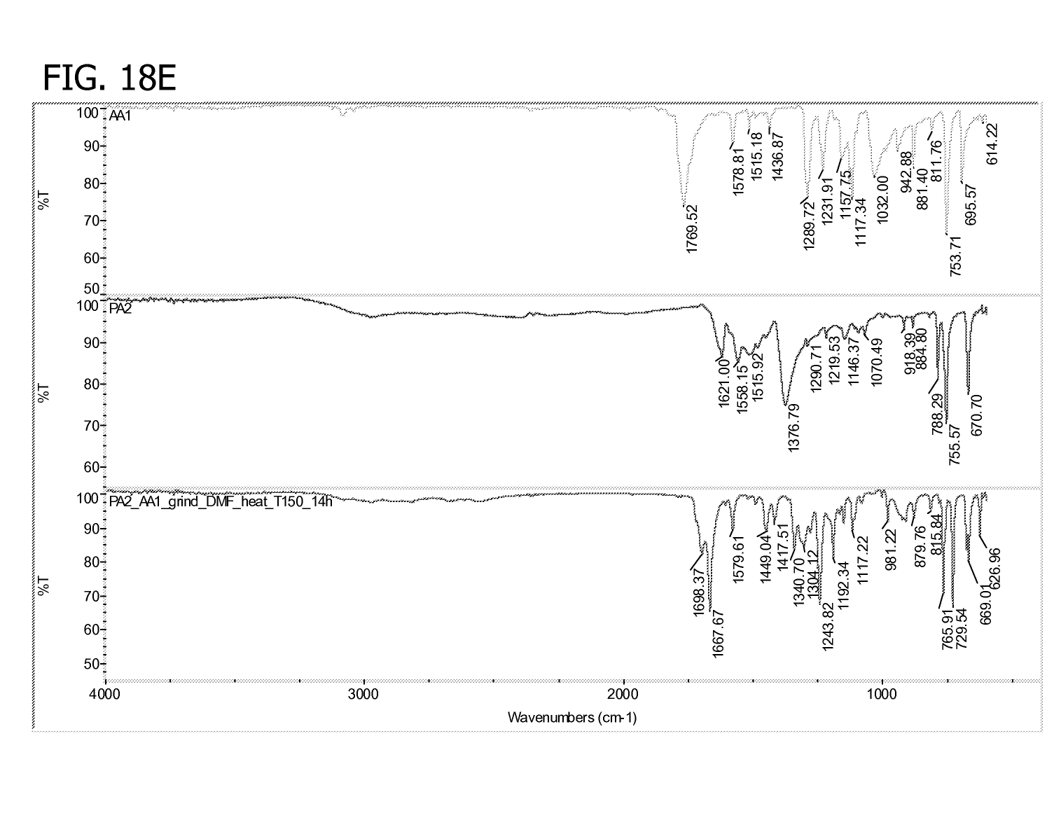

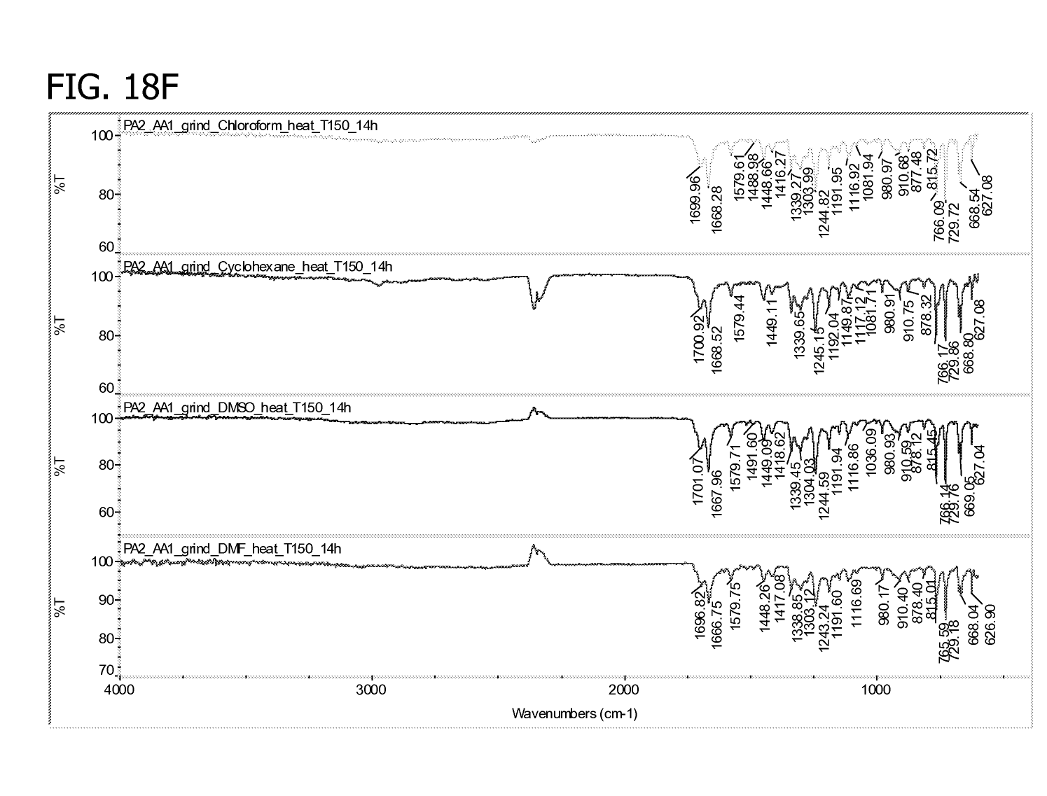

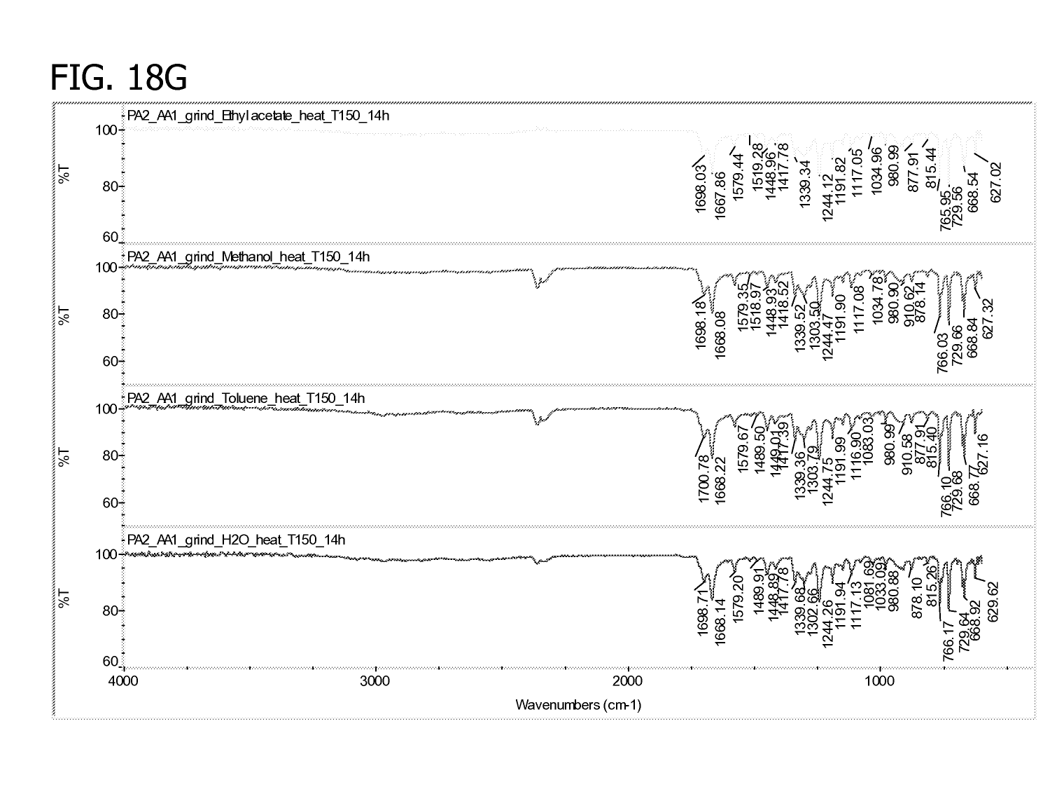

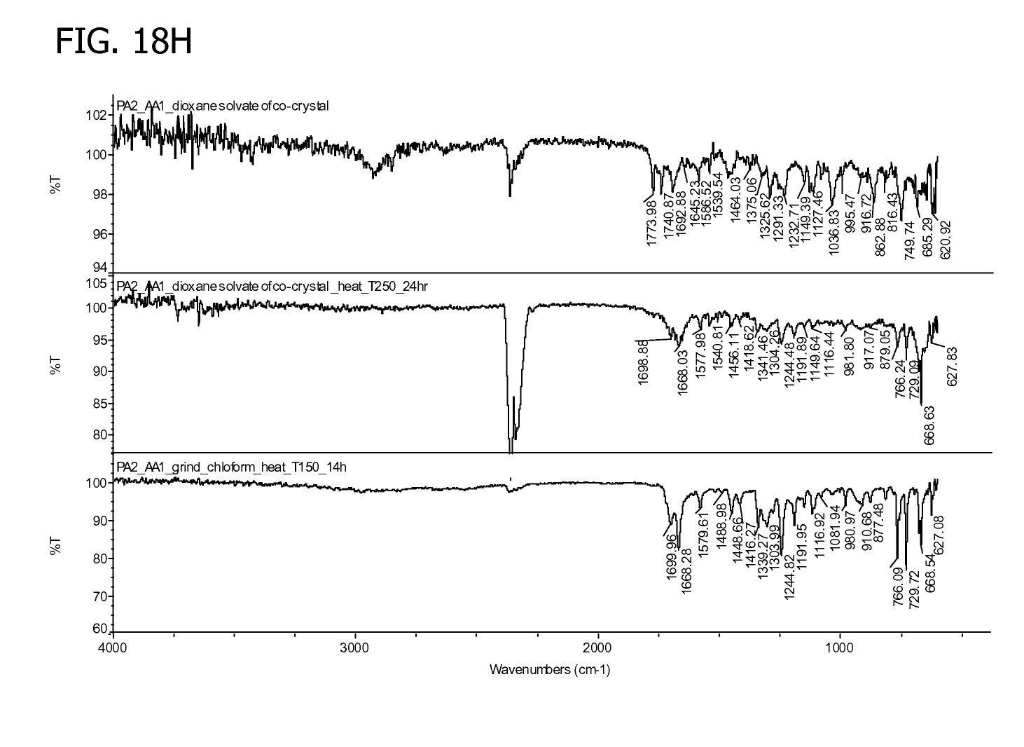

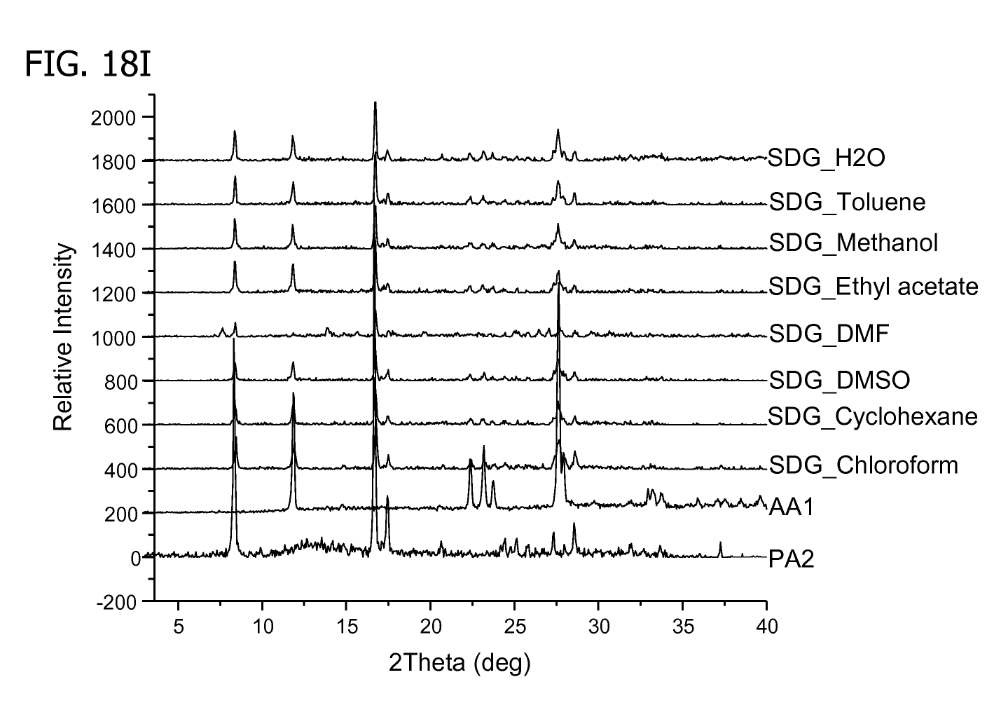

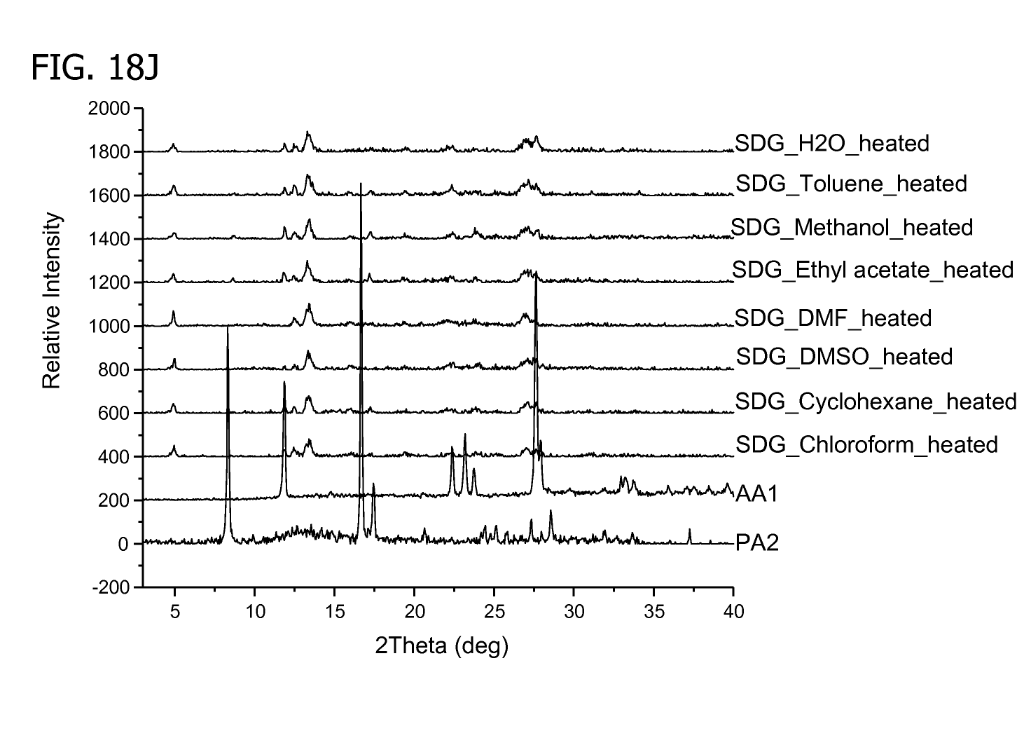

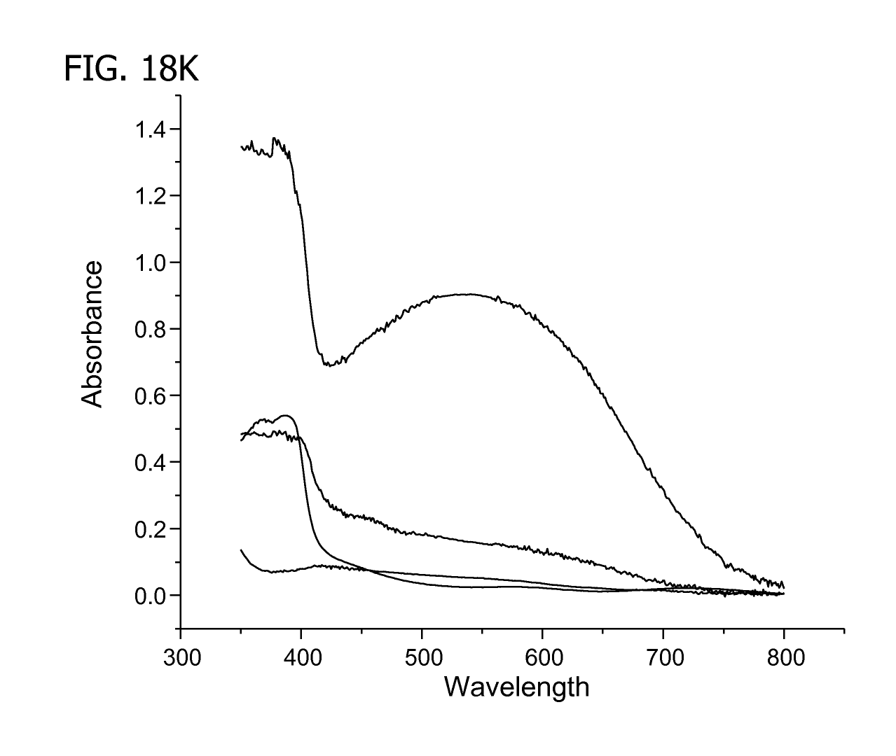

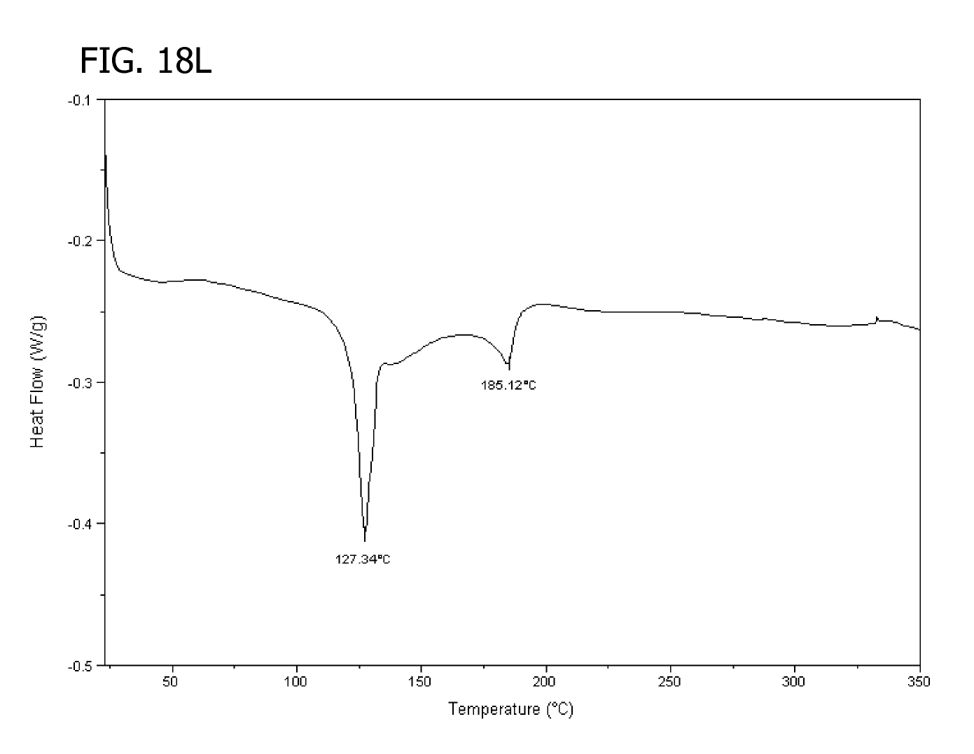

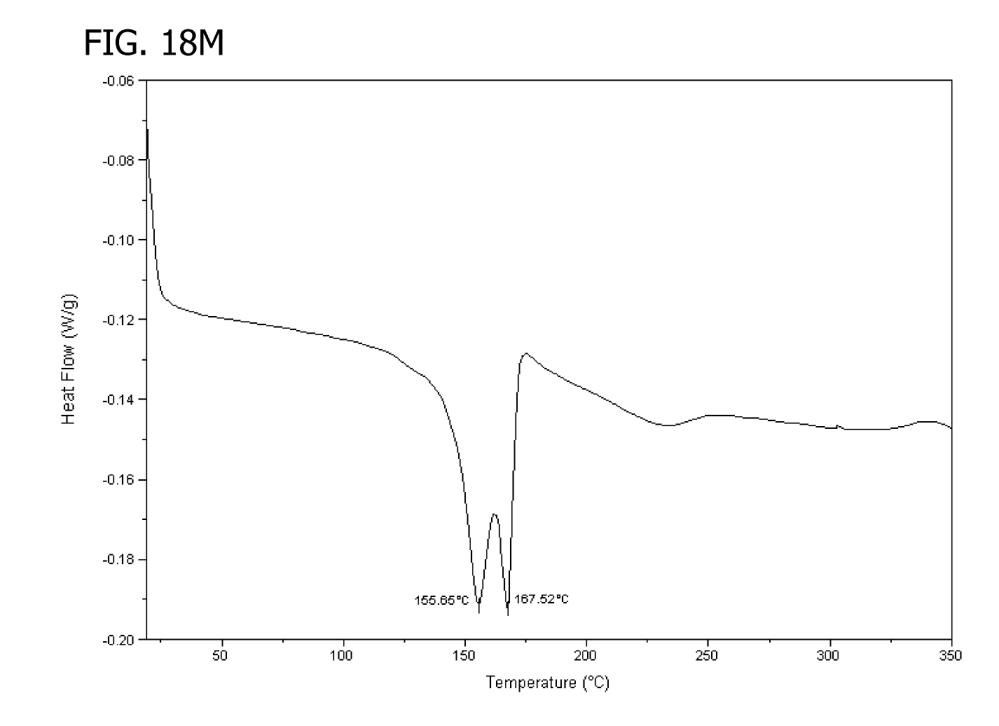

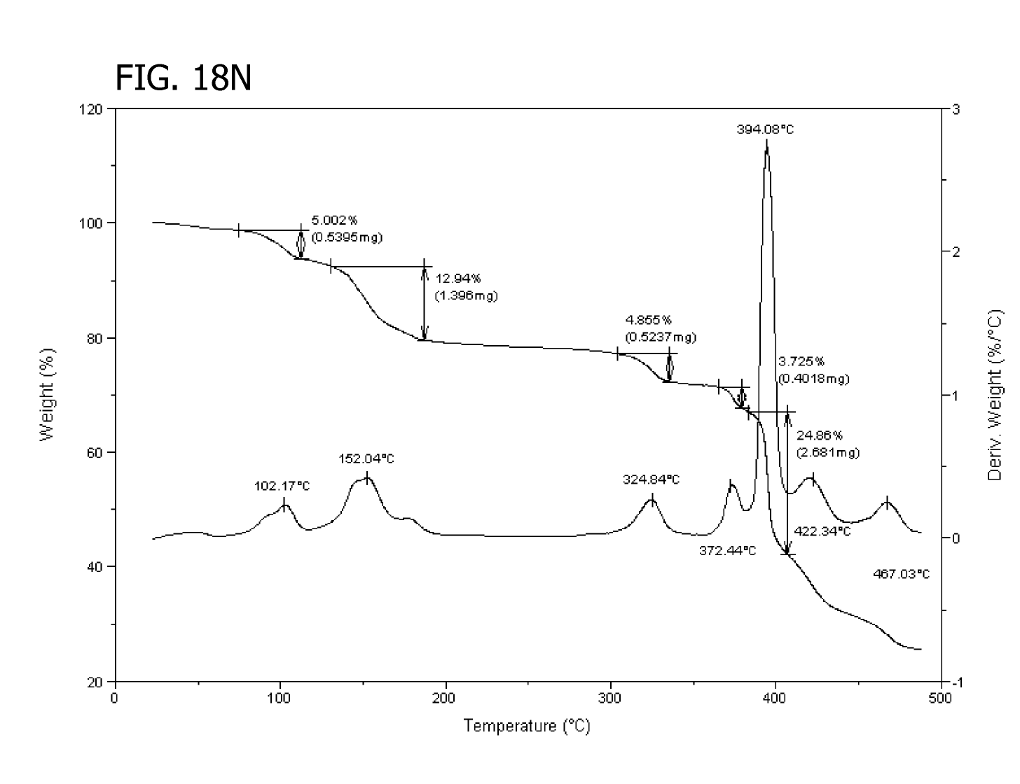

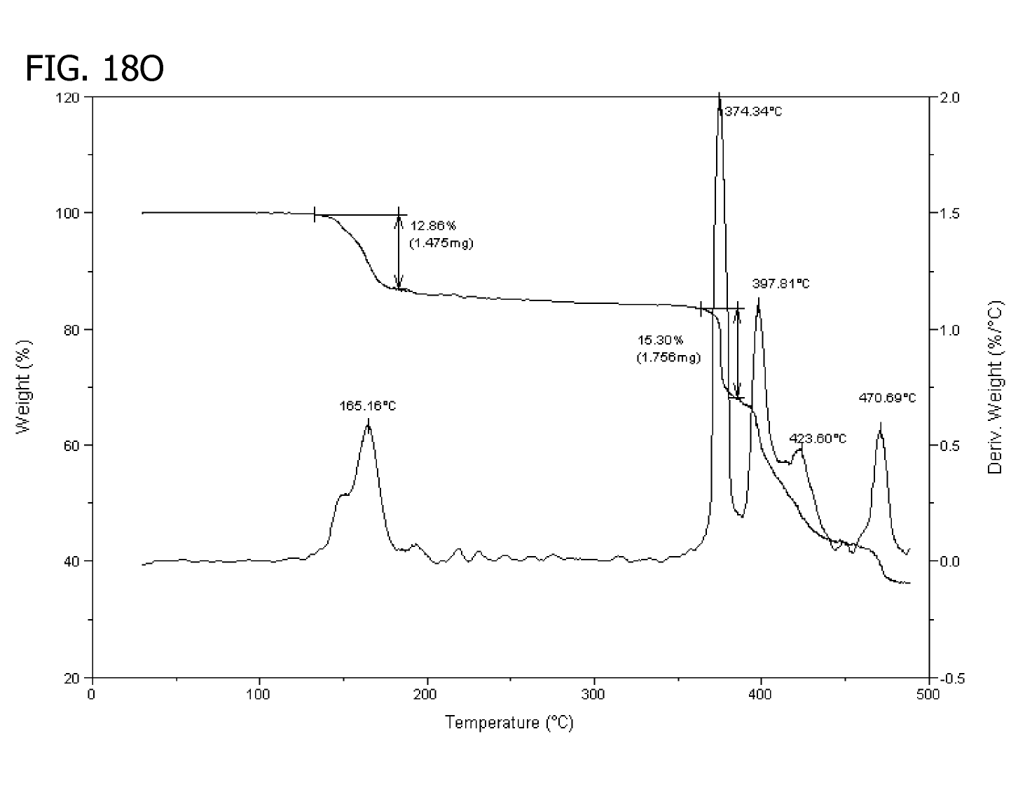

In another embodiment, NTCDA and 3-aminobenzoic acid (ABA) react to form a purple co-crystal via solvent drop grinding with DMF (see FIG. 18A). The co-crystal undergoes condensation to the corresponding diimide under ambient conditions. The solid-state UV-vis spectrum, represented by FIG. 18K, exhibits a broad band at 550 nm, consistent with charge-transfer. The shortest distance between the amine nitrogen atoms and the carbon atoms of the carbonyl moieties is 3.14 Å. The co-crystal converts to diimide after heating for about 24 hours at 150° C. with a 99% yield.

Solvent-grinding followed by heating therefore represents a general methodology for preparation of imides. Similarly, solvent-drop grinding or solvent-grinding followed by heating can also be used to prepare imines. A co-crystal forms between the aromatic amine and the carbonyl, and the co-crystal undergoes condensation to the imine form. This process leaves only a small molecule such as water, an alcohol or hydrochloric acid as a by-product.

The subject invention also concerns co-crystal compositions produced according to the subject invention. In an exemplified embodiment, a co-crystal composition of the invention comprises NTCDA and MNA in a 1:2 ratio co-crystal (shown as co-crystal 1 in FIG. 17A). In another exemplified embodiment, a co-crystal composition of the invention comprises NTCDA and ABA (shown as co-crystal 3 in FIG. 18A). The subject invention also concerns the reaction product produced from the co-crystal including, for example, imide 2 of FIG. 17A and imide 4 of FIG. 18A. The subject invention also concerns imide- and imine-based drugs and therapeutic compounds produced by the methods of the present invention.

### DEFINITIONS

The terms “hydrocarbon” and “hydrocarbyl” as used herein describe organic compounds or radicals consisting exclusively of the elements carbon and hydrogen. These moieties include alkyl, alkenyl, alkynyl, and aryl moieties. These moieties also include alkyl, alkenyl, alkynyl, and aryl moieties substituted with other aliphatic or cyclic hydrocarbon groups, such as alkaryl, alkenaryl and alkynaryl. Unless otherwise indicated, these moieties preferably comprise 1 to 20 carbon atoms.

The “substituted hydrocarbyl” moieties described herein are hydrocarbyl moieties which are substituted with at least one atom other than carbon, including moieties in which a carbon chain atom is substituted with a hetero atom such as nitrogen, oxygen, silicon, phosphorous, boron, sulfur, or a halogen atom. These substituents include halogen, heterocyclo, alkoxy, alkenoxy, alkynoxy, aryloxy, hydroxy, protected hydroxy, keto, acyl, acyloxy, nitro, amino, amido, nitro, cyano, thiol, ketals, acetals, esters and ethers.

The term “heteroatom” shall mean atoms other than carbon and hydrogen.

As used herein, alkyl means straight, branched or cyclic chain, saturated or mono- or polyunsaturated hydrocarbyl groups having from 1 to 20 carbon atoms and C₁₋ₓ alkyl means straight or branched chain alkyl groups containing from one up to X carbon atoms, and includes alkyls, alkenyl, and alkynyls. For example, C₁₋₆ alkyl means straight or branched chain alkyl groups containing from 1 up to 6 carbon atoms. Alkoxy means an alkyl-O— group in which the alkyl group is as previously described. Cycloalkyl includes a nonaromatic monocyclic or multicyclic ring system, including fused and spiro rings, of from about three to about 10 carbon atoms. A cyclic alkyl may optionally be partially unsaturated. Cycloalkoxy means a cycloalkyl-O— group in which cycloalkyl is as defined herein. Aryl means an aromatic monocyclic or multicyclic carbocyclic ring system, including fused and spiro rings, containing from about six to about 14 carbon atoms. Aryloxy means an aryl-O— group in which the aryl group is as described herein. Alkylcarbonyl means a RC(O)— group where R is an alkyl group as previously described. Alkoxycarbonyl means an ROC(O)— group where R is an alkyl group as previously described. Cycloalkylcarbonyl means an RC(O)— group where R is a cycloalkyl group as previously described. Cycloalkoxycarbonyl means an ROC(O)— group where R is a cycloalkyl group as previously described.

Heteroalkyl means a straight or branched-chain having from one to 20 carbon atoms and one or more heteroatoms selected from nitrogen, oxygen, or sulphur, wherein the nitrogen and sulphur atoms may optionally be oxidized, i.e., in the form of an N-oxide or an S-oxide. Heterocycloalkyl means a monocyclic or multicyclic ring system (which may be saturated or partially unsaturated), including fused and Spiro rings, of about five to about 10 elements wherein one or more of the elements in the ring system is an element other than carbon and is selected from nitrogen, oxygen, silicon, or sulphur atoms. Heteroaryl means a five to about a 14-membered aromatic monocyclic or multicyclic hydrocarbyl ring system, including fused and spiro rings, in which one or more of the elements in the ring system is an element other than carbon and is selected from nitrogen, oxygen, silicon, or sulphur and wherein an N atom may be in the form of an N-oxide. Arylcarbonyl means an aryl-CO— group in which the aryl group is as described herein. Heteroarylcarbonyl means a heteroaryl-CO— group in which the heteroaryl group is as described herein and heterocycloalkylcarbonyl means a heterocycloalkyl-CO— group in which the heterocycloalkyl group is as described herein. Aryloxycarbonyl means an ROC(O)— group where R is an aryl group as previously described. Heteroaryloxycarbonyl means an ROC(O)— group where R is a heteroaryl group as previously described. Heterocycloalkoxy means a heterocycloalkyl-O— group in which the heterocycloalkyl group is as previously described. Heterocycloalkoxycarbonyl means an ROC(O)— group where R is a heterocycloalkyl group as previously described.

Lactam means a cyclic amide. Prefixes indicate the ring size: four-membered (β-lactam), five-membered (γ-lactam), six-membered (δ-lactam), and seven-membered (ε-lactam). The ring carbons and nitrogen can be optionally substituted with a hydrocarbon or substituted hydrocarbon such as alkyl, alkoxy, cycloalkyl, cycloalkoxy, aryl, aryloxy, alkylcarbonyl, alkoxycarbonyl, cycloalkylcarbonyl, cycloalkoxycarbonyl, heteroalkyl, heterocycloalkyl, heteroaryl, arylcarbonyl, heteroarylcarbonyl, aryloxycarbonyl, heteroaryloxycarbonyl, heterocycloalkoxy, heterocycloalkoxycarbonyl, any of which can be optionally substituted with alkyl, alkoxy, cycloalkyl, cycloalkoxy, aryloxy, alkylcarbonyl, alkoxycarbonyl, cycloalkylcarbonyl, cycloalkoxycarbonyl, heteroalkyl, heterocycloalkyl, heteroaryl, arylcarbonyl, heteroarylcarbonyl, heterocycloalkylcarbonyl, aryloxycarbonyl, heteroaryloxycarbonyl, heterocycloalkoxy, or heterocycloalkoxycarbonyl, —OH, —NO₂, —NH₂, —COOH, a halogen, and/or —CH₃. Lactams can be optionally joined with one or more unsaturated, partially unsaturated or saturated cyclic ring structures, such as substituted or unsubstituted cycloalkyl, heterocycloalkyl, aryl and heteroaryl, to form a multicyclic ring structure.

Lactone means a cyclic ester. Prefixes indicate the ring size: four-membered (β-lactone), five-membered (γ-lactone), six-membered (δ-lactone), and seven-membered (ε-lactone). The ring carbons and nitrogen can be optionally substituted with a hydrocarbon or substituted hydrocarbon such as alkyl, alkoxy, cycloalkyl, cycloalkoxy, aryl, aryloxy, alkylcarbonyl, alkoxycarbonyl, cycloalkylcarbonyl, cycloalkoxycarbonyl, heteroalkyl, heterocycloalkyl, heteroaryl, arylcarbonyl, heteroarylcarbonyl, aryloxycarbonyl, heteroaryloxycarbonyl, heterocycloalkoxy, heterocycloalkoxycarbonyl, any of which can be optionally substituted with alkyl, alkoxy, cycloalkyl, cycloalkoxy, aryloxy, alkylcarbonyl, alkoxycarbonyl, cycloalkylcarbonyl, cycloalkoxycarbonyl, heteroalkyl, heterocycloalkyl, heteroaryl, arylcarbonyl, heteroarylcarbonyl, heterocycloalkylcarbonyl, aryloxycarbonyl, heteroaryloxycarbonyl, heterocycloalkoxy, or heterocycloalkoxycarbonyl, —OH, —NO₂, —NH₂, —COOH, a halogen, and/or —CH₃. Lactones can be optionally joined with one or more unsaturated, partially unsaturated or saturated cyclic ring structures, such as substituted or unsubstituted cycloalkyl, heterocycloalkyl, aryl and heteroaryl, to form a multicyclic ring structure.

Imine means a chemical compound containing a carbon-nitrogen double bond. Where the imine nitrogen is linked to a first moiety by a carbon-nitrogen double bond and a second moiety by a carbon-nitrogen single bond, the moieties are independently a hydrocarbon or substituted hydrocarbon such as an alkyl, alkoxy, cycloalkyl, cycloalkoxy, aryloxy, alkylcarbonyl, alkoxycarbonyl, cycloalkylcarbonyl, cycloalkoxycarbonyl, heteroalkyl, heterocycloalkyl, heteroaryl, arylcarbonyl, heteroarylcarbonyl, heterocycloalkylcarbonyl, aryloxycarbonyl, heteroaryloxycarbonyl, heterocycloalkoxy, or heterocycloalkoxycarbonyl. Those moieties can be optionally substituted with alkyl, alkoxy, cycloalkyl, cycloalkoxy, aryloxy, alkylcarbonyl, alkoxycarbonyl, cycloalkylcarbonyl, cycloalkoxycarbonyl, heteroalkyl, heterocycloalkyl, heteroaryl, arylcarbonyl, heteroarylcarbonyl, heterocycloalkylcarbonyl, aryloxycarbonyl, heteroaryloxycarbonyl, heterocycloalkoxy, or heterocycloalkoxycarbonyl, —OH, —NO₂, —NH₂, —COOH, a halogen, and/or —CH₃.

Imide means a functional group having two carbonyl groups bound to a primary amine. Imides can be linear, cyclic or multicyclic. In linear imides, the carbonyl groups and primary amine or ammonia can be substituted with a hydrocarbon or substituted hydrocarbon such as alkyl, alkoxy, cycloalkyl, cycloalkoxy, aryloxy, alkylcarbonyl, alkoxycarbonyl, cycloalkylcarbonyl, cycloalkoxycarbonyl, heteroalkyl, heterocycloalkyl, heteroaryl, arylcarbonyl, heteroarylcarbonyl, heterocycloalkylcarbonyl, aryloxycarbonyl, heteroaryloxycarbonyl, heterocycloalkoxy, or heterocycloalkoxycarbonyl, any of which can be optionally substituted with alkyl, alkoxy, cycloalkyl, cycloalkoxy, aryloxy, alkylcarbonyl, alkoxycarbonyl, cycloalkylcarbonyl, cycloalkoxycarbonyl, heteroalkyl, heterocycloalkyl, heteroaryl, arylcarbonyl, heteroarylcarbonyl, heterocycloalkylcarbonyl, aryloxycarbonyl, heteroaryloxycarbonyl, heterocycloalkoxy, or heterocycloalkoxycarbonyl, —OH, —NO₂, —NH₂, —COOH, a halogen, and/or —CH₃. Cyclic imides can be optionally joined with one or more unsaturated, partially unsaturated or saturated cyclic ring structures, such as substituted or unsubstituted cycloalkyl, heterocycloalkyl, aryl and heteroaryl, to form a multicyclic ring structure.

Examples of saturated alkyl groups include, but are not limited to, methyl, ethyl, N-propyl, isopropyl, N-butyl, tert-butyl, isobutyl, sec-butyl, N-pentyl, N-hexyl, N-heptyl, and N-octyl. An unsaturated alkyl group is one having one or more double or triple bonds. Unsaturated alkyl groups include, for example, ethenyl, propenyl, butenyl, hexenyl, vinyl, 2-propynyl, 2-isopentenyl, 2-butadienyl, ethynyl, 1-propynyl, 3-propynyl, and 3-butynyl. Cycloalkyl groups include, for example, cyclopentyl, cyclohexyl, 1-cyclohexenyl, 3-cyclohexenyl, and cycloheptyl. Heterocycloalkyl groups include, for example, 1-piperidinyl, 2-piperidinyl, 3-piperidinyl, 3-morpholinyl, 4-morpholinyl, tetrahydrofuran-2-yl, tetrahydrofuran-3-yl, tetrahydrothien-2-yl, tetrahydrothien-3-yl, 1-piperazinyl, 2-piperazinyl, and 1,4-diazabicyclooctane. Aryl groups include, for example, phenyl, indenyl, biphenyl, 1-naphthyl, 2-naphthyl, anthracenyl, and phenanthracenyl. Heteroaryl groups include, for example, 1-pyrrolyl, 2-pyrrolyl, 3-pyrrolyl, furyl, thienyl, imidazolyl, oxazolyl, thiazolyl, pyrazolyl, pyridyl, indolyl, quinolinyl, isoquinolinyl, benzoquinolinyl, carbazolyl, and diazaphenanthrenyl.

As used herein, halogen means the elements fluorine (F), chlorine (Cl), bromine (Br), and iodine (I).

All patents, patent applications, provisional applications, and publications referred to or cited herein are incorporated by reference in their entirety, including all figures and tables, to the extent they are not inconsistent with the explicit teachings of this specification.

Having described the invention in detail, it will be apparent that modifications and variations are possible without departing from the scope of the invention defined in the appended claims.

### EXAMPLES

The following non-limiting examples are provided to further illustrate the present invention and illustrate some reactions that can be used for co-crystal controlled solid-state synthesis of imides and imines. These examples should not be construed as limiting.

### Example 1

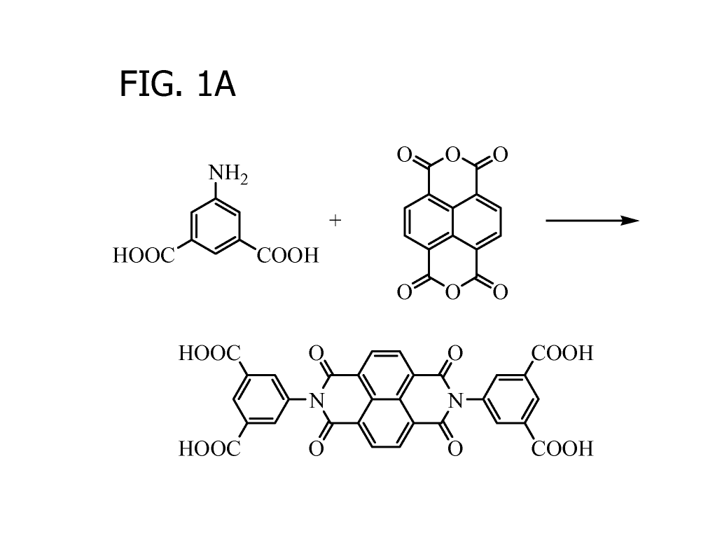

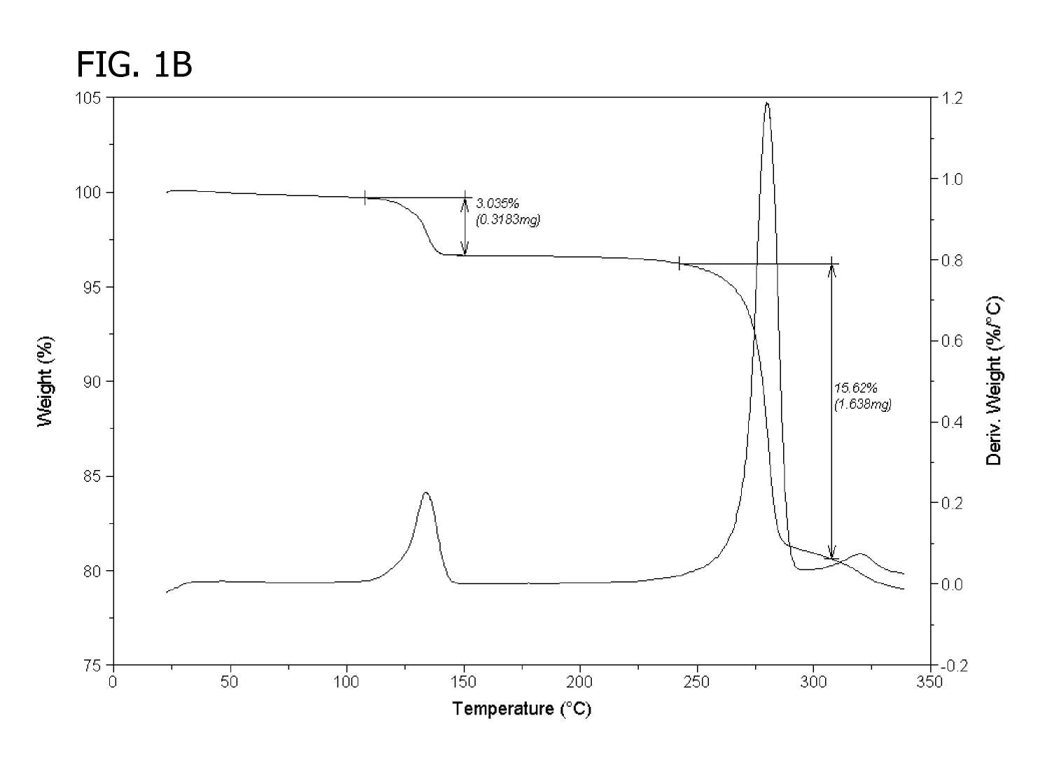

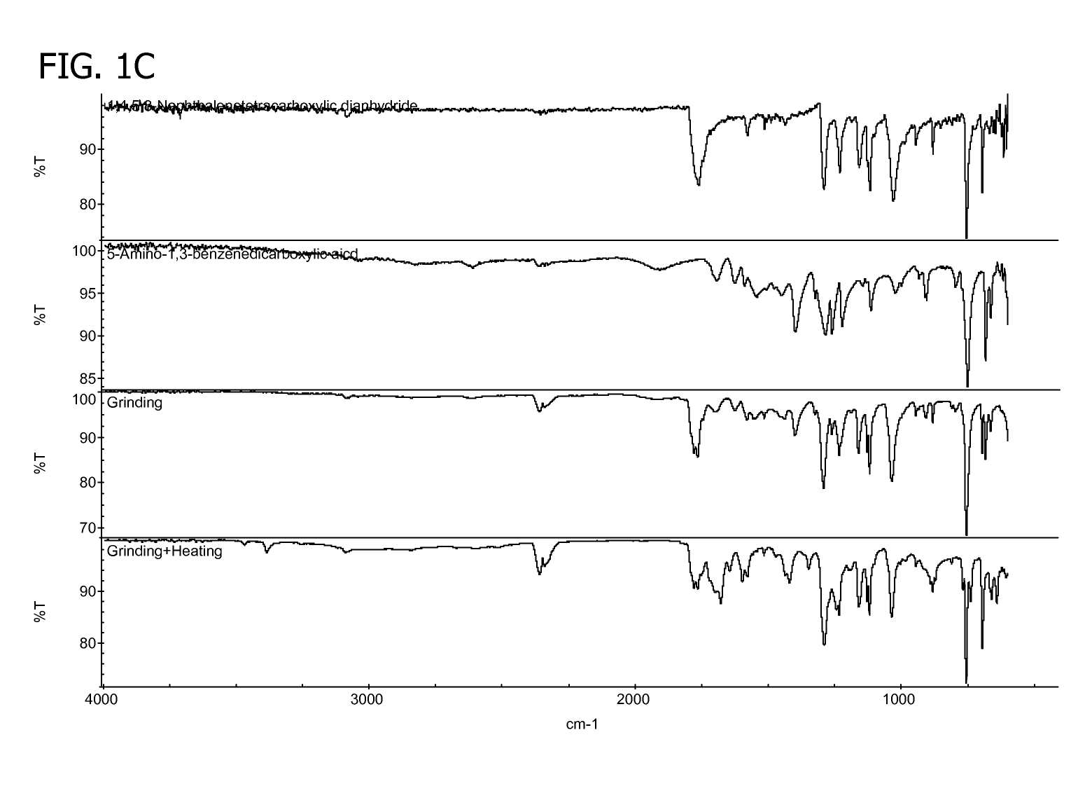

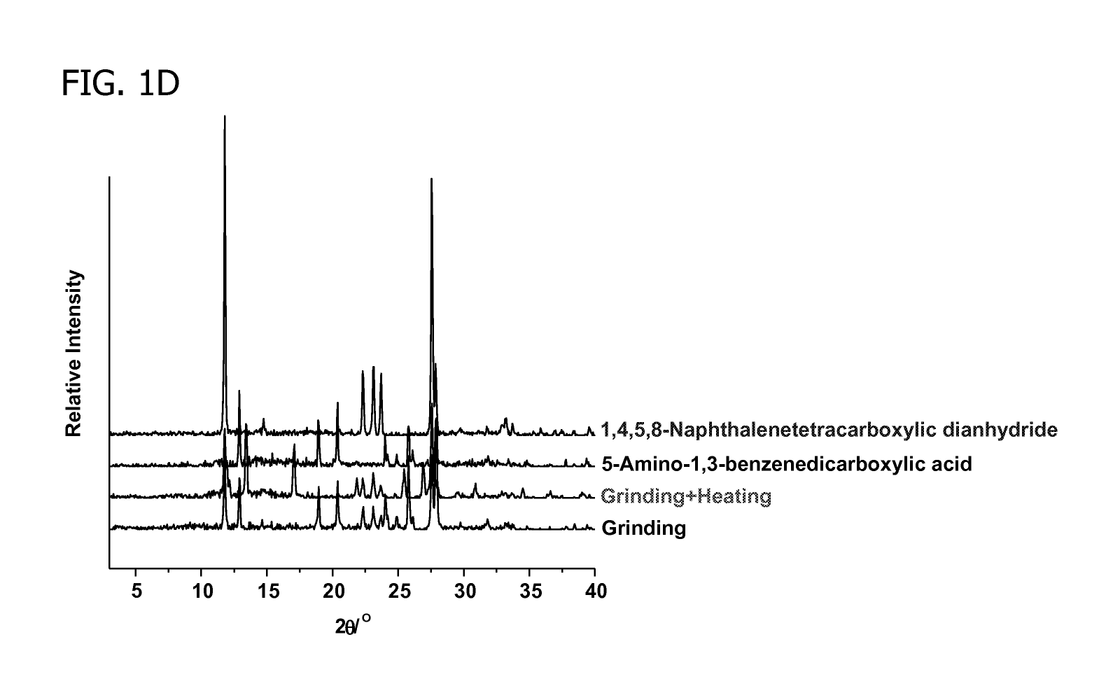

58 mg (0.32 mmol) 5-amino-1,3-benzenedicarboxylic acid and 42 mg (0.16 mmol) 1,4,5,8-naphthalenetetracarboxylic dianhydride were placed in a mortar and pestle. The mixture was ground for four minutes at room temperature. This yellow product was characterized by Thermogravimetric Analysis (TGA), Infrared Spectroscopy (IR), and Power X-ray Diffraction (PXRD) and identified as a co-crystal. The powder was then transferred to an oven and was heated for 10 hours at 180° C. The resulting yellow powder was characterized by IR and PXRD and identified as 5,5′-(1,3,6,8-tetrahydro-1,3,6,8-tetraoxobenzo[lmn][3,8]phenanthroline-2,7-diyl)bis-1,3-Benzenedicarboxylic acid. See FIGS. 1A-1D.

### Example 2

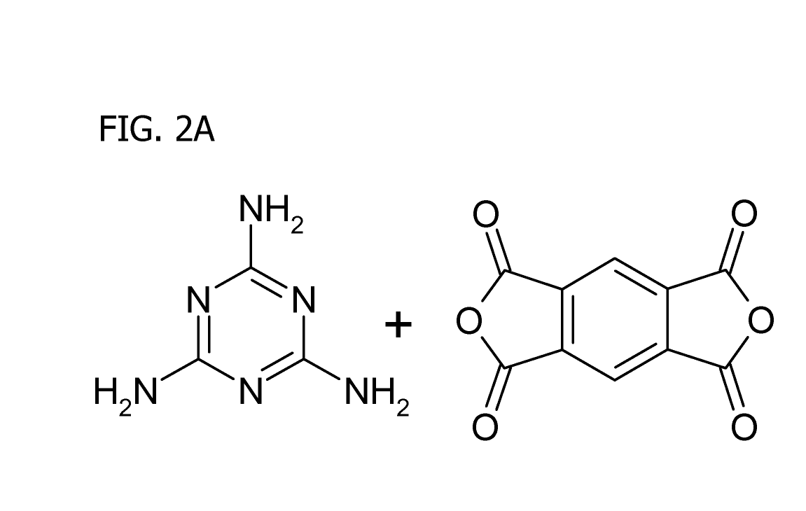

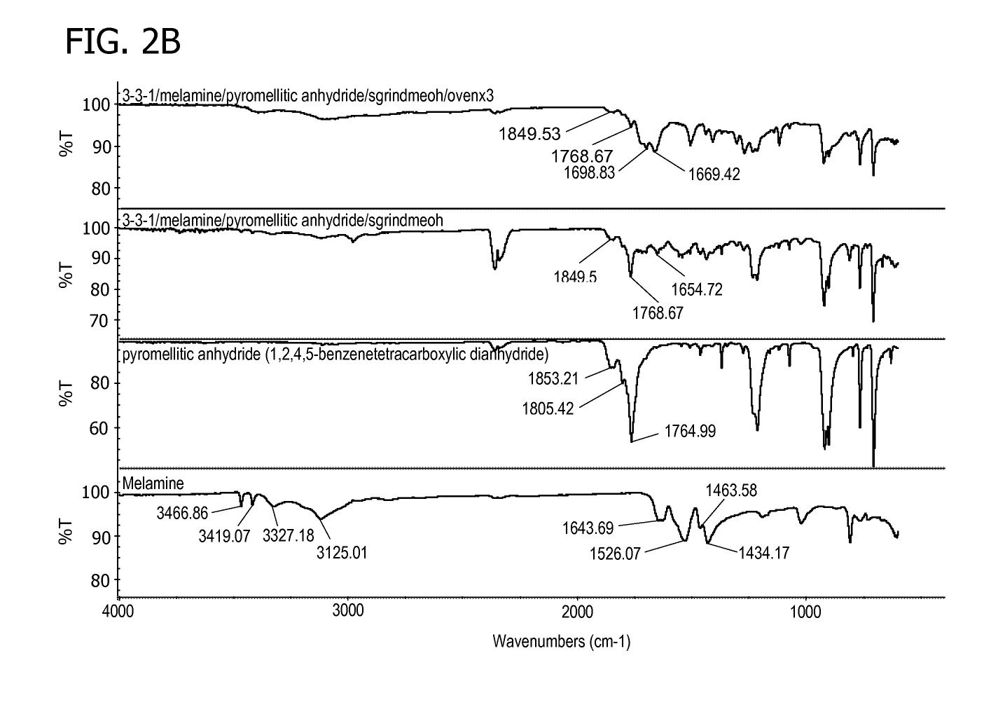

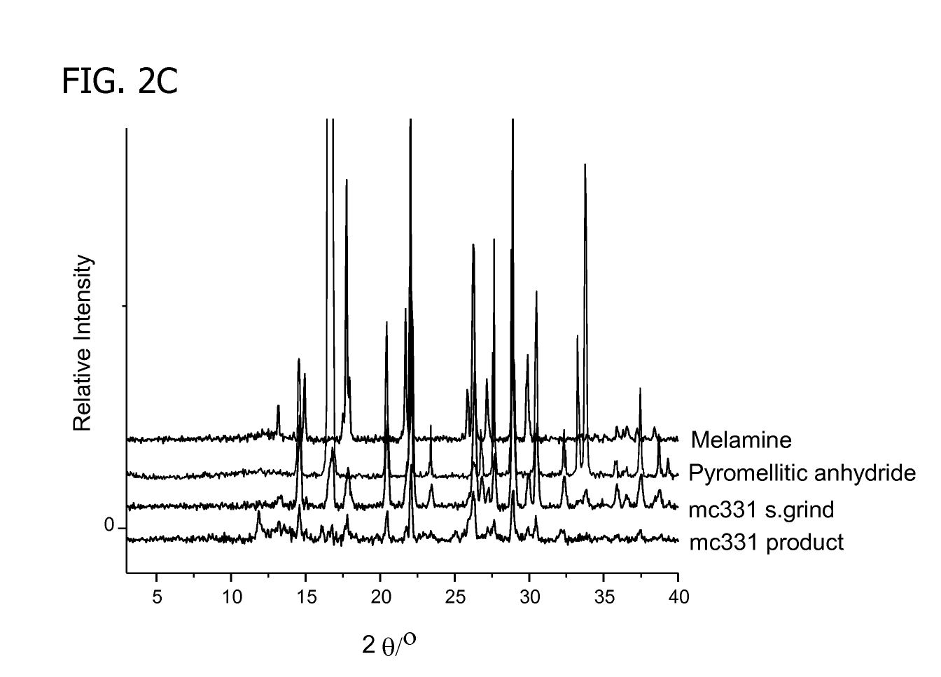

32 mg (0.25 mmol) melamine and 78 mg (0.36 mmol) pyromellitic anhydride were placed in a mortar and pestle. 20 μL of methanol solvent was added, and the mixture was ground for four minutes at room temperature. This white product was characterized by IR and PXRD and identified as a mixture. The powder was then transferred to an oven and was heated for 36 hours at 120° C. The resulting white powder was characterized by IR and PXRD and identified as an imide. See FIGS. 2A-2C.

### Example 3

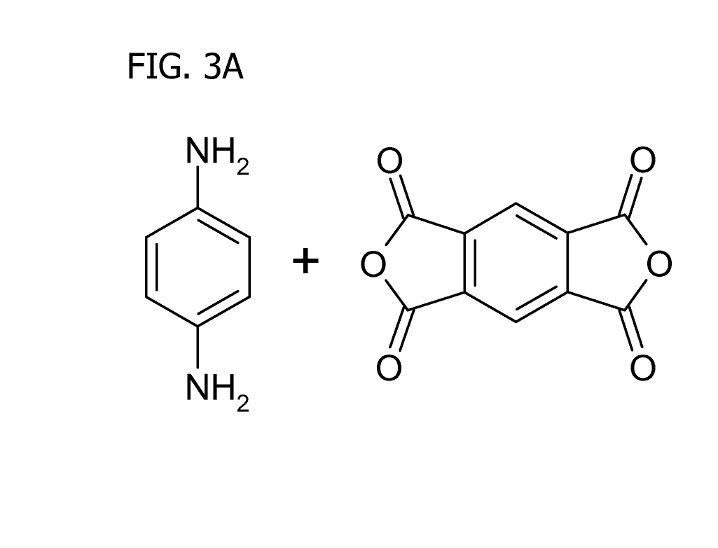

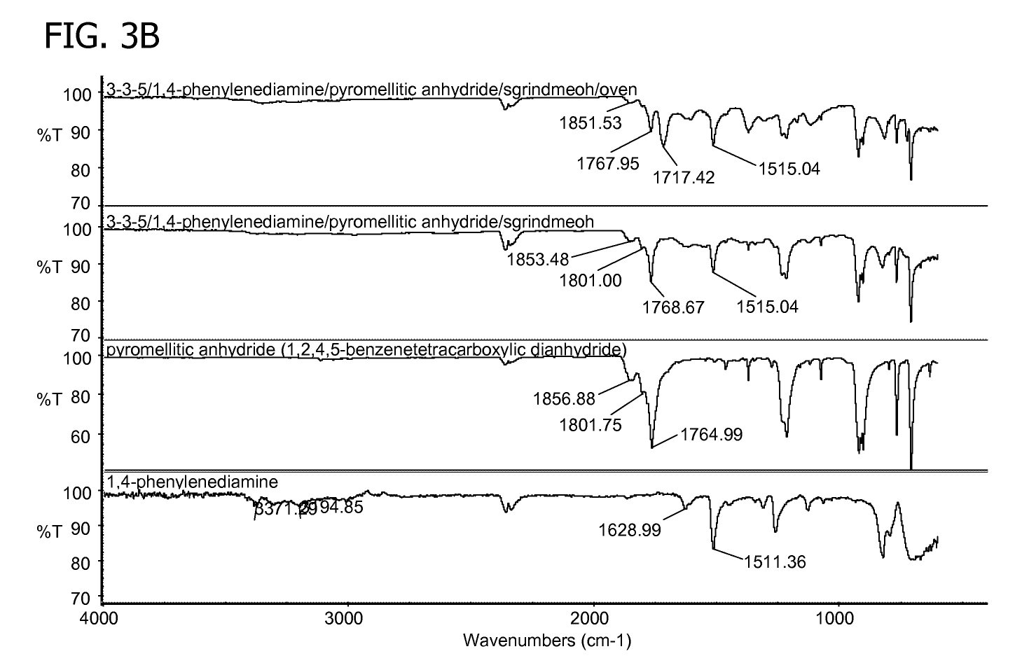

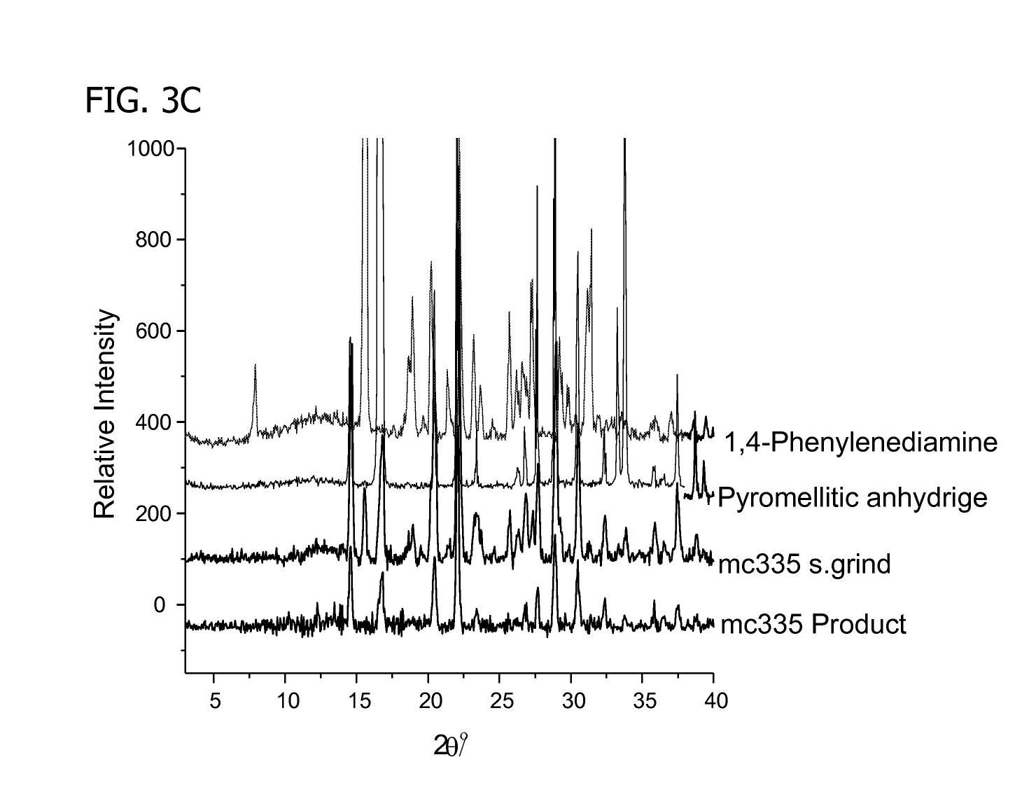

35 mg (0.32 mmol) 1,4-phenylenediamine and 72 mg (0.33 mmol) pyromellitic anhydride were placed in a mortar and pestle. 20 μL of methanol solvent was added and the mixture was ground for four minutes at room temperature. This yellow product was characterized by IR and PXRD and identified as a mixture. The powder was then transferred to an oven and was heated for 98 hours at 120° C. The resulting black powder was characterized by IR and PXRD and identified as an imide. See FIGS. 3A-3C.

### Example 4

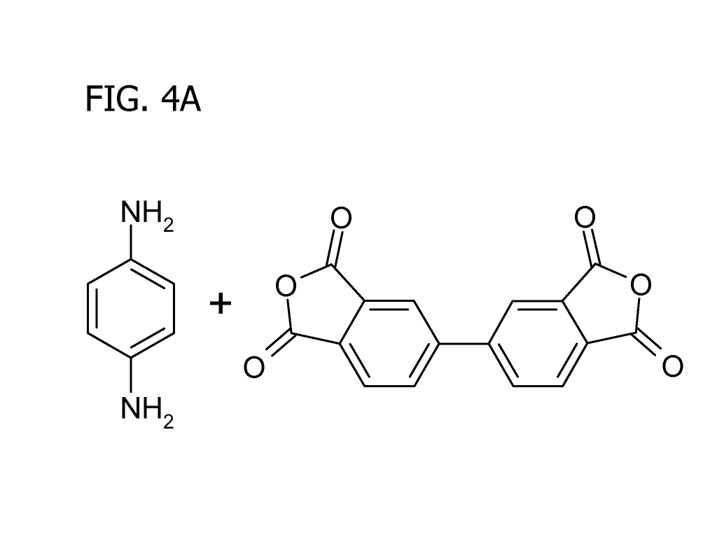

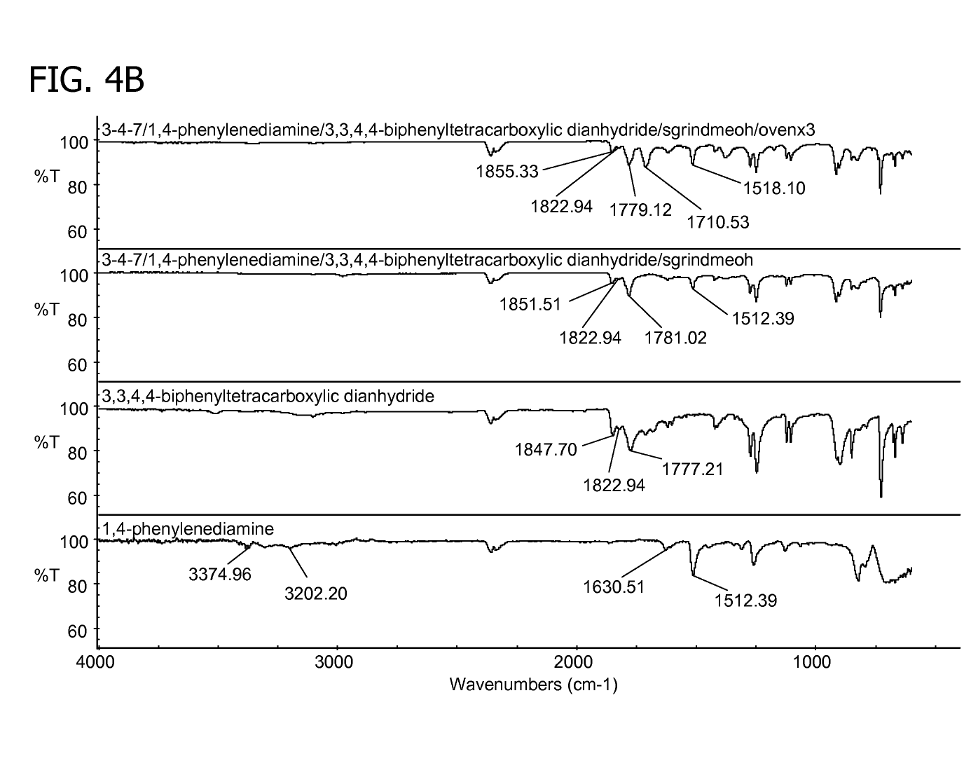

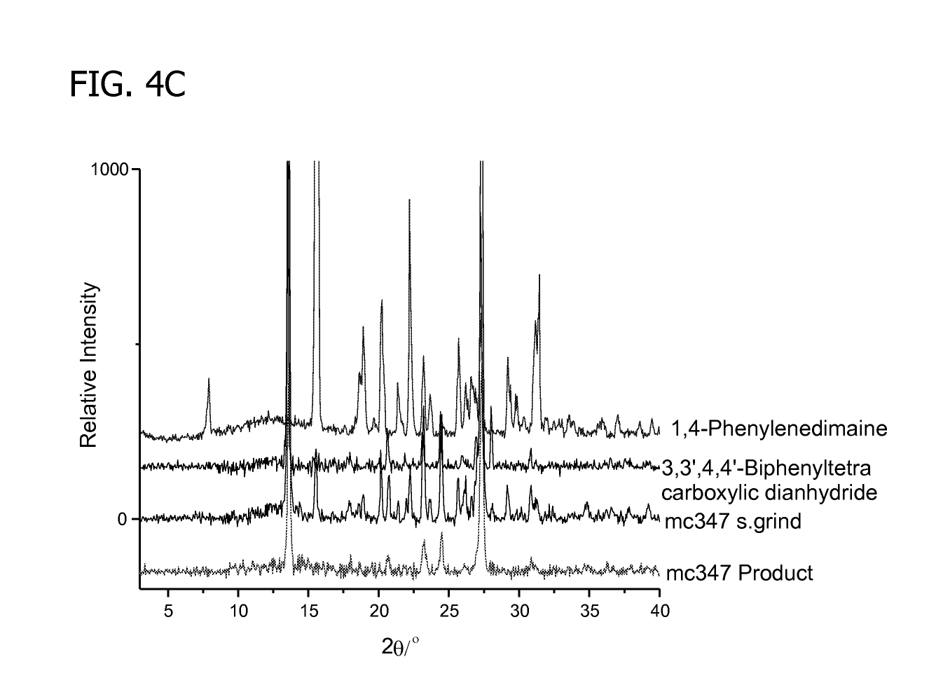

25 mg (0.23 mmol) 1,4-phenylenediamine and 70 mg (0.24 mmol) 3,3′,4,4′-biphenyltetracarboxylic dianhydride were placed in a mortar and pestle. 20 μL of methanol solvent was added and the mixture was ground for four minutes at room temperature. This yellow product was characterized by IR and PXRD and identified as a mixture. The powder was then transferred to an oven and was heated for 24 hours at 120° C. The resulting black powder was characterized by IR and PXRD and identified as an imide. See FIGS. 4A-4C.

### Example 5

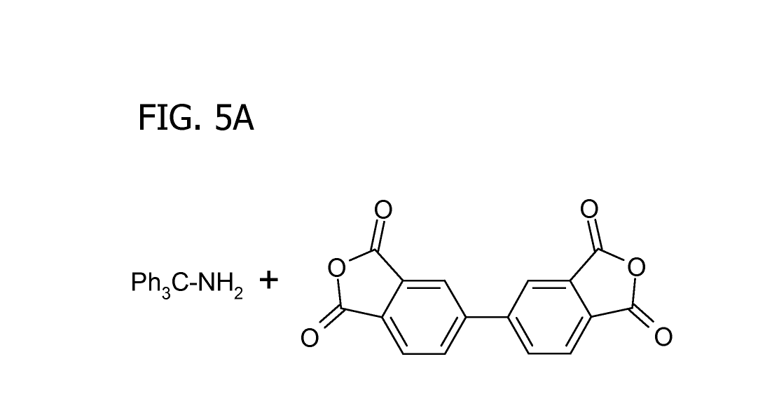

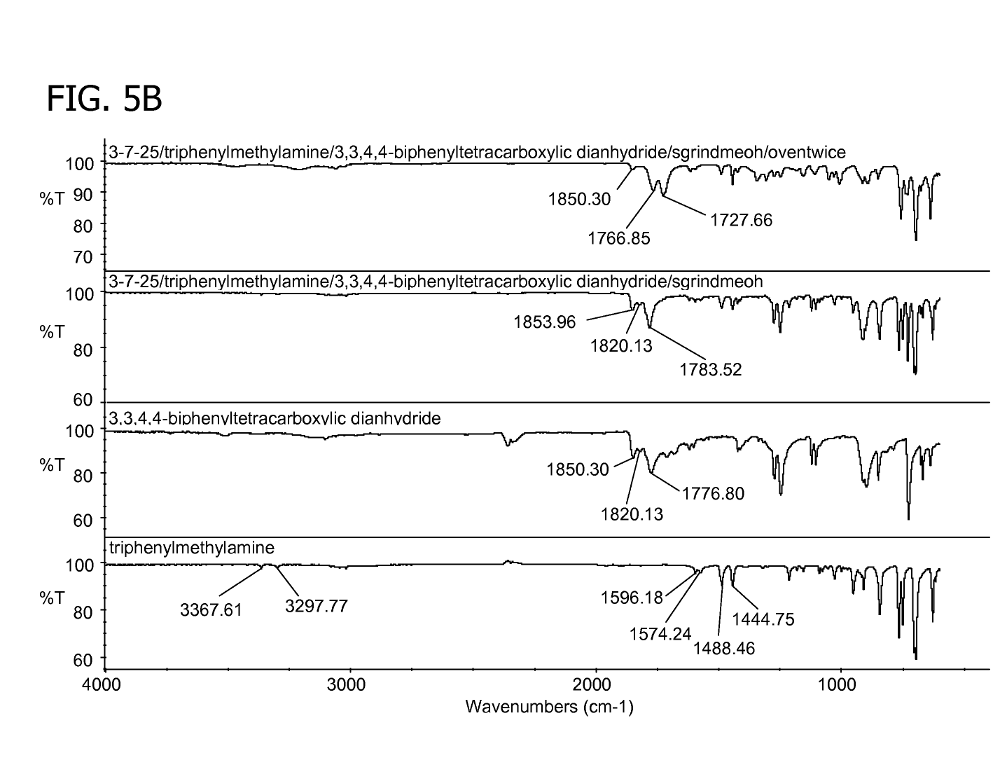

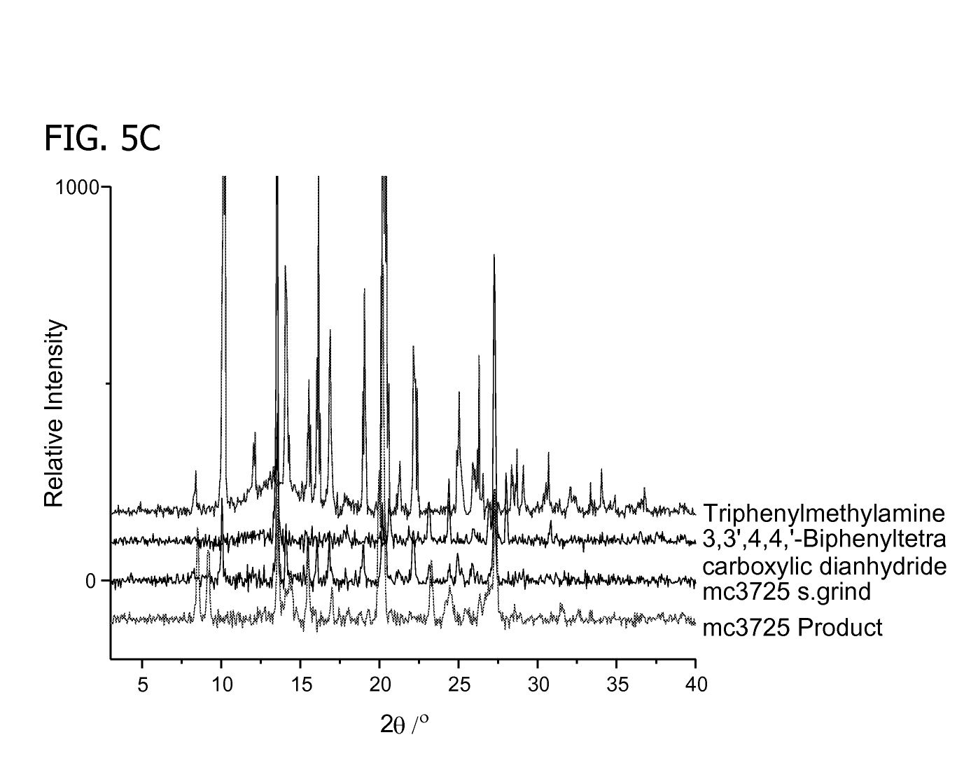

62 mg (0.24 mmol) triphenylmethylamine (62 mg, 0.24 mmol) and 38 mg (0.13 mmol) 3,3′,4,4′-biphenyltetracarboxylic dianhydride were placed in a mortar and pestle. 20 μL of methanol solvent was added and the mixture was ground for four minutes at room temperature. This white product was characterized by IR and PXRD and identified as a mixture. The powder was then transferred to an oven and was heated for 84 hours at 120° C. The resulting light pink powder was characterized by IR and PXRD. See FIGS. 5A-5C.

### Example 6

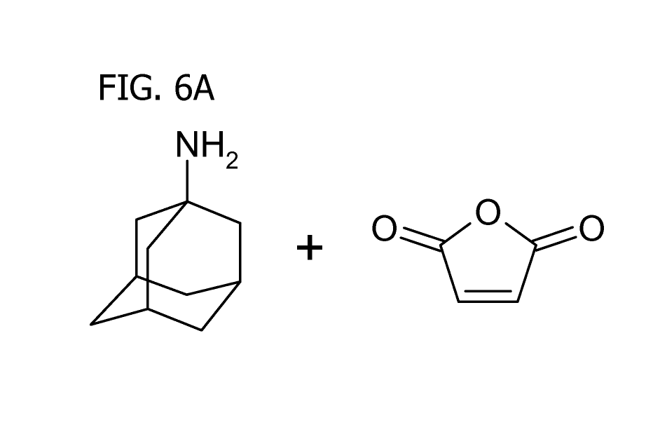

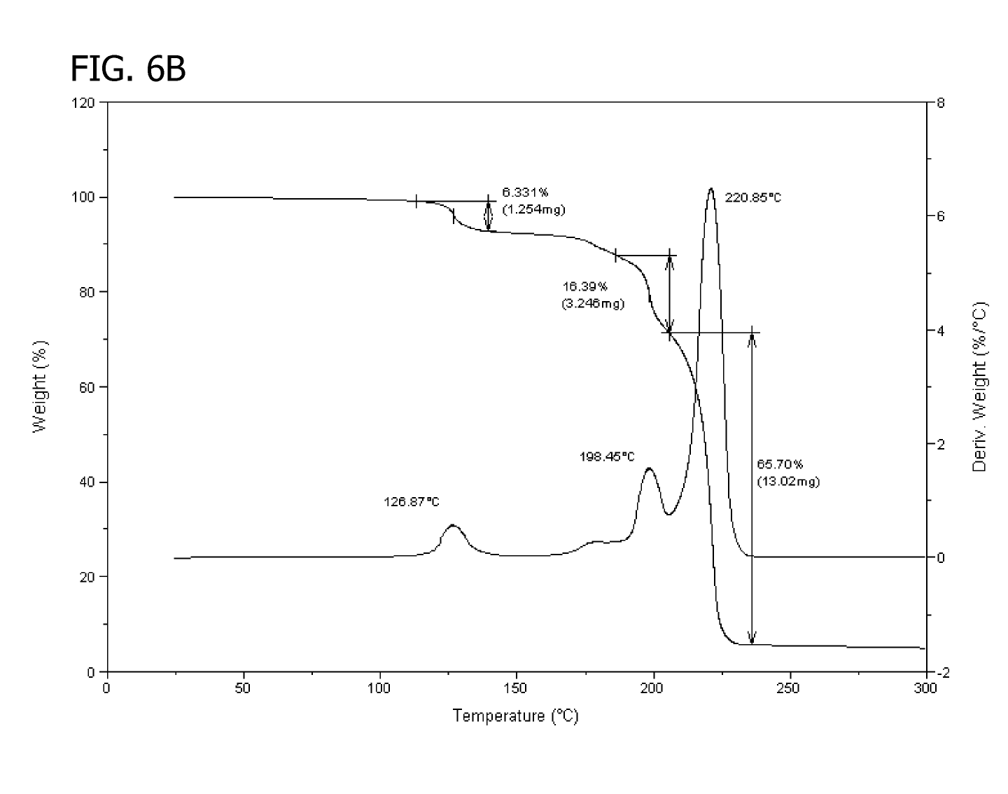

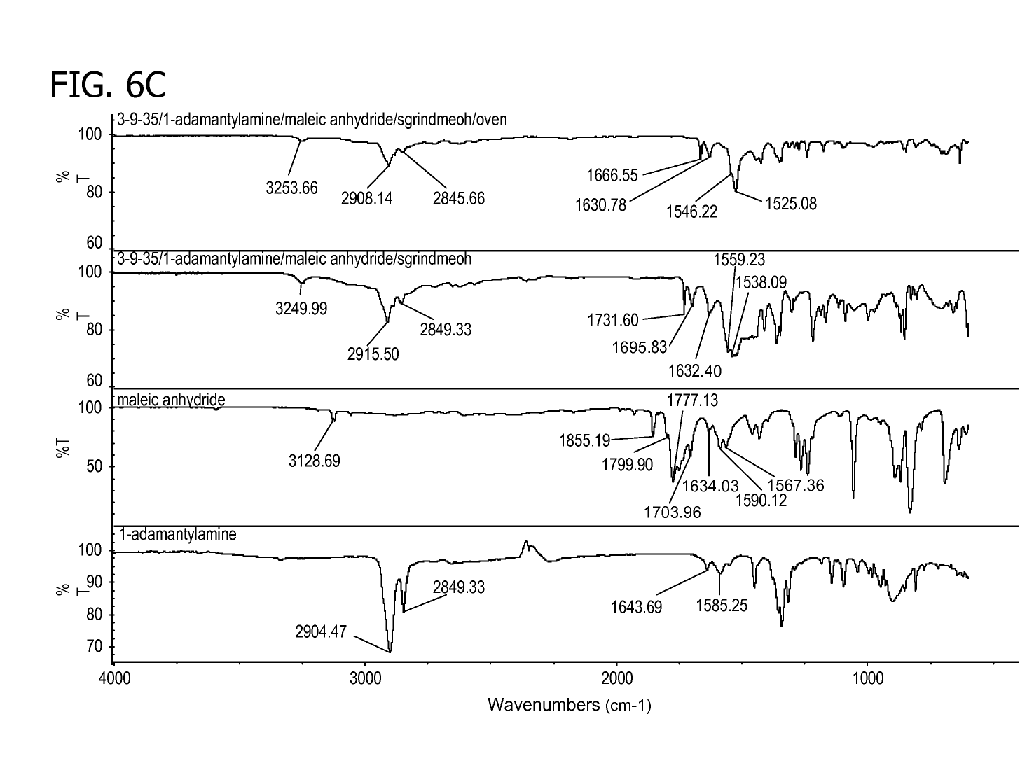

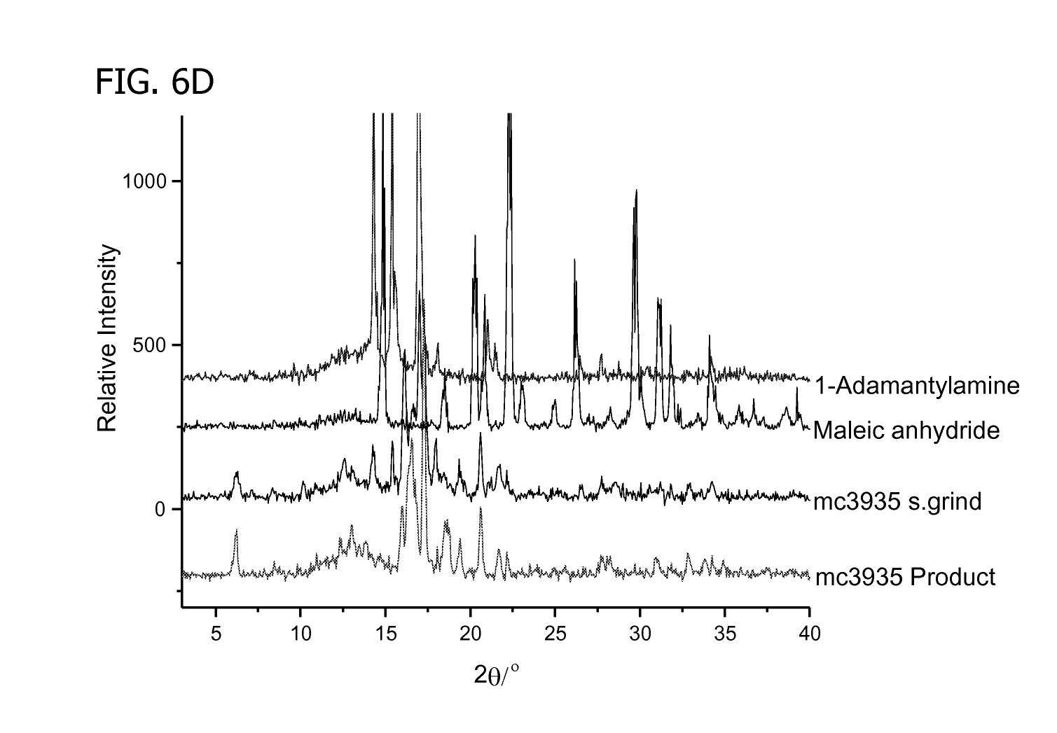

60 mg (0.4 mmol) 1-adamantylamine and 40 mg (0.4 mmol) maleic anhydride were placed in a mortar and pestle. 20 μL of methanol was added and the mixture was ground for four minutes at room temperature. This white product was characterized by TGA, IR, and PXRD and identified as a mixture. The powder was then transferred to an oven and was heated for 19.5 hours at 120° C. The resulting white powder was characterized by IR and PXRD and identified as N-adamantylmaleimide. See FIGS. 6A-6D.

### Example 7

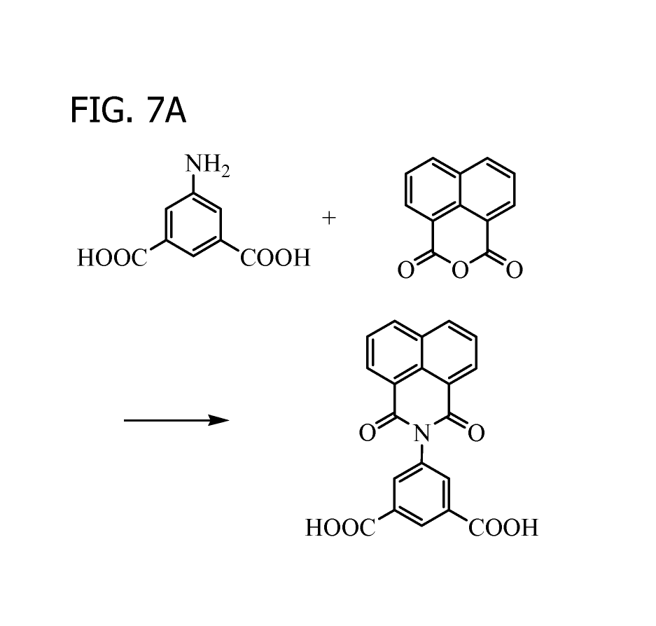

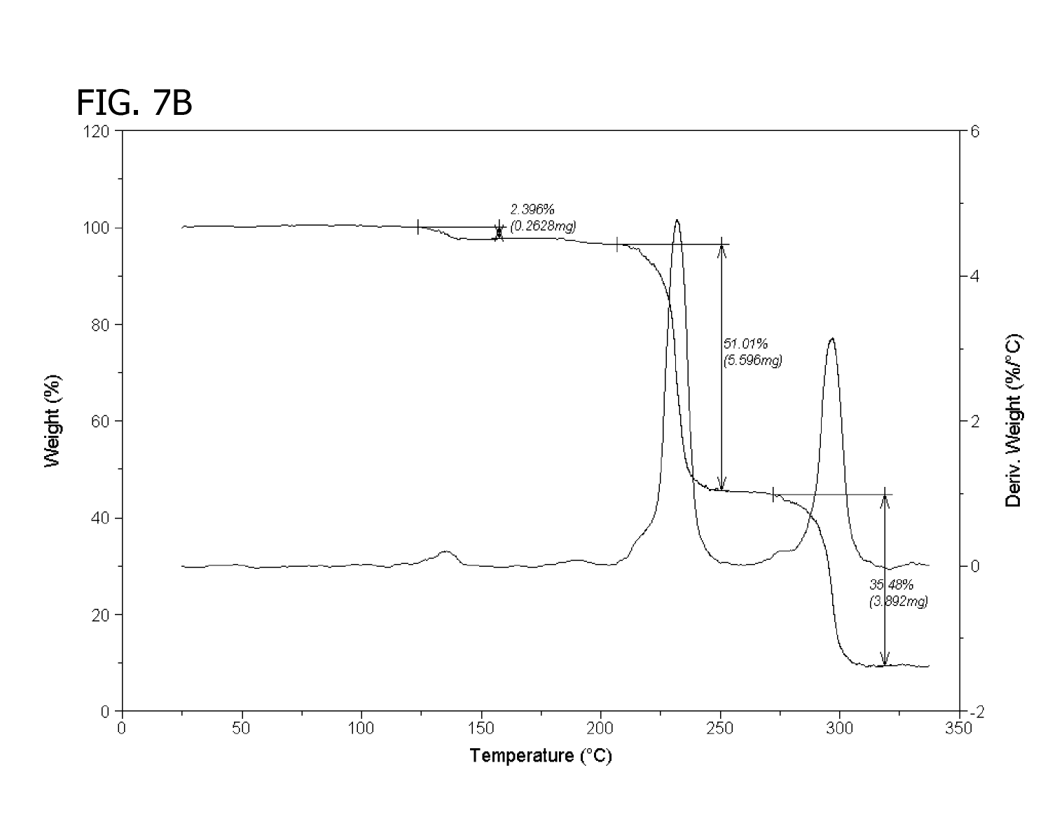

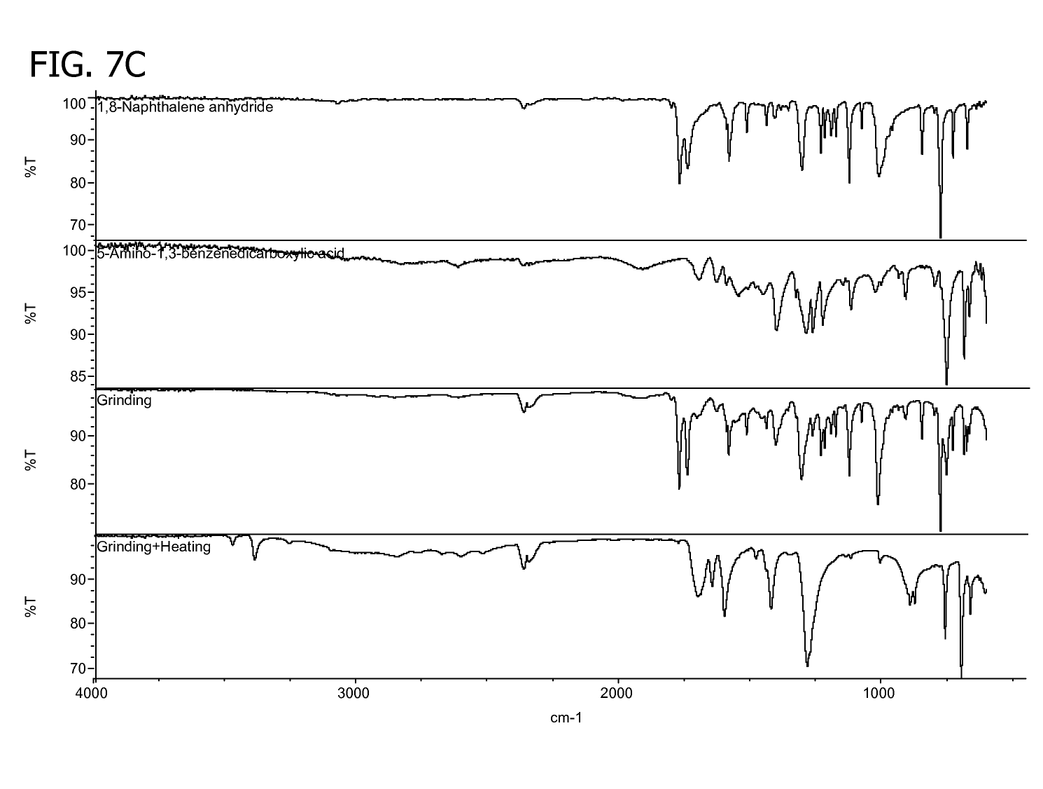

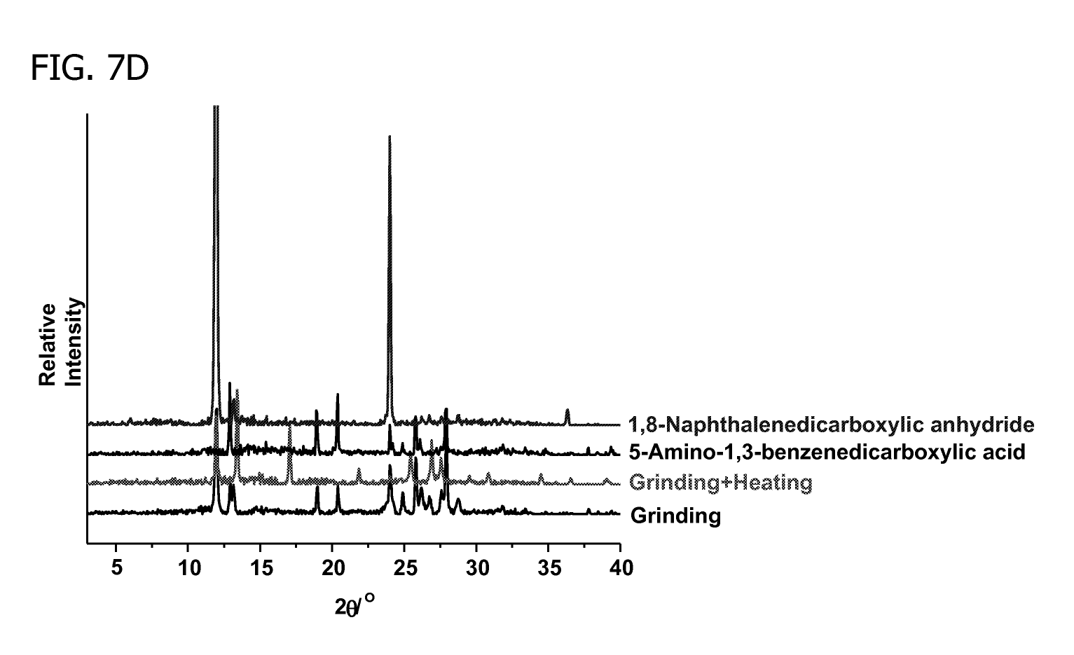

48 mg (0.26 mmol) 5-amino-1,3-benzenedicarboxylic acid and 52 mg (0.26 mmol) 1,8-naphthalenedicarboxylic anhydride were placed in a mortar and pestle. The mixture was ground for four minutes at room temperature. This yellowish product was characterized by TGA, IR and PXRD and identified as a mixture. The powder was then transferred to an oven and was heated for 10 hours at 180° C. The resulting yellow powder was characterized by IR and PXRD and identified as 5-(1,3-dioxo-1H-benz[de]isoquinolin-2(3H)-yl)1,3-benzendicarboxylic acid. See FIGS. 7A-7D.

### Example 8

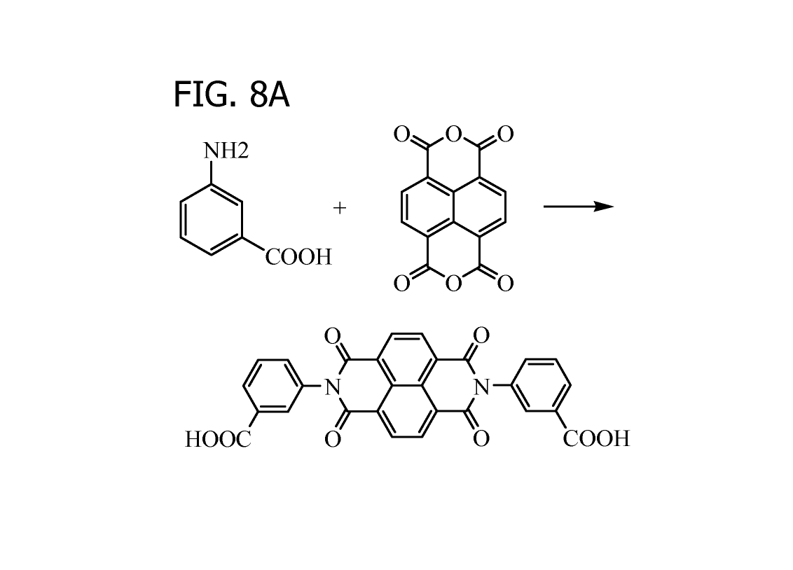

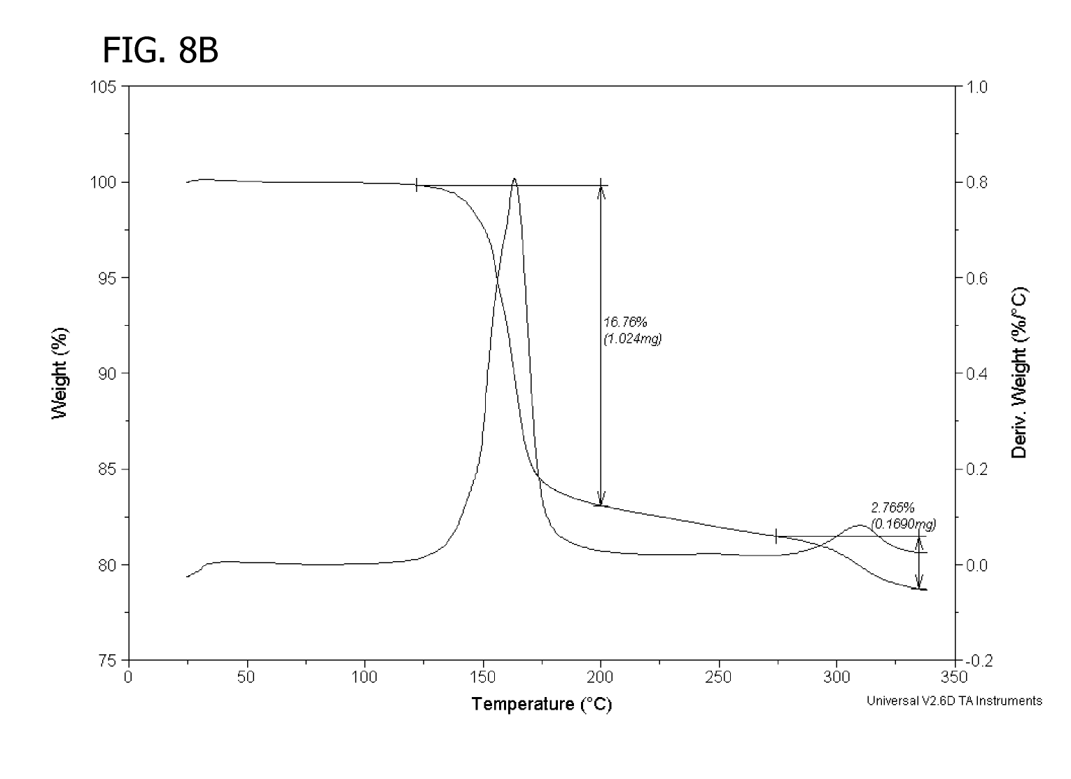

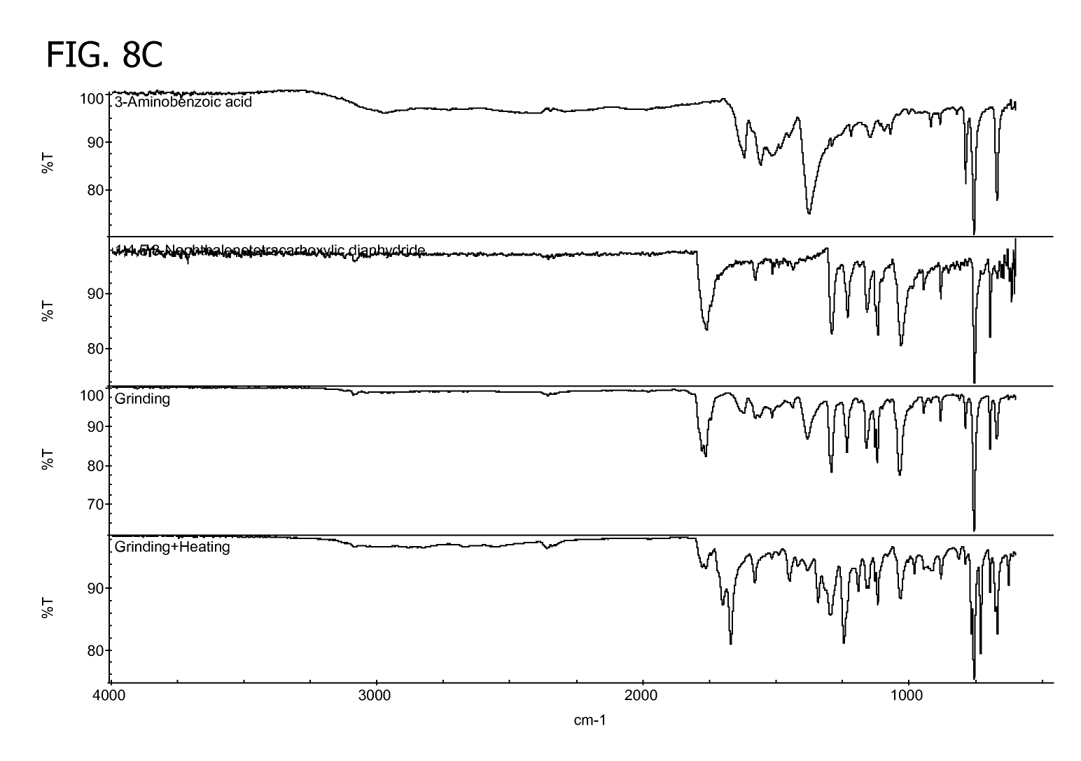

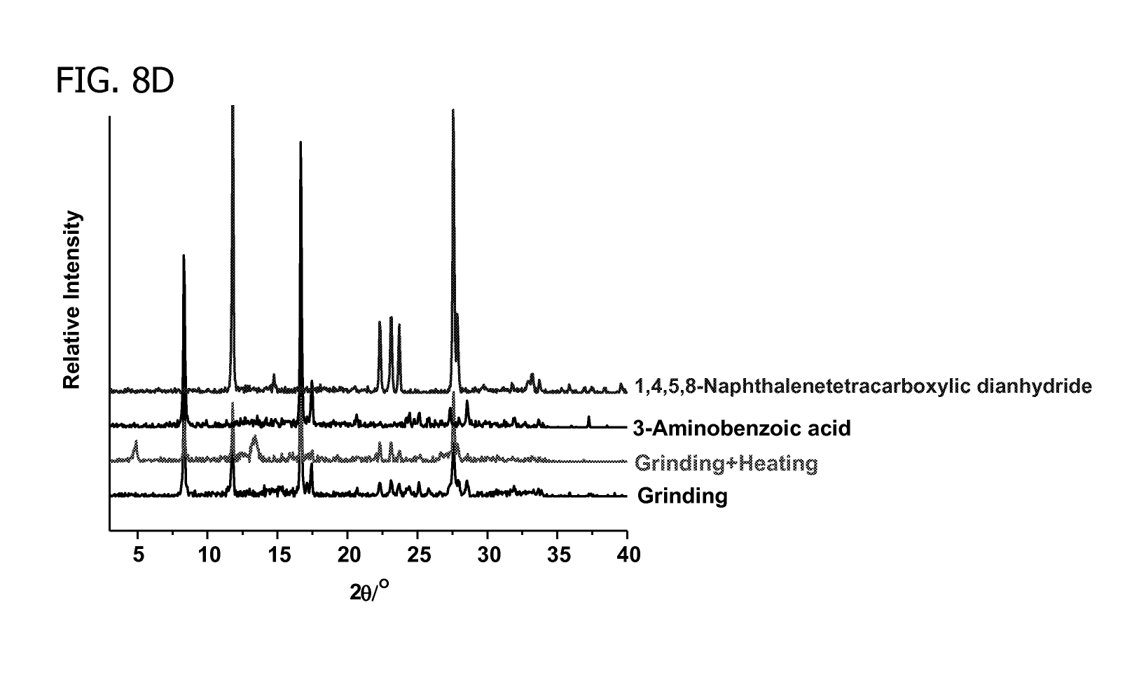

140 mg (1.0 mmol) 3-aminobenzoic acid and 130 mg (0.5 mmol) 1,4,5,8-naphthalenetetracarboxylic dianhydride were placed in a mortar and pestle. The mixture was ground for four minutes at room temperature. This yellow product was characterized by TGA, IR and PXRD and identified as a co-crystal. The powder was then transferred to an oven and was heated for 14 hours at 150° C. The resulting yellow powder was characterized by IR and PXRD and identified as 3,3′-(1,3,68-tetrahydro-1,3,6,8-tetraoxobenzo[3,8]phenanthroline-2,7-diyl)bis-benzoic acid. See FIGS. 8A-8D.

### Example 9

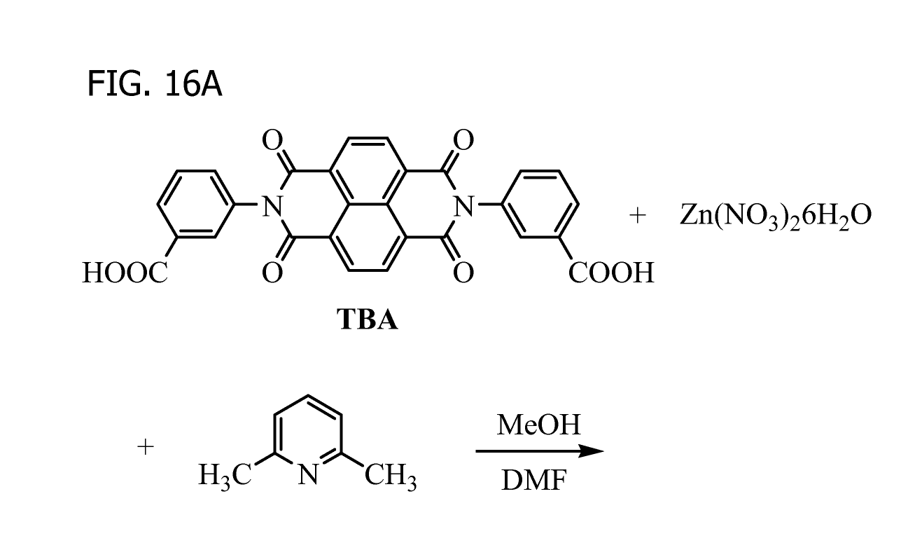

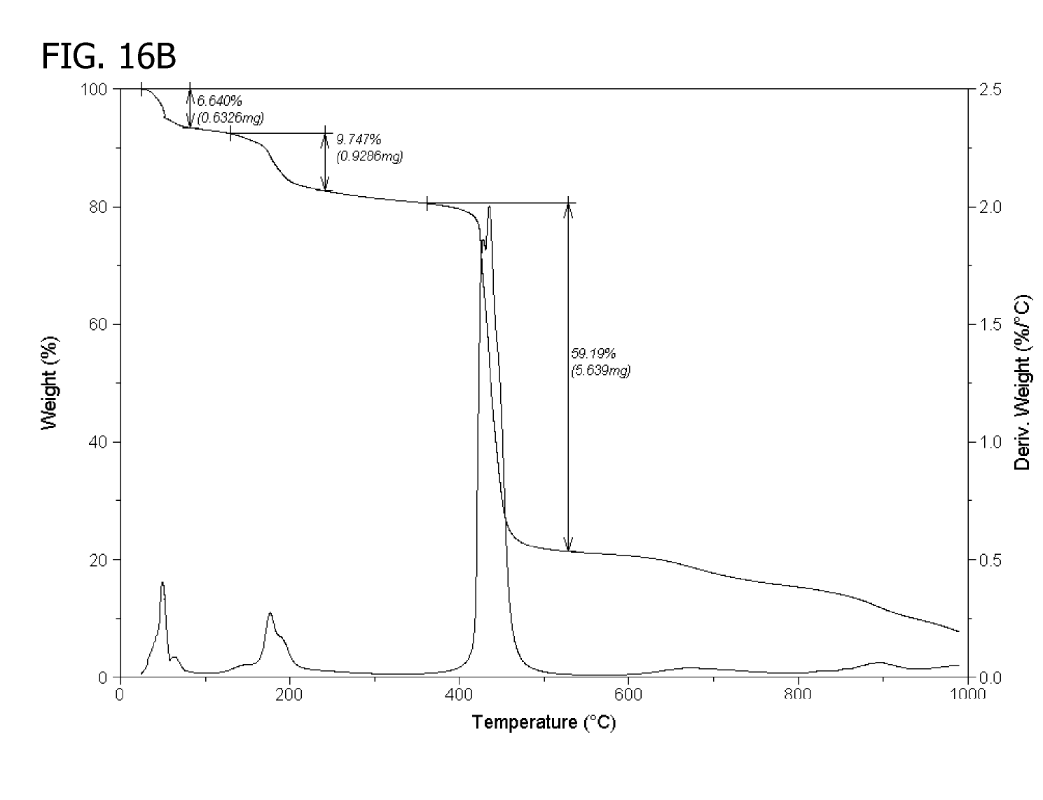

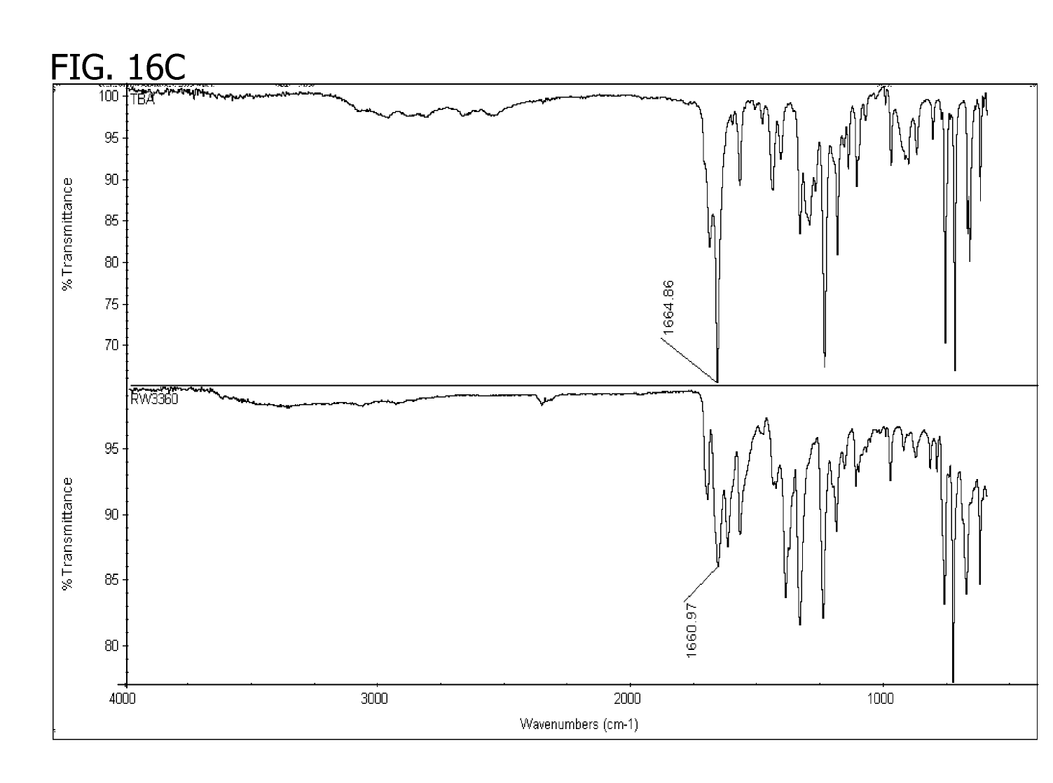

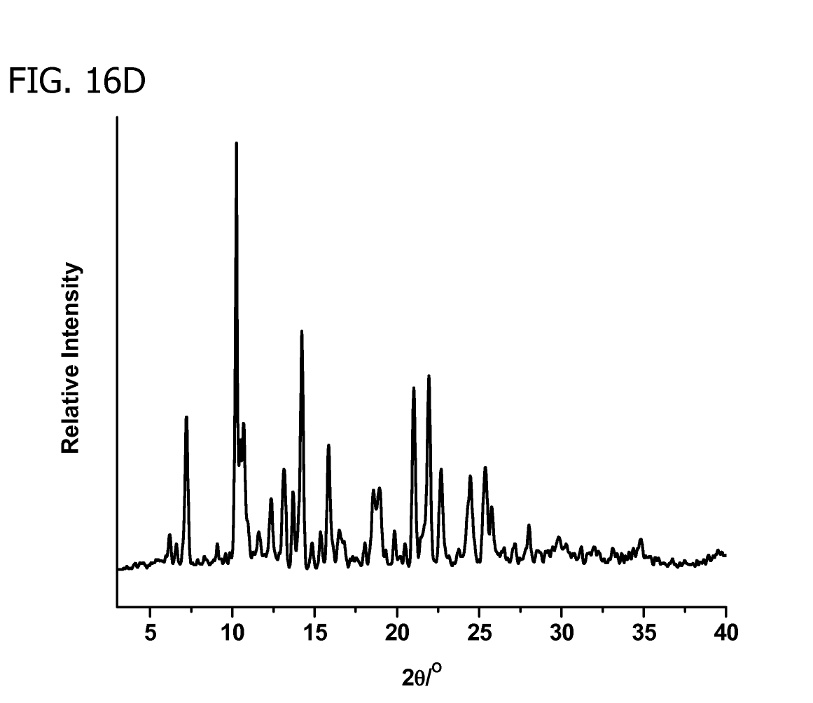

10 mg (0.02 mmol) of the product from Example 8 and 7 μL (0.06 mmol) 2,6-lutidine were dissolved in 4 mL dimethylformamide (DMF). 15 mg (0.05 mmol) Zn(NO₃)₂6H₂O was dissolved in 3 mL methyl alcohol (MeOH), which was then carefully layered onto the DMF solution. Pink block crystals appeared after about 12 hours. The product was characterized by TGA, IR, and PXRD. See FIGS. 16A-16D.

### Example 10

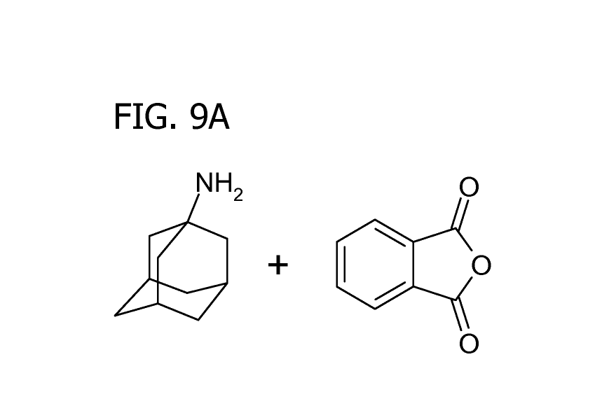

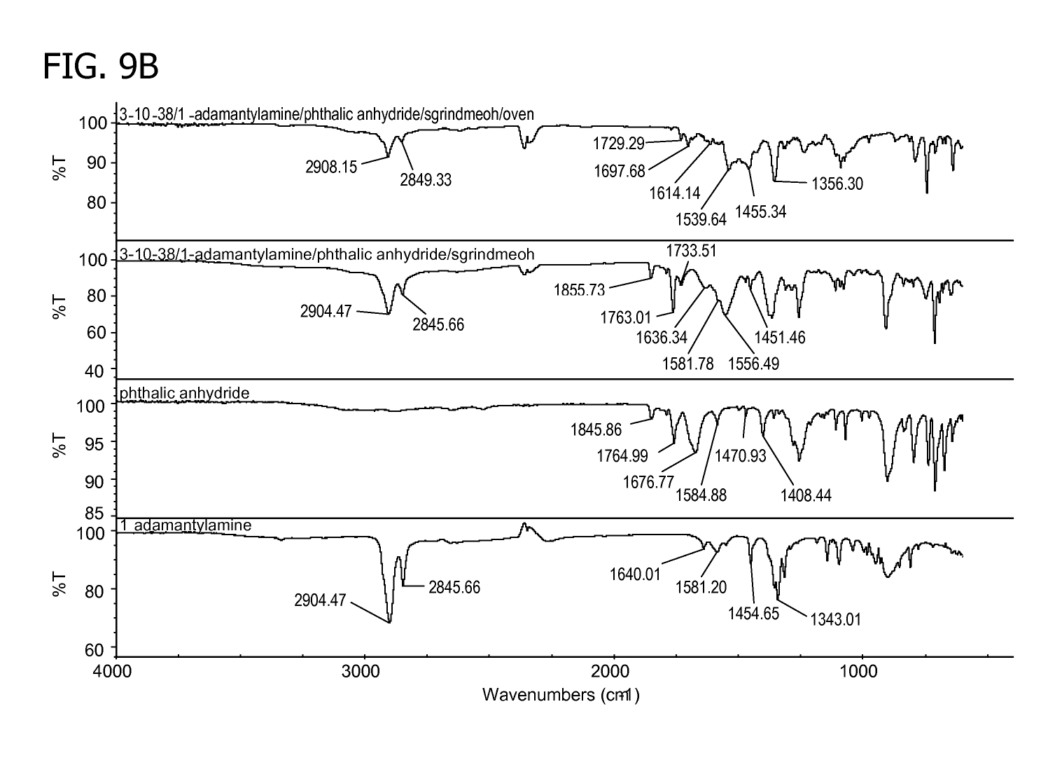

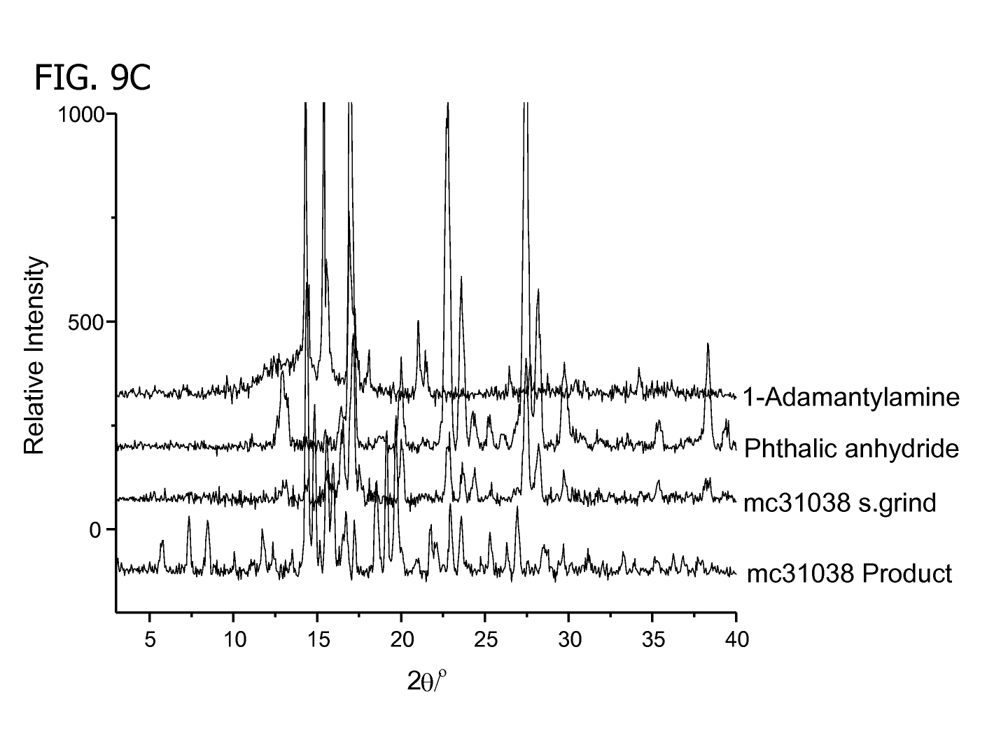

50 mg (0.33 mmol) 1-adamantylamine and 49 mg (0.33 mmol) phthalic anhydride were placed in a mortar and pestle. 20 μL of methanol solvent was added and the mixture was ground for four minutes at room temperature. This white product was characterized by IR and PXRD and identified as a mixture. The powder was then transferred to an oven and was heated for 19 hours at 120° C. The resulting white powder was characterized by IR and PXRD and identified as 1-adamantylphthalimide. See FIGS. 9A-9C.

The intermediate can be isolated via solvent drop grinding followed by heating for 1.5 hours at 110° C. Single crystals of the intermediate can be grown by slow evaporation in acetonitrile. The X-ray structure shows the typical intermediate to forming the imide product. A simulated X-ray powder diffraction pattern was then compared to the experimental pattern from the heated material for further conformation of intermediate formation. Further heating of the white powder for a total of 144 hours at 120° C. resulted in 1-adamantylphthalimide.

Crystal data for 1-Adamantylphthalamic acid: Monoclinic, space group P2(1)/c, a=13.045(7) Å, b=9.761(5) Å, c=12.785(7) Å, α=90°, β=110.402(8)°, γ=90°, V=1525.7(14) Å³, Z=4, ρ_{calc}=1.303 Mg/m³, T=293K, μ=0.088 mm⁻¹, 8766 reflections measured, 3420 independent reflections, [I>2σ(I)], R1==0.0535, wR2=0.1242, crystal size: 0.40×0.35×0.10 mm³.

### Example 11

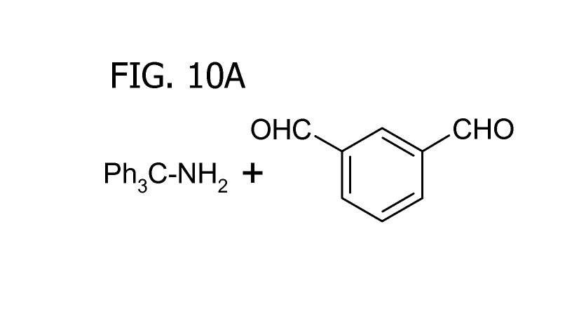

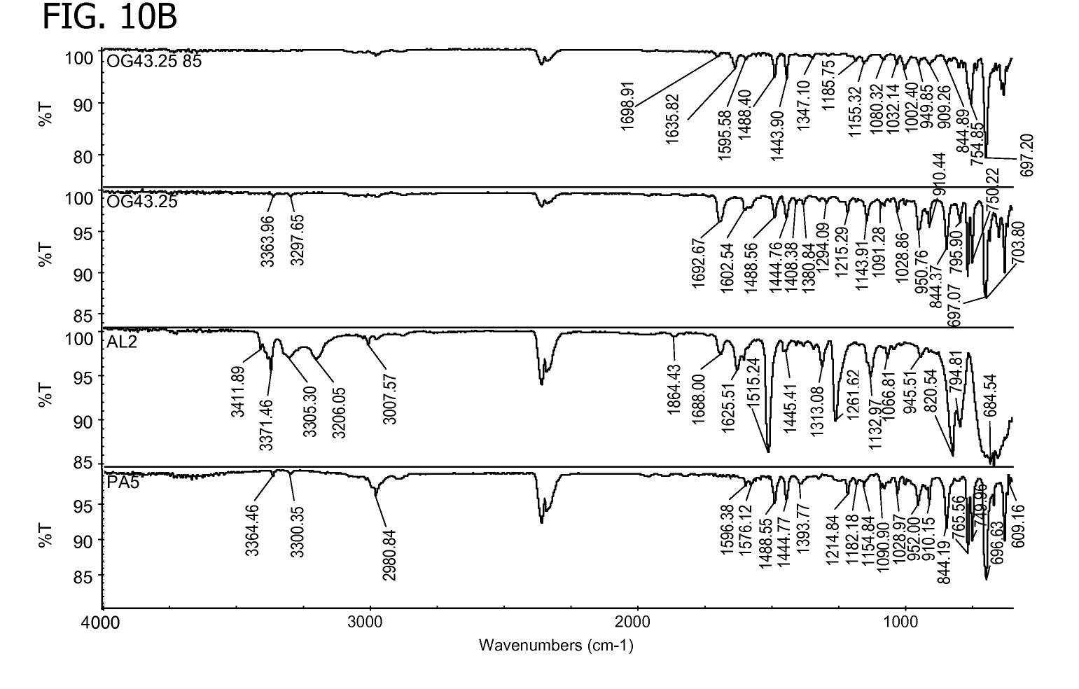

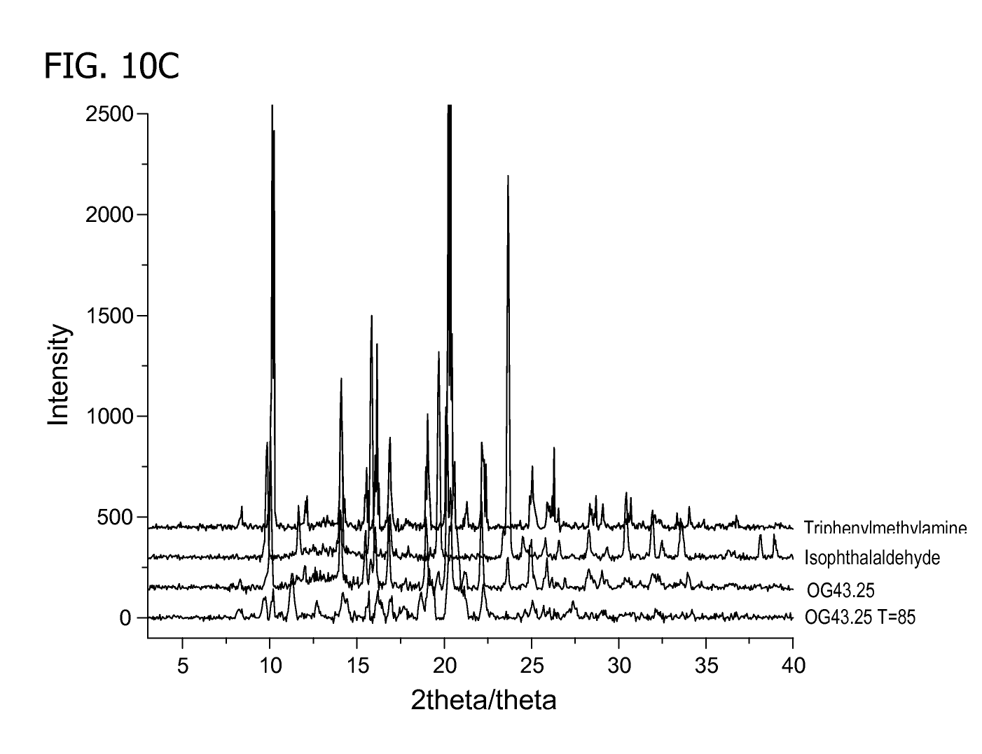

78 mg (0.3 mmol) triphenylmethylamine and 20 mg (0.15 mmol) isophthalaldehyde were placed in a mortar and pestle. 20 μL of methanol was added and the mixture was ground for four minutes at room temperature. This white product was characterized by IR and PXRD and identified as a mixture. The powder was then transferred to an oven and was heated for 12 hours at 85° C. The resulting white powder was characterized by IR and PXRD. See FIGS. 10A-10C.

### Example 12

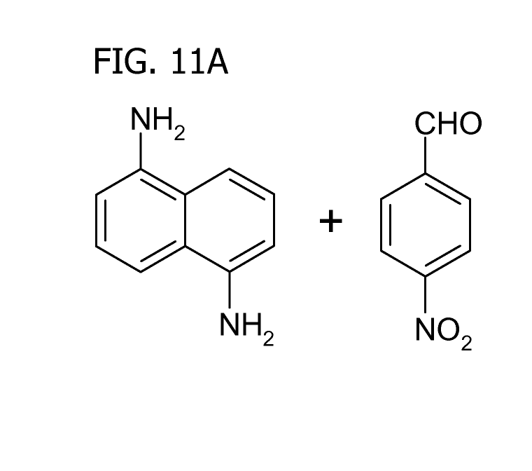

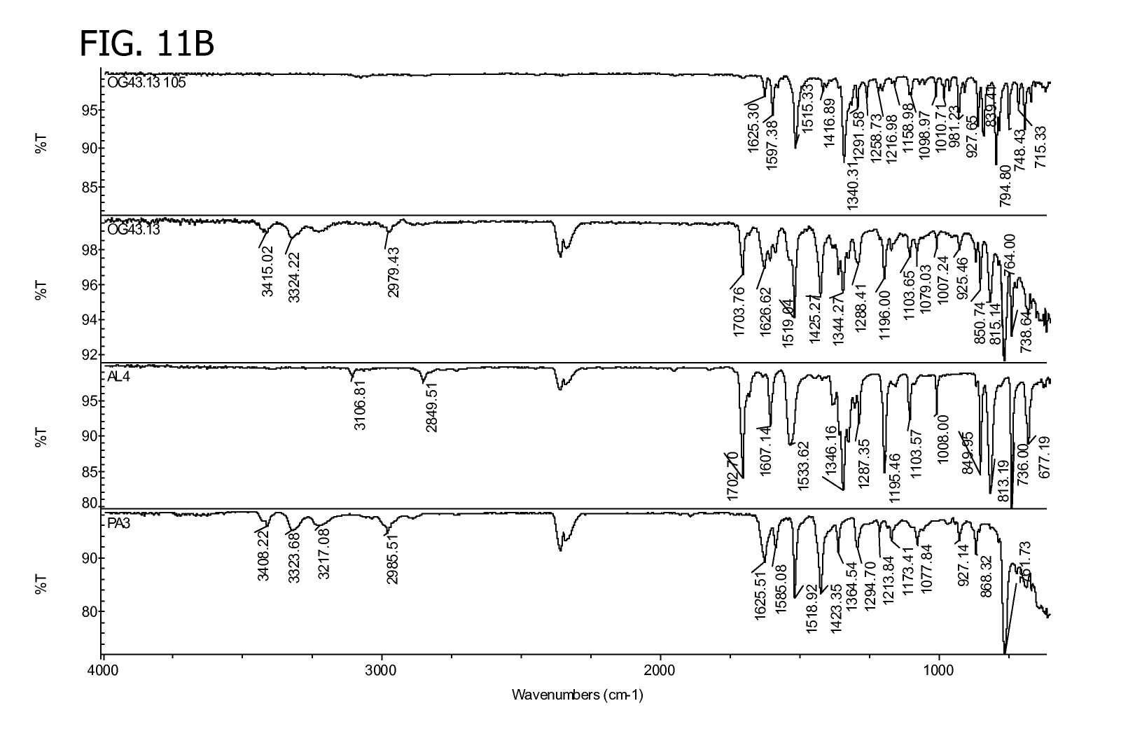

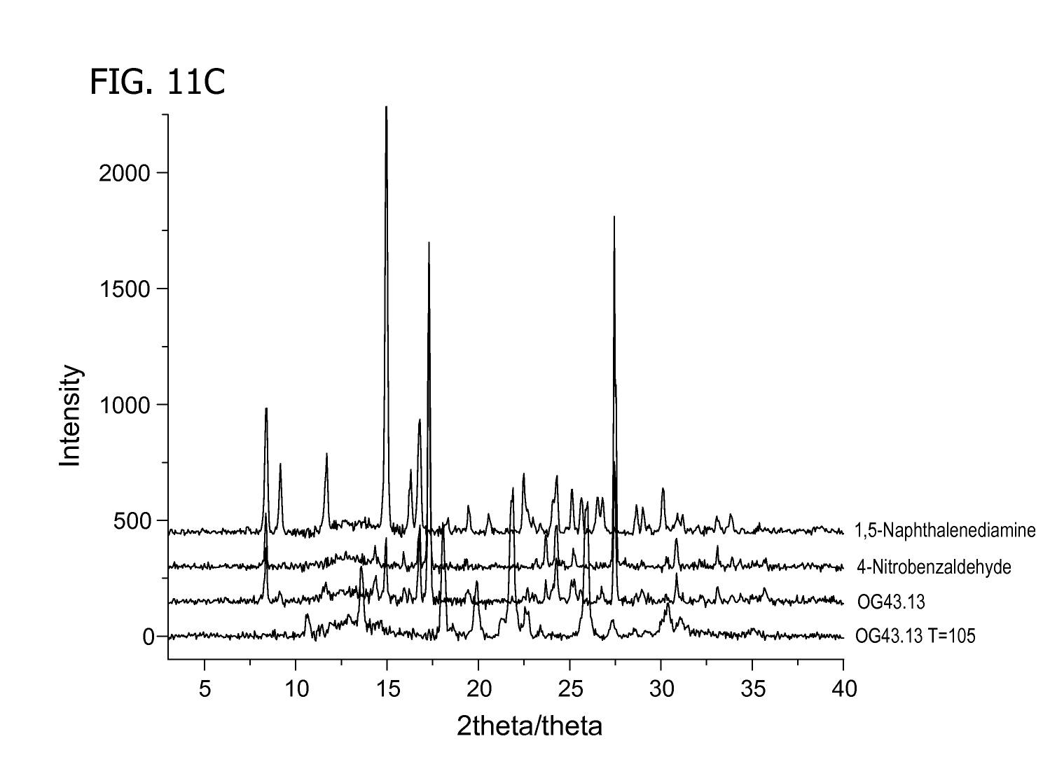

39 mg (0.25 mmol) 1,5-naphthalenediamine and 76 mg (0.5 mmol) 4-nitrobenzaldehyde were placed in a mortar and pestle. 23 μL of methanol was added and the mixture was ground for four minutes at room temperature. This light brown product was characterized by IR and PXRD and identified as a mixture. The powder was then transferred to an oven and was heated for 12 hours at 105° C. The resulting dark yellow powder was characterized by IR and PXRD and identified as N,N′-bis[(4-nitrophenyl)methylene]-1,5-naphthalenediamine. See FIGS. 11A-11C.

### Example 13

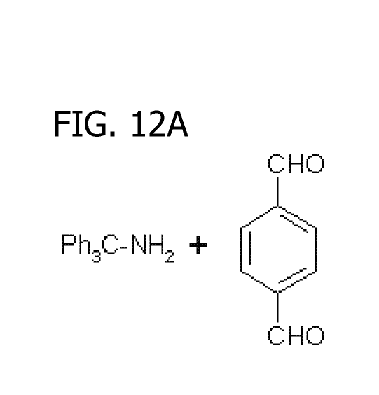

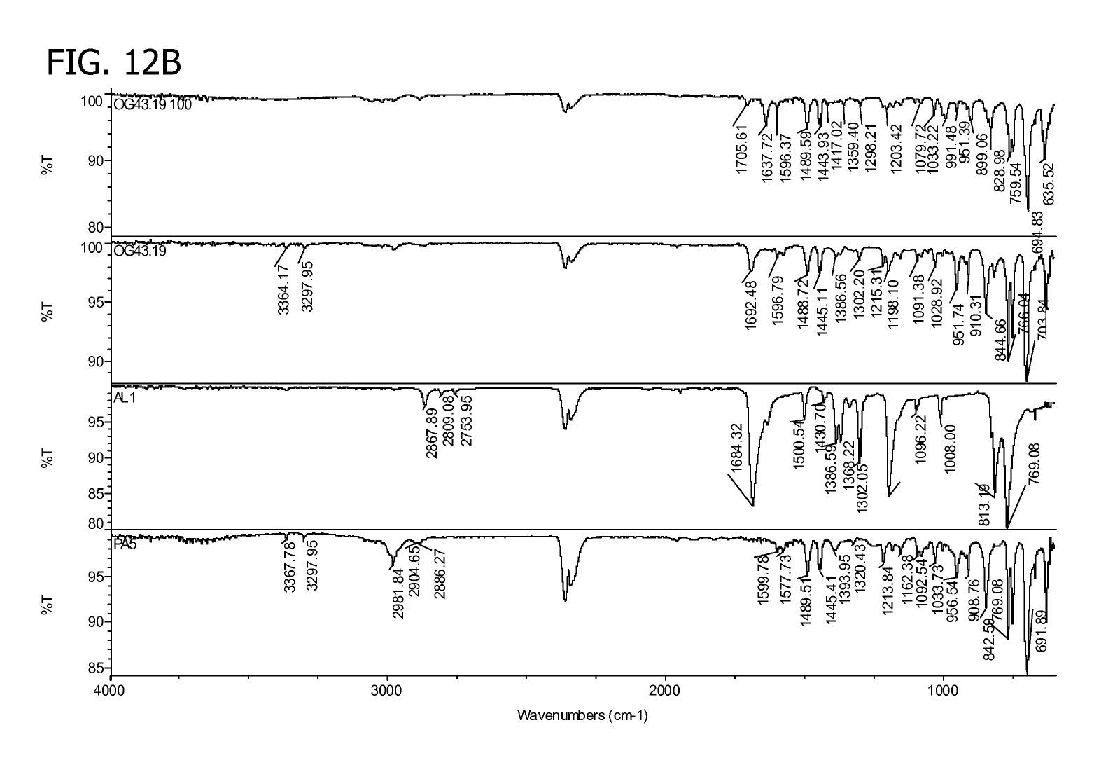

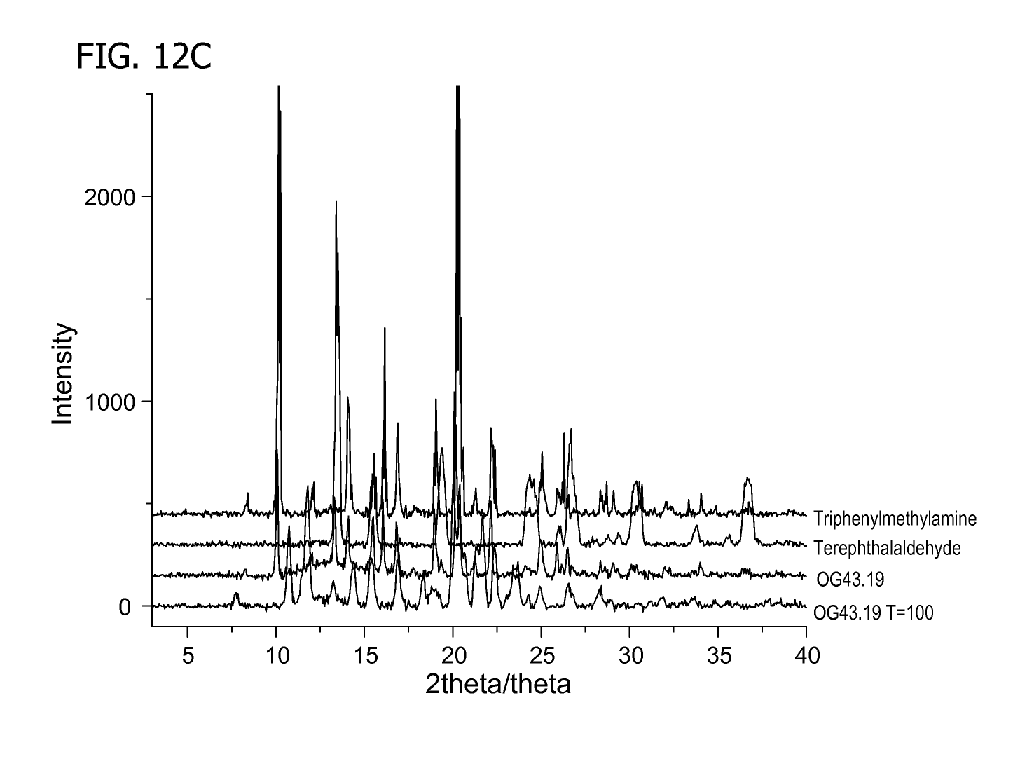

78 mg (0.3 mmol) triphenylmethylamine and 20 mg (0.15 mmol) terephthalaldehyde were placed in a mortar and pestle. 20 μL of methanol was added and the mixture was ground for four minutes at room temperature. This white product was characterized by IR and PXRD and identified as a mixture. The powder was then transferred to an oven and was heated for 12 hours at 100° C. The resulting white powder was characterized by IR and PXRD. See FIGS. 12A-12C.

### Example 14

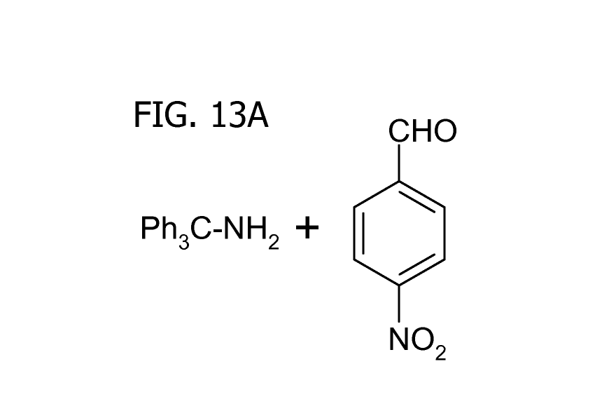

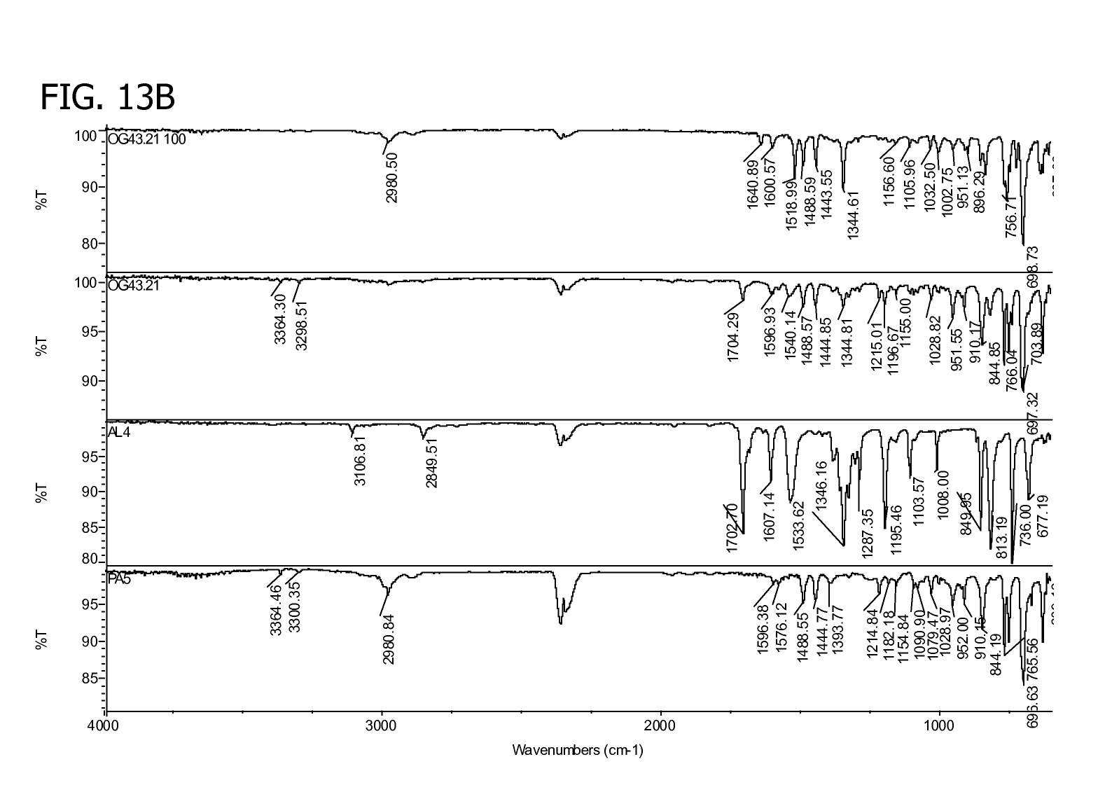

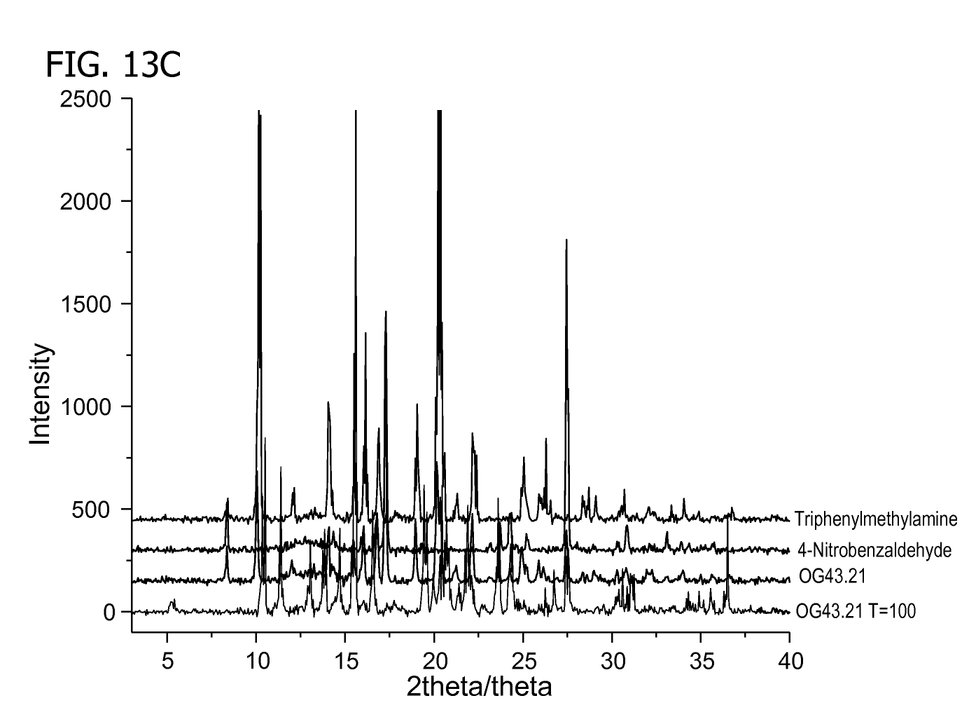

65 mg (0.25 mmol) triphenylmethylamine and 37 mg (0.25 mmol) 4-nitrobenzaldehyde were placed in a mortar and pestle. 20 μL of methanol was added and the mixture was ground for four minutes at room temperature. This white product was characterized by IR and PXRD and identified as a mixture. The powder was then transferred to an oven and was heated for 12 hours at 100° C. The resulting white crystalline product was characterized by IR and PXRD. See FIGS. 13A-13C.

### Example 15

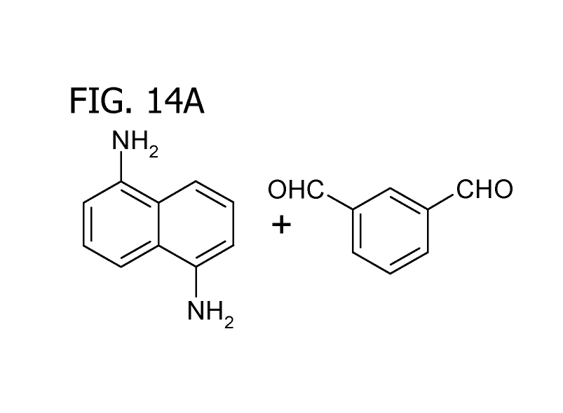

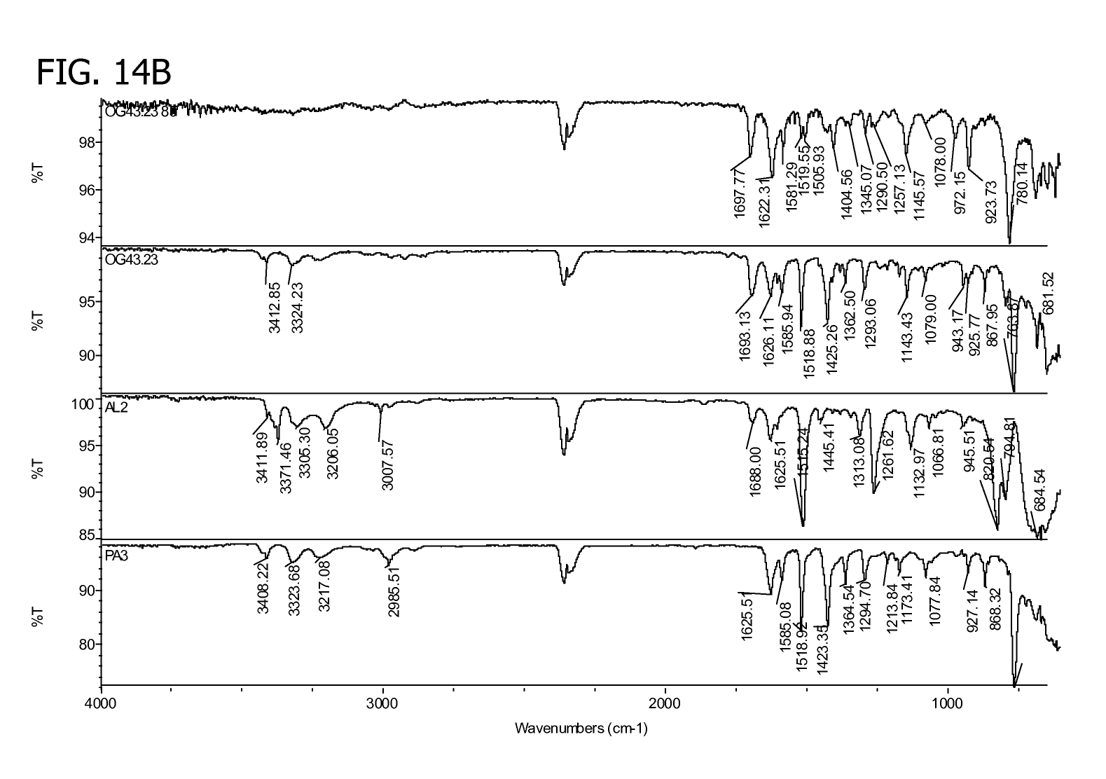

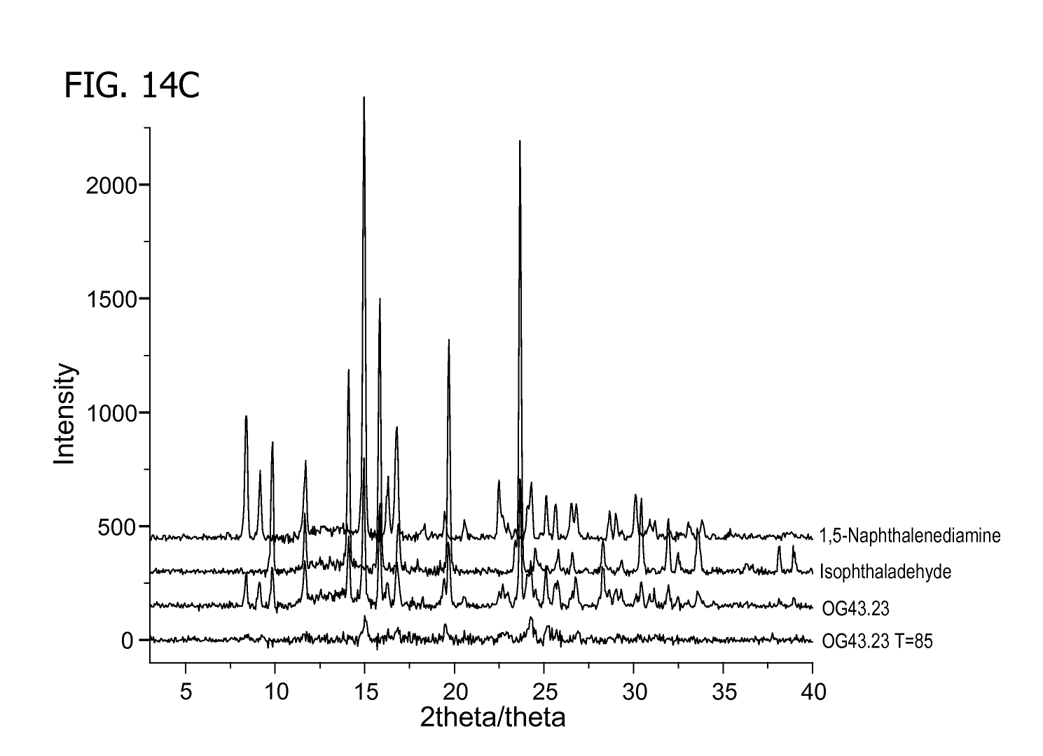

55 mg (0.3 mmol) 1,5-naphthalenediamine and 47 mg (0.3 mmol) isophthaladehyde were placed in a mortar and pestle. 20 μL of methanol was added and the mixture was ground for four minutes at room temperature. This light brown colored product was characterized by IR and PXRD and identified as a mixture. The powder was then transferred to an oven and was heated for 12 hours at 85° C. The resulting yellow powder was characterized by IR and PXRD and identified as an amine. See FIGS. 14A-14C.

### Example 16

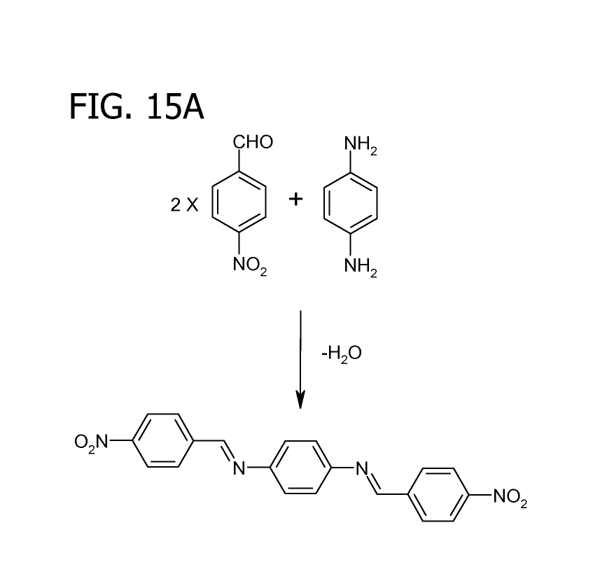

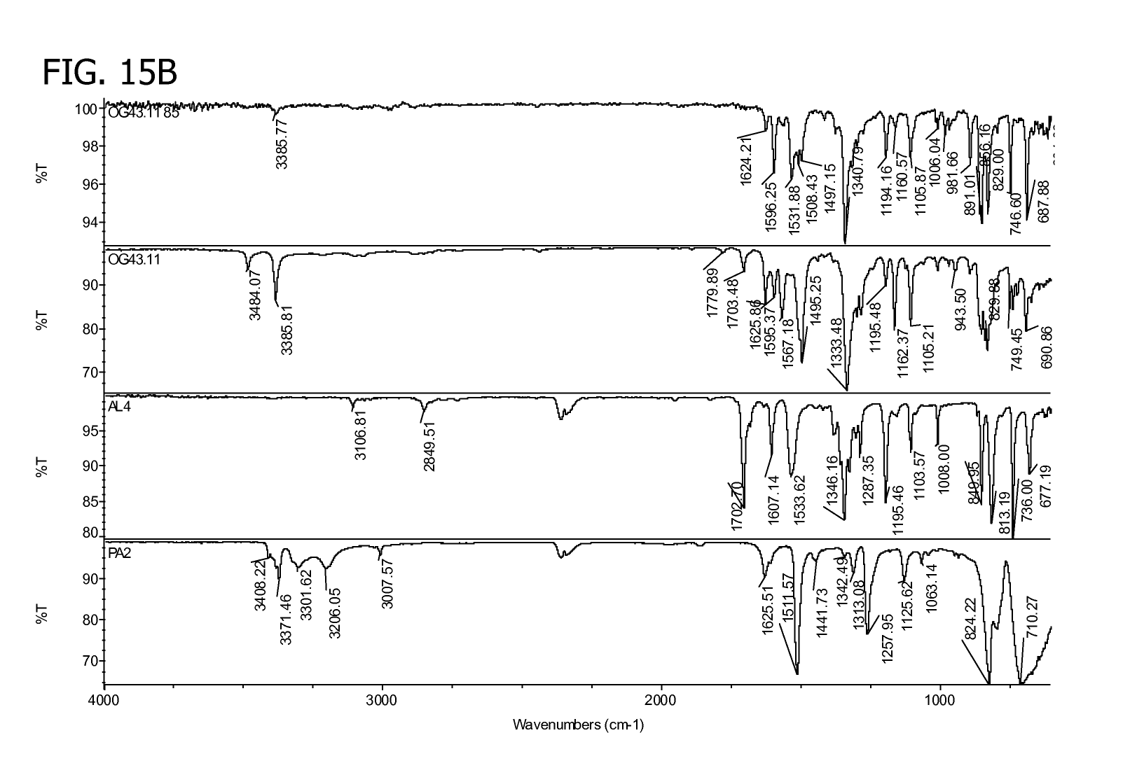

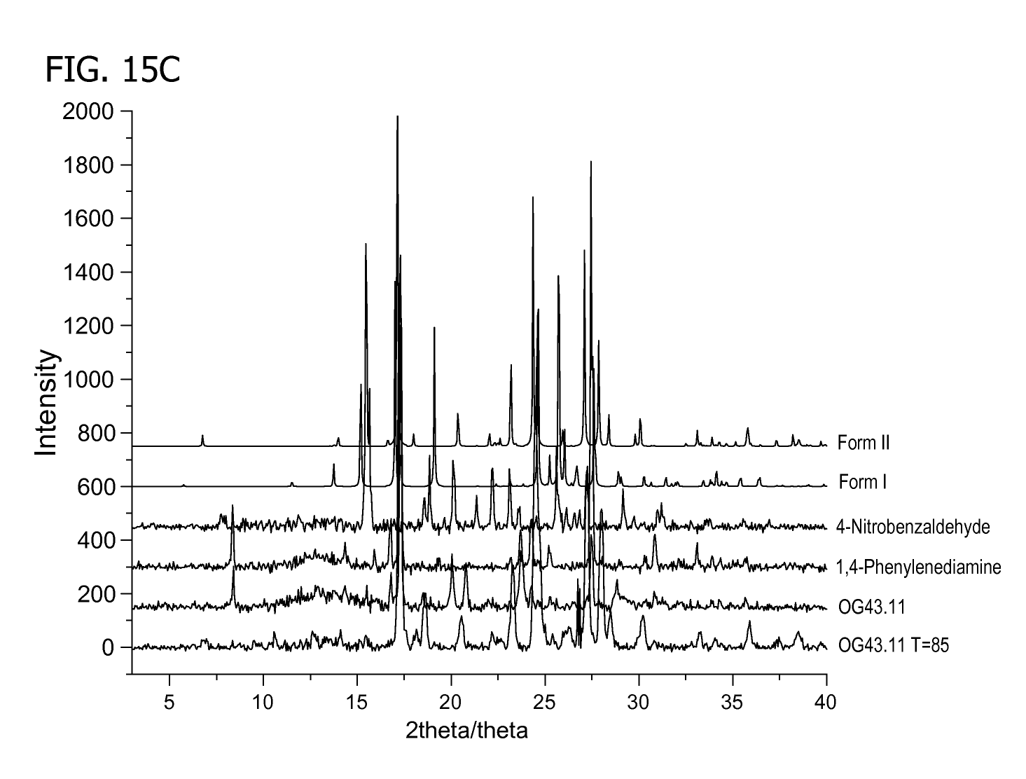

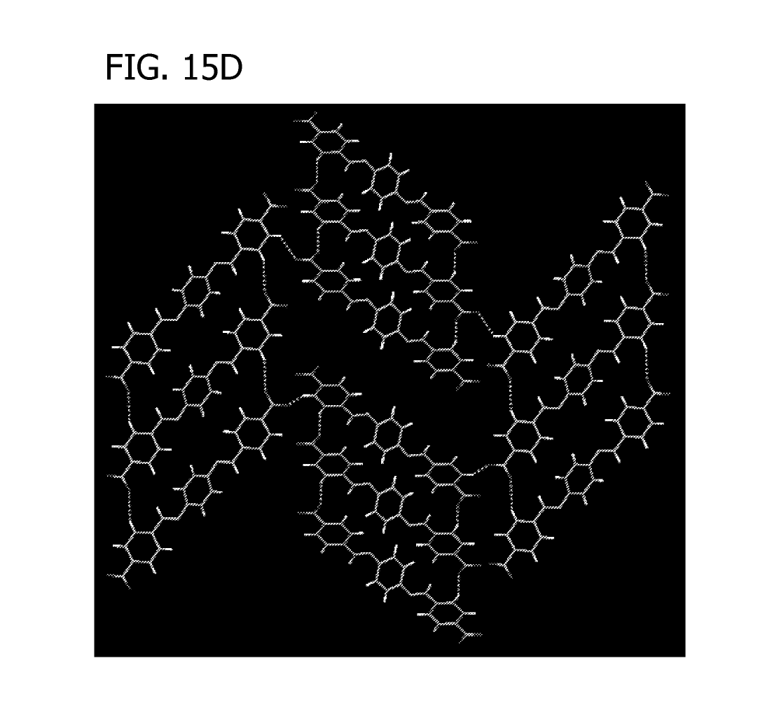

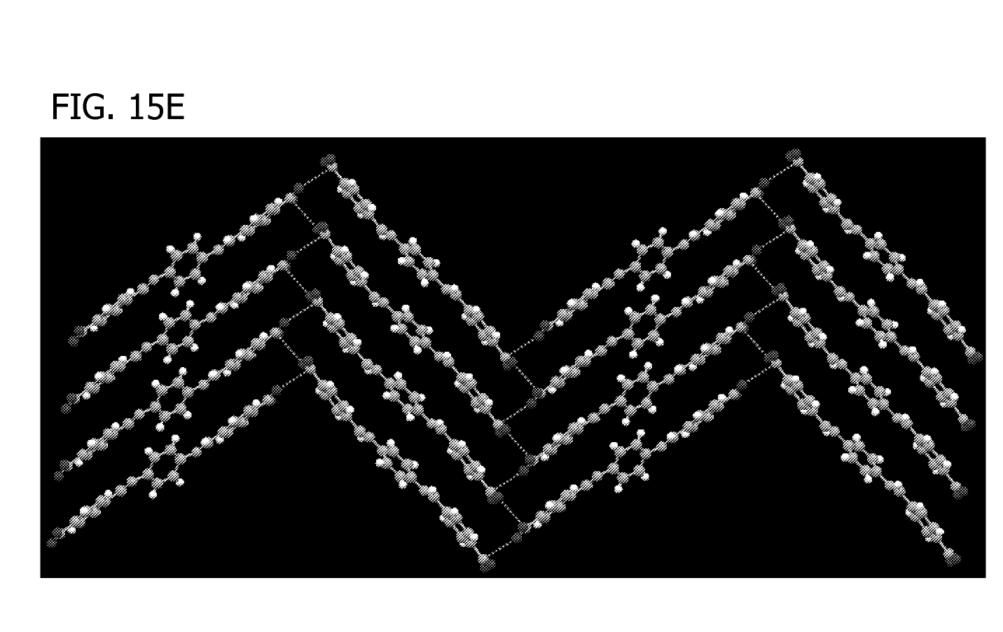

27 mg (0.25 mmol) 1,4-phenylenediamine and 76 mg (0.5 mmol) 4-nitrobenzaldehyde were placed in mortar and pestle. 20 μL methanol solvent was added and the mixture was ground for four minutes at room temperature. The red colored compound was dissolved in ethyl acetate solvent at room temperature. Yellow colored single crystals were obtained after a few days and were characterized by IR, PXRD, and single crystal X-ray diffraction and identified as 4,4′-Di-(p-nitrobenzal)-p-phenylenediamine. The crystal structure shows that the condensation reaction occurred in solution, resulting in 4,4′-Di-(p-nitrobenzal)-p-phenylenediamine (see FIGS. 15A-15D) according to the following reaction:

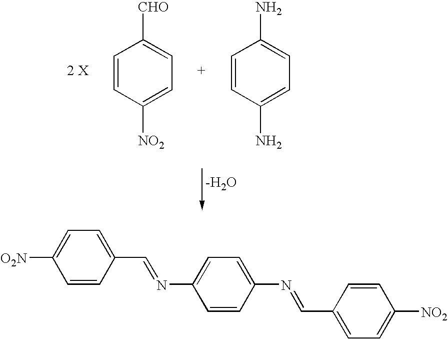

Crystal Details for 4,4′-Di-(p-nitrobenzal)-p-phenylenediamine (form I): Molecular Formula: C₂₀H₁₄N₄O₄; Formula weight: 374.35; Crystal System: Monoclinic; a=3.972(2) Å; b=7.094(4) Å; c=30.750(18) Å; α=90°; β=93.438(11)°; γ=90°; V=865.0(8) Å³; T=298 K; Space group: P2₁/c; Z=2; ρ_{calc}=1.437 Mg m⁻³, μ (Mo—K_{α})=0.103 mm⁻¹, 4382 reflections measured, 1533 unique reflections, 397 observed reflections [I>2σ(I)], R1_obs=0.060, wR2_obs=0.162. Crystal melting point was measured to be about 244.6° C.

### Example 17

27 mg (0.25 mmol) 1,4-phenylenediamine and 76 mg (0.5 mmol) 4-nitrobenzaldehyde were placed in a mortar and pestle. 20 μL of methanol was added and the mixture was ground for four minutes at room temperature. This red colored product was characterized by IR and PXRD and identified as a mixture. The powder was then transferred to an oven and was heated for 12 hours at 85° C. The resulting yellow powder was characterized by IR and PXRD and identified as 4,4′-Di-(p-nitrobenzal)-p-phenylenediamine. The powder was dissolved in acetone solvent. Single crystals were obtained after few days and characterized by IR, PXRD, and single crystal X-ray diffraction. The crystal structure shows the Schiff base, 4,4′-Di-(p-nitrobenzal)-p-phenylenediamine but has different cell parameters and different arrangement of molecules in the crystal structure than in Example 15. See FIGS. 15A-15C and 15E.

Crystal details for 4,4′-Di-(p-nitrobenzal)-p-phenylenediamine (form II): Molecular Formula: C₂₀H₁₄N₄O₄; Formula weight: 374.35; Crystal System: Monoclinic; a=6.578(13) Å; b=5.013(9) Å; c=26.15(6) Å; α=90°; β=91.80(6)°; γ=90°; V=862(3) Å³; T=298 K; Space group: P2₁/n; Z=2; ρ_{calc}=1.442 Mg m⁻¹, μ (Mo—K_{α})=0.104 mm⁻¹, 1924 reflections measured, 1409 unique reflections, 420 observed reflections [I>2σ(I)], R1_obs=0.049, wR2_obs=0.150. Crystal melting point was measured to be about 244.3° C.

### Example 18

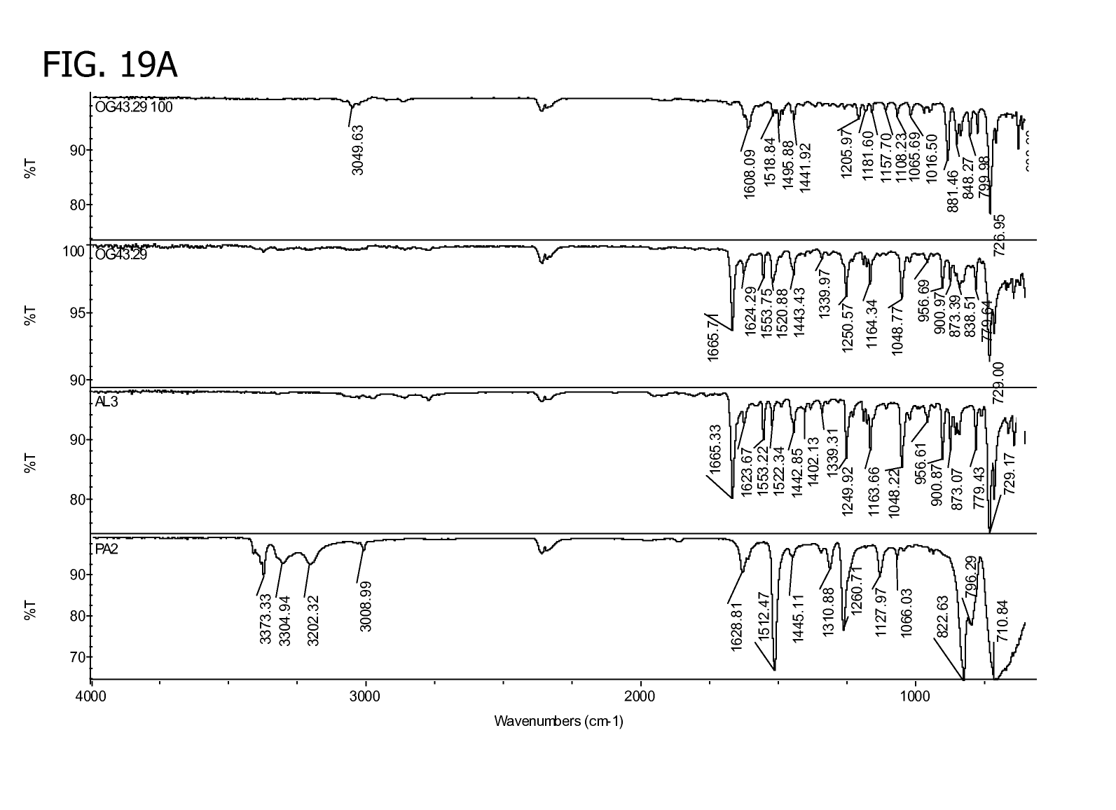

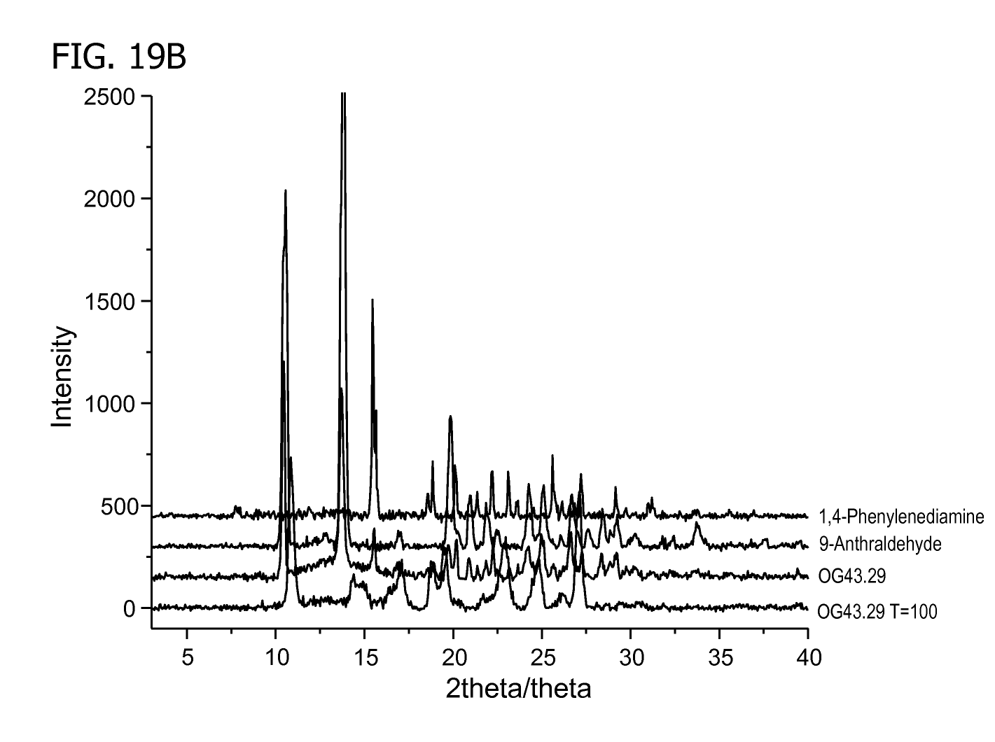

1,4-phenylenediamine (22 mg, 2·10⁻³ mol) and 9-anthraldehyde (82 mg, 4·10⁻³ mol) were placed in a mortar and pestle. 21 μL of methanol was added and the mixture was ground for four minutes at room temperature. This yellow product was characterized by IR and PXRD. The powder was then transferred to an oven and was heated for 12 hours at 100° C. The resulting brown-yellow powder was characterized by IR and PXRD and identified as N,N′-bis(9-anthracenylmethylene)-1,4-benzenediamine. See FIGS. 19A and 19B where PA2 is 1,4-phenylenediamine, AL3 is 9-anthraldehyde, OG43.29 is solvent drop grind and OG43.29 100 is product at 100° C.

### Example 19

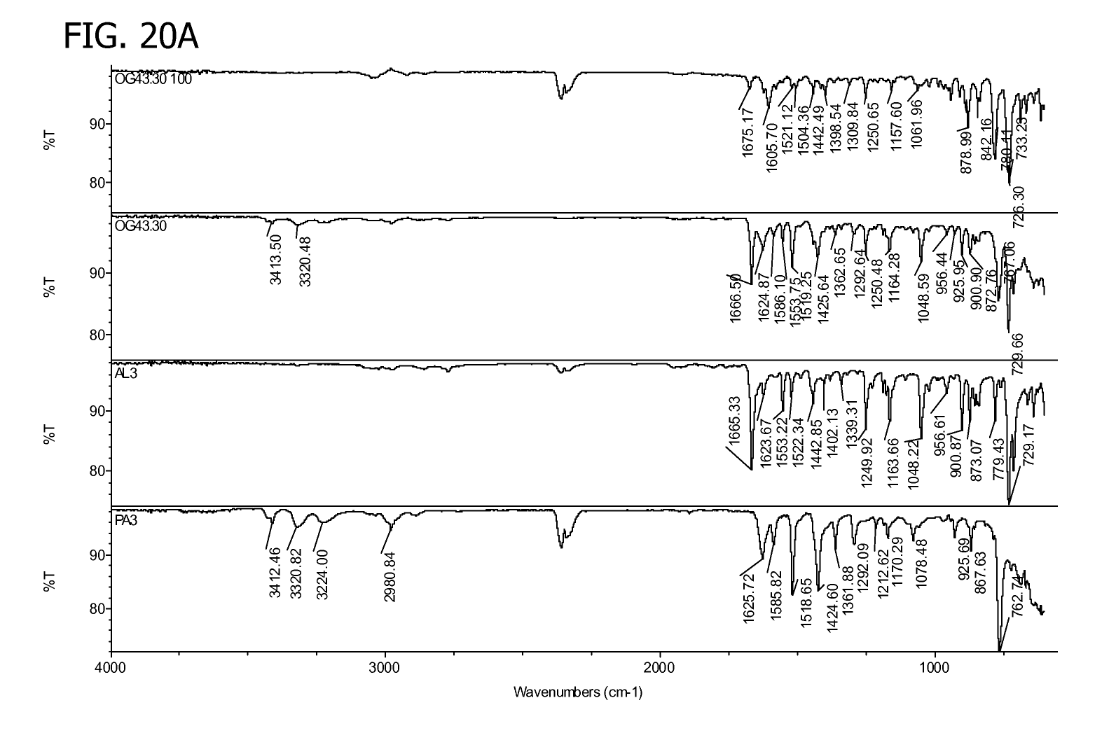

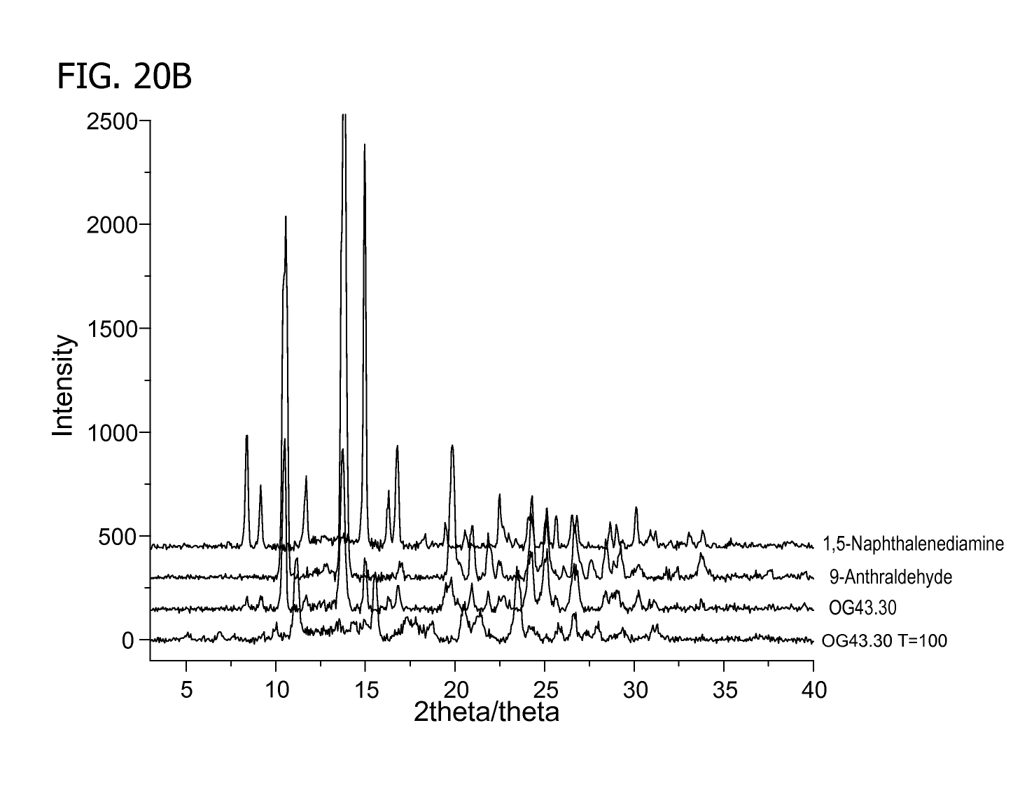

1,5-Naphthalenediamine (31 mg, 2·10⁻³ mol) and 9-anthraldehyde (82 mg, 4·10⁻³ mol) were placed in a mortar and pestle. 23 μL of methanol was added and the mixture was ground for four minutes at room temperature. This yellow product was characterized by IR and PXRD. The powder was then transferred to an oven and was heated for 12 hours at 100° C. The resulting dark-yellow powder was characterized by IR and PXRD and identified as N,N′-bis(9-anthracenylmethylene)-1,5-napthalenediamine. See FIGS. 20A and 20B where PA3 is 1,5-Naphthalenediamine, AL3 is 9-anthraldehyde, OG43.30 is solvent drop grind and OG43.30 100 is product at 100° C.

### Example 20

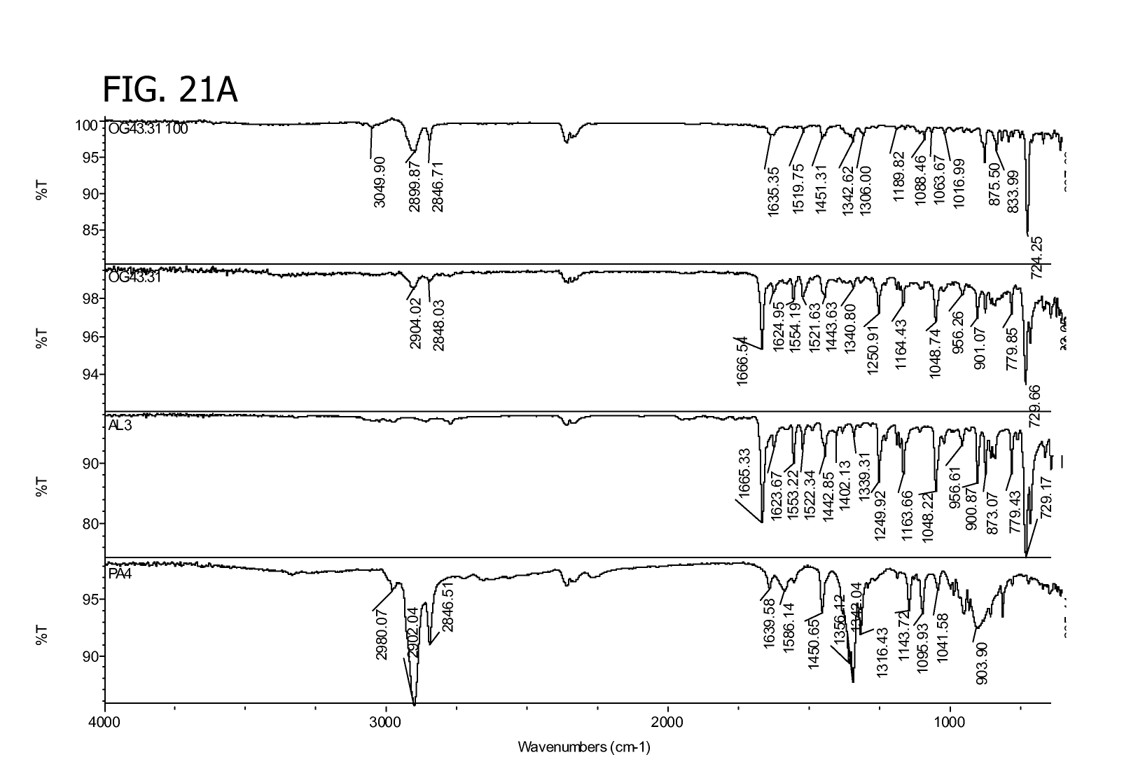

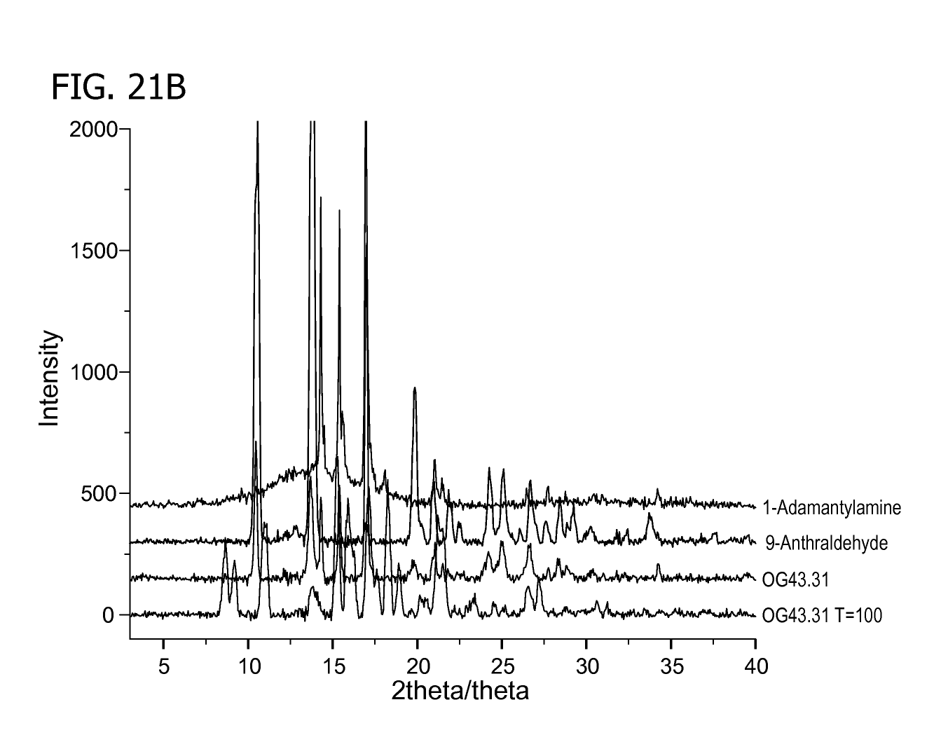

1-adamantylamine (45 mg, 3·10⁻³ mol) and 9-anthraldehyde (62 mg, 3·10⁻³ mol) were placed in a mortar and pestle. 21 μL of methanol was added and the mixture was ground for four minutes at room temperature. This yellow product was characterized by IR and PXRD. The powder was then transferred to an oven and was heated for 12 hours at 100° C. The resulting light-yellow powder was characterized by IR and PXRD. See FIGS. 21A and 21B where PA3 is 1-adamantylamine, AL3 is 9-anthraldehyde, OG43.31 is solvent drop grind and OG43.31 100 is product at 100° C.

### Example 21

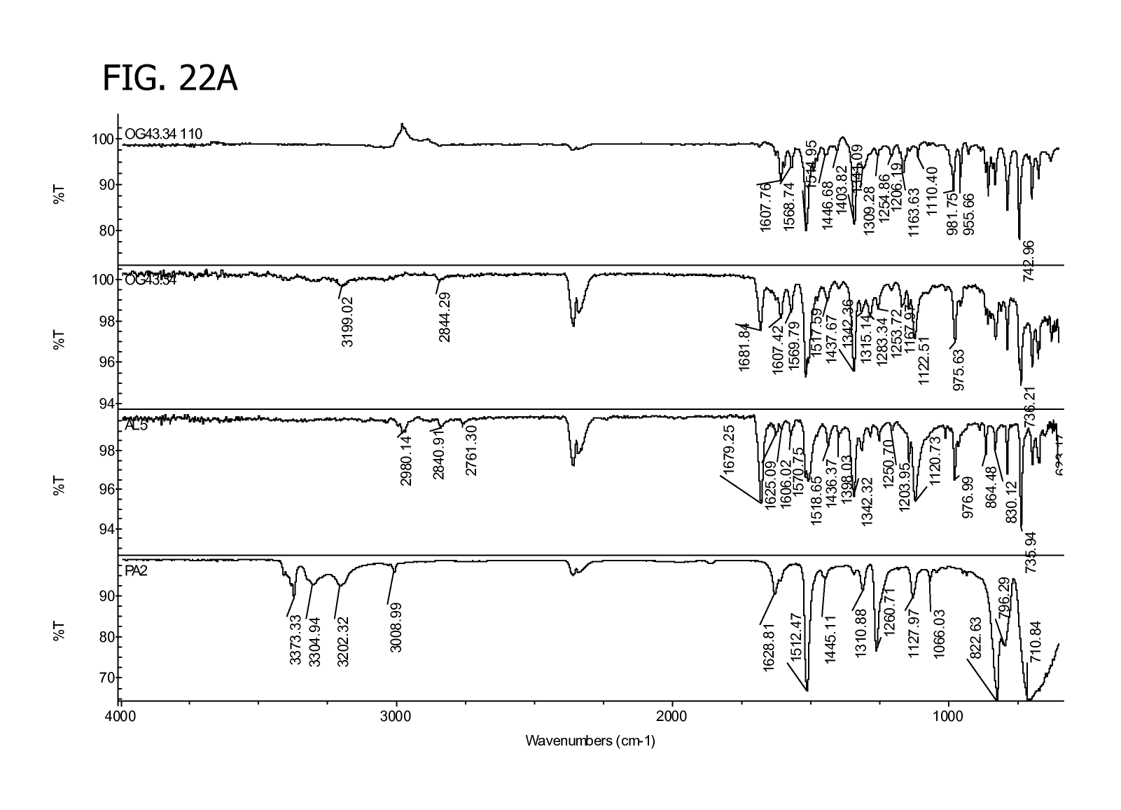

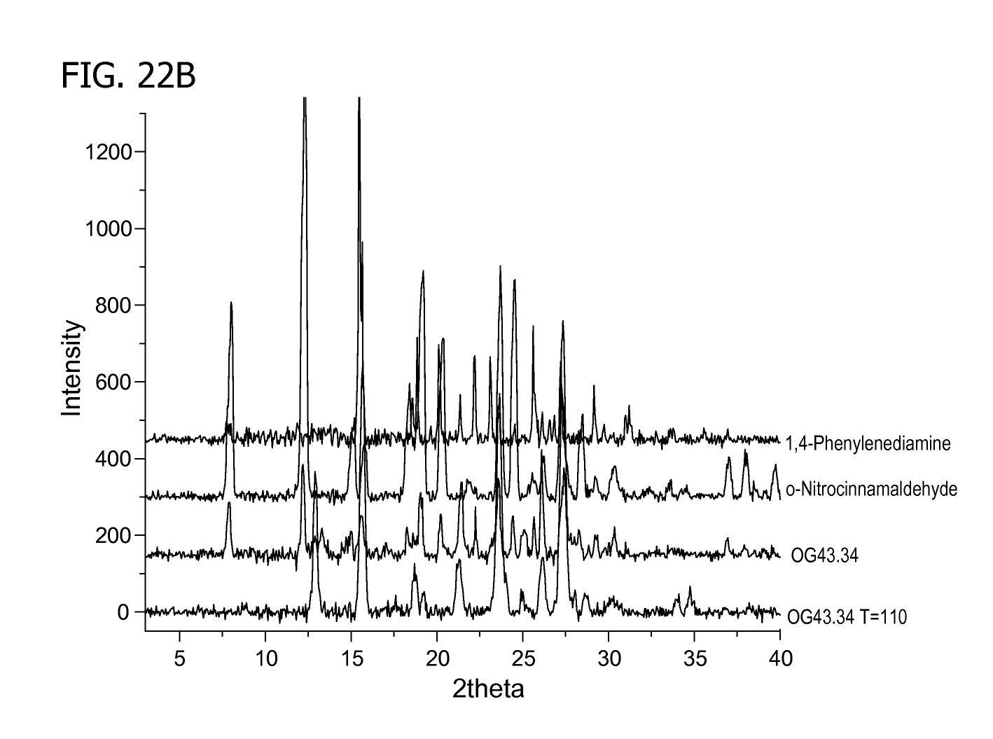

1,4-phenylenediamine (22 mg, 2·10⁻³ mol) and o-nitrocinnamaldehyde (71 mg, 4·10⁻³ mol) were placed in a mortar and pestle. 19 μL of methanol was added and the mixture was ground for four minutes at room temperature. This yellow product was characterized by IR and PXRD. The powder was then transferred to an oven and was heated for 12 hours at 110° C. The resulting orange powder was characterized by IR and. See FIGS. 22A and 22B where PA2 is 1,4-phenylenediamine, AL5 is o-nitrocinnamaldehyde, OG43.34 is solvent drop grind and OG43.34 110 is product at 110° C.

### Example 22

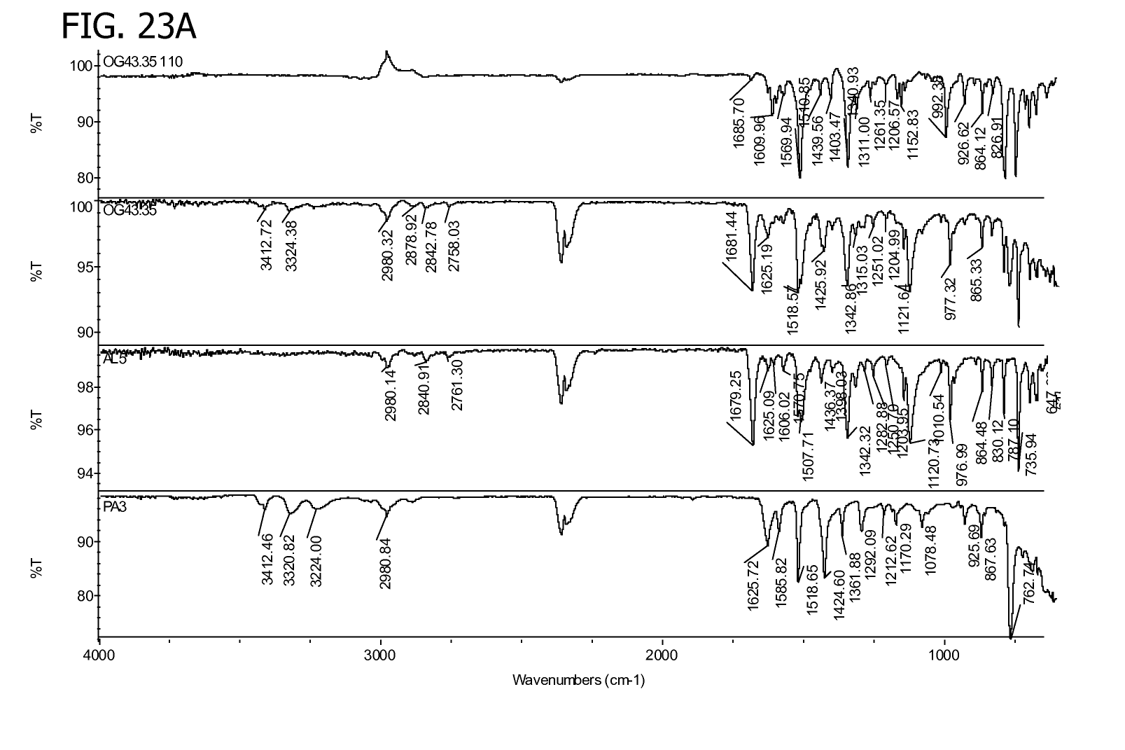

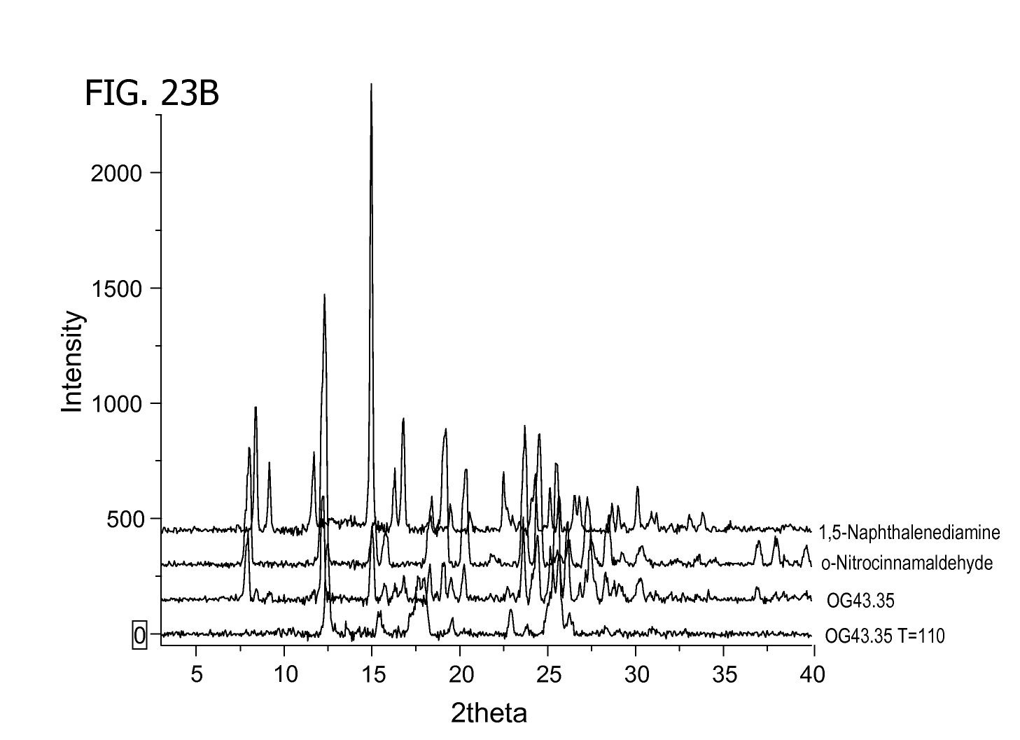

1,5-naphthalenediamine (31 mg, 2·10⁻³ mol) and o-nitrocinnamaldehyde (71 mg, 4·10⁻³ mol) were placed in a mortar and pestle. 20 μL of methanol was added and the mixture was ground for four minutes at room temperature. This yellow product was characterized by IR and PXRD. The powder was then transferred to an oven and was heated for 12 hours at 110° C. The resulting dark-yellow powder was characterized by IR and PXRD. See FIGS. 23A and 23B where PA3 is 1,5-naphthalenediamine, AL5 is o-nitrocinnamaldehyde, OG43.35 is solvent drop grind and OG43.35 110 is product at 110° C.

### Example 23

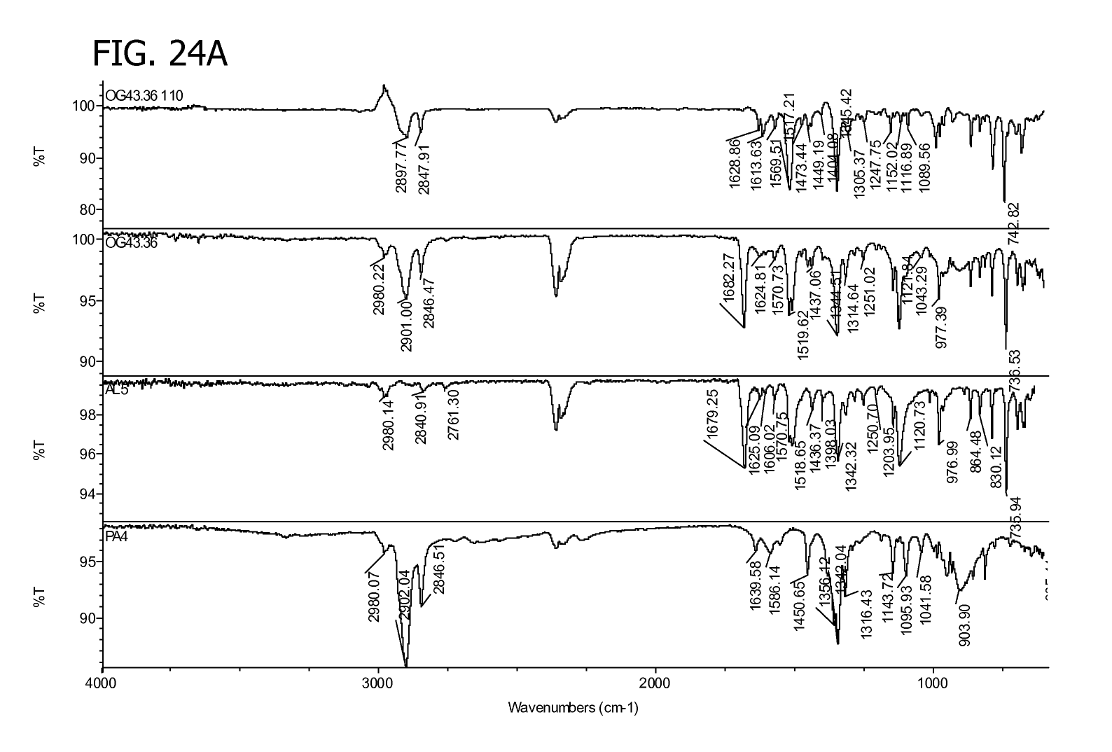

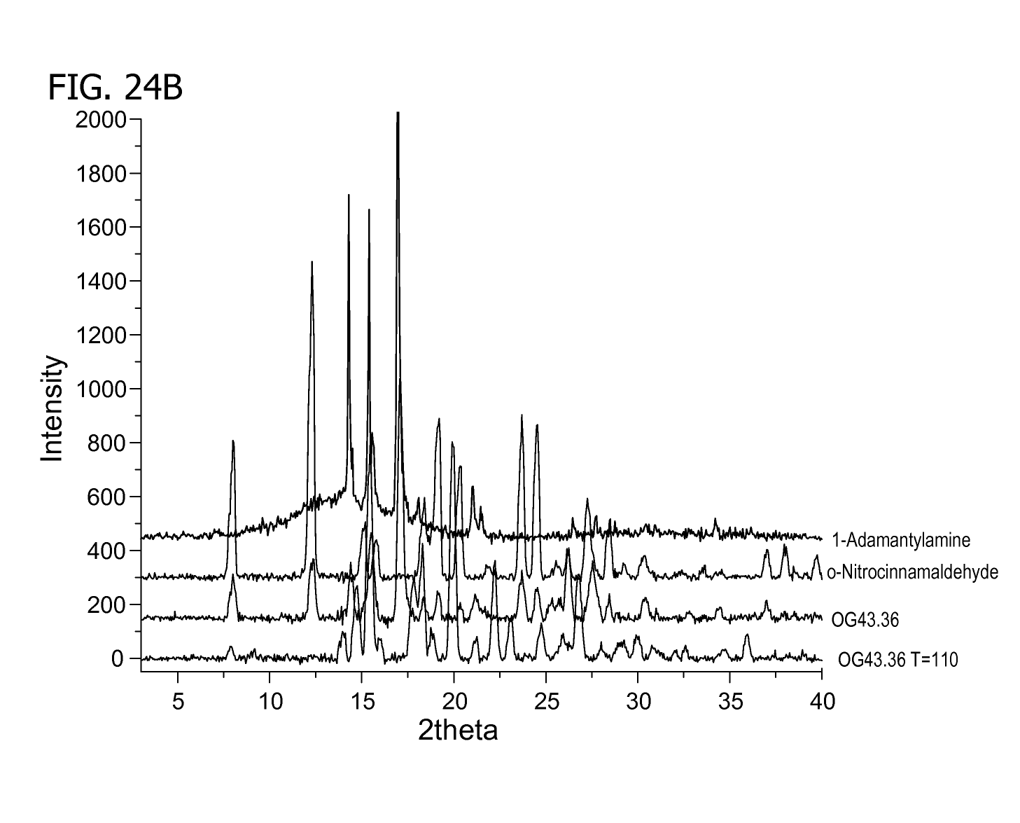

1-adamantylamine (61 mg, 4·10⁻³ mol) and o-nitrocinnamaldehyde (71 mg, 4·10⁻³ mol) were placed in a mortar and pestle. 26 μL of methanol was added and the mixture was ground for four minutes at room temperature. This white-yellow product was characterized by IR and PXRD. The powder was then transferred to an oven and was heated for 12 hours at 110° C. The resulting brown powder was characterized by IR and PXRD. See FIGS. 24A and 24B where PA4 is 1-adamantylamine, AL5 is o-nitrocinnamaldehyde, OG43.36 is solvent drop grind and OG43.36 110 is product at 110° C.

### Example 24

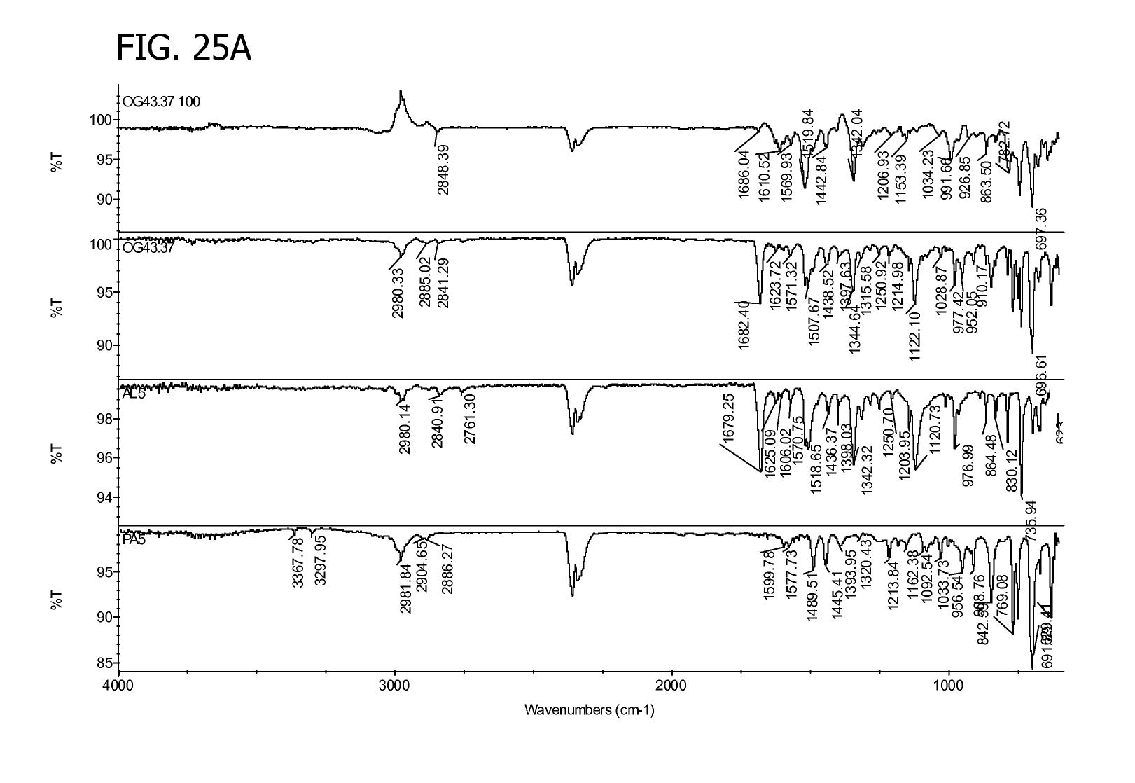

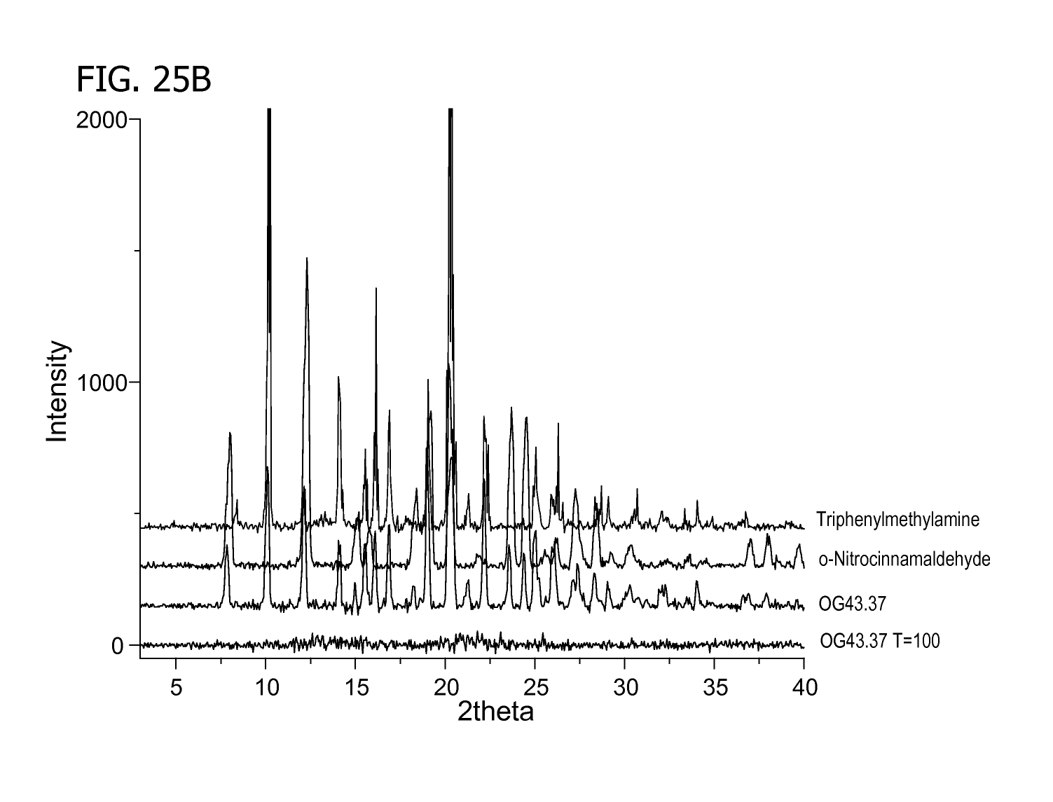

Triphenylmethylamine (78 mg, 3·10⁻³ mol) and o-nitrocinnamaldehyde (53 mg, 3·10⁻³ mol) were placed in a mortar and pestle. 26 μL of methanol was added and the mixture was ground for four minutes at room temperature. This white-yellow product was characterized by IR and PXRD. The powder was then transferred to an oven and was heated for 12 hours at 100° C. The resulting white-yellow powder was characterized by IR and PXRD. See FIGS. 25A and 25B where PA5 is triphenylmethylamine, AL5 is o-nitrocinnamaldehyde, OG43.37 is solvent drop grind and OG43.37 100 is product at 100° C.

### Example 25

Various acid anhydrides (identified as AA1 to AA7 below) and primary amines (identified as PA1 to PA7 below) were evaluated in combination for co-crystal formation and condensation reaction product formation.

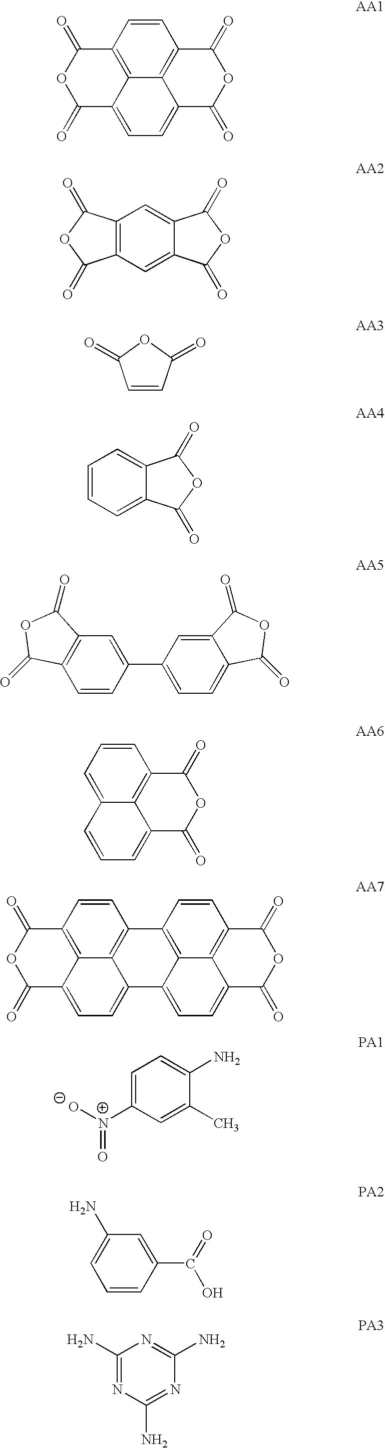

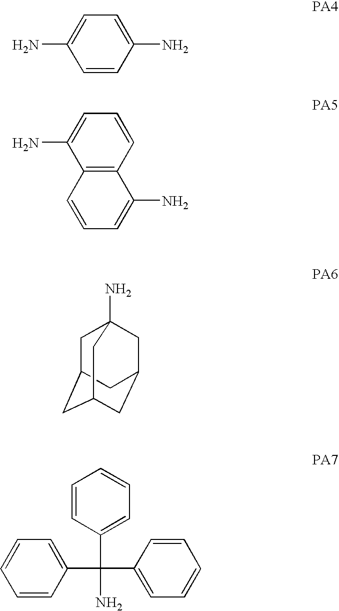

The reaction parameters and conditions are indicated in Table 3 below where “Rx.” indicates the reaction number, “Anhy.” represents anhydride and the Ratio is the ratio of amine to anhydride. Each reaction was evaluated independently in each of chloroform, cyclohexane, ethyl acetate, methanol, toluene, water, DMSO and DMF solvents.

TABLE 3

| Rx. | Amine | Anhy. | Ratio | Reaction conditions |
|---|---|---|---|---|
| 1 | PA1 | AA1 | 2:1 | Solvent drop grind and heating for |
| | | | | 3 hrs at 180° C. |
| 2 | PA2 | AA1 | 2:1 | Solvent drop grind and heating for |
| | | | | 14 hrs at 150° C. |
| 3 | PA3 | AA2 | 2:3 | Solvent drop grind, heat 75 hrs at |
| | | | | 180° C. and 26 hrs at 150° C. |
| 4 | PA4 | AA2 | 5:1 | Solvent drop grind, heat 68 hrs at |
| | | | | 180° C. |
| 5 | PA4 | AA5 | 5:1 | Solvent drop grind, heat 68 hrs at |
| | | | | 180° C. |
| 6 | PA5 | AA1 | 5:1 | Solvent drop grind, heat 68 hrs at |
| | | | | 180° C. |
| 7 | PA5 | AA6 | 5:1 | Solvent drop grind, heat 68 hrs at |
| | | | | 180° C. |
| 8 | PA5 | AA5 | 5:1 | Solvent drop grind, heat 68 hrs at |
| | | | | 180° C. |
| 9 | PA6 | AA4 | 1:1 | Solvent drop grind, heat 144 hrs at |
| | | | | 120° C. |
| 10 | PA6 | AA3 | 1:1 | Solvent drop grind, heat 19.5 hrs at |
| | | | | 120° C. |
| 11 | PA7 | AA2 | 1:1 | Solvent drop grind, heat 48 hrs at |
| | | | | 140° C. |
| 12 | PA7 | AA5 | 1:1 | Solvent drop grind, heat 45 hrs at |
| | | | | 140° C. + 29 hrs at 180° C. |
| 13 | PA3 | AA3 | 1:3 | Solvent drop grind, heat 23 hrs at |
| | | | | 115° C. |
| 14 | PA4 | AA3 | 1:2 | Solvent drop grind, heat 23 hrs at |
| | | | | 115° C. |
| 15 | PA5 | AA3 | 1:2 | Solvent drop grind, heat 23 hrs at |
| | | | | 115° C. |
| 16 | PA7 | AA3 | 1:1 | Solvent drop grind, heat 23 hrs at |
| | | | | 115° C. |
| 17 | PA5 | AA2 | 1:1 | Solvent drop grind, heat 107 hrs at |
| | | | | 120° C. |
| 18 | PA3 | AA4 | 1:3 | Solvent drop grind, heat 23 hrs at |
| | | | | 115° C. |
| 19 | PA4 | AA4 | 1:2 | Solvent drop grind, heat 5 hrs at |
| | | | | 115° C. |
| 20 | PA4 | AA6 | 1:2 | Solvent drop grind, heat 64 hrs at |
| | | | | 150° C. |
| 21 | PA4 | AA1 | 1:1 | Solvent drop grind, heat for 5 hrs |
| | | | | at 115° C. |
| 22 | PA5 | AA4 | 1:2 | Solvent drop grind, heat for 19 |
| | | | | hours at 115° C. |
| 23 | PA7 | AA4 | 1:1 | Solvent drop grind, heat for 26 |
| | | | | hours at 115° C. |
| 24 | PA1 | AA4 | 1:1 | Solvent drop grind, heat for 3 hours |
| | | | | at 150° C. |
| 25 | PA1 | AA2 | 2:1 | Solvent drop grind, heat for 14 |
| | | | | hours at 130° C. |
| 26 | PA1 | AA5 | 2:1 | Solvent drop grind, heat for 21 |
| | | | | hours at 120° C. |
| 27 | PA1 | AA3 | 1:1 | Solvent drop grind, heat for 40 |
| | | | | hours at 60° C. |
| 28 | PA2 | AA4 | 1:1 | Solvent drop grind, heat for 26 |
| | | | | hours at 150° C. |
| 29 | PA2 | AA2 | 2:1 | Solvent drop grind, heat for 16 |
| | | | | hours at 180° C. |
| 30 | PA2 | AA6 | 1:1 | Solvent drop grind, heat for 23 |
| | | | | hours at 150° C. |
| 31 | PA2 | AA5 | 2:1 | Solvent drop grind, heat for 14 |
| | | | | hours at 150° C. |
| 32 | PA2 | AA3 | 1:1 | Solvent drop grind, heat for 19 |
| | | | | hours at 150° C. |

Each reaction was evaluated for co-crystal formation and product formation by Infrared Spectrum analysis over a wavenumber range of about 500 to about 4000 cm⁻¹ and by X-ray powder diffraction (XPD). Reactions 1, 2 and 25 resulted in co-crystal formation while co-crystal formation was not observed for reactions 3-24 and 26-32.

In reaction 1, where the 1,4,5,8-naphthalenetetracarboxylic dianhydride (NTCDA) and 2-methyl-4-nitroaniline (MNA) were solvent drop-grinded with DMF in a 1:1 stoichiometric ratio, the co-crystal was heated at 180° C. for 3 hours. The condensation reaction product was generated by the following reaction:

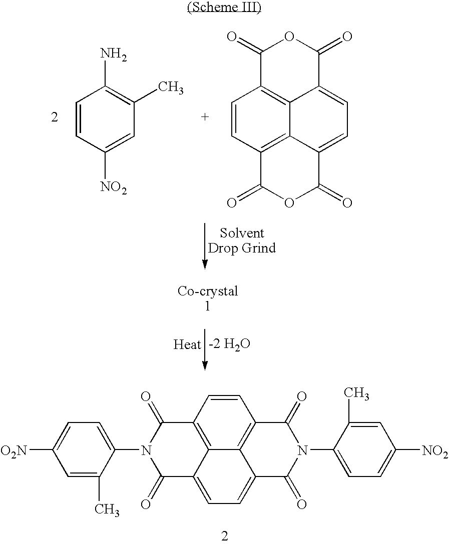

The product was characterized by TGA, IR, and PXRD and identified as 2,7-bis(2-methyl-4-nitrophenyl-benzo[3,8]phenanthroline-1,3,6,8(2H,7H)-tetrone. See FIGS. 17A-17N and Scheme III shown above.

The reaction 1 DMF drop grind was observed to be purple in color at room temperature and orange in color upon further heating to about 158° C. DSC analysis over a temperature range of about 25° C. to about 350° C. is shown in FIG. 17K. A phase transition from a co-crystal morphology to the reaction product was observed at about 158° C. The color changes observed correspond to the phase transitions indicated in the DSC results.

In reaction 1, where the 1,4,5,8-naphthalenetetracarboxylic dianhydride (NTCDA) and 2-methyl-4-nitroaniline (MNA) were solvent drop-grinded with methanol in a 1:1 stoichiometric ratio, the co-crystal was heated at 180° C. for 3 hours. The condensation reaction product was generated by the above reaction. The drop grind was observed to be yellow in color at room temperature, purple in color upon heating to about 130° C. and orange in color upon further heating to about 156° C. DSC analysis over a temperature range of about 25° C. to about 350° C. is shown in FIG. 17L. A first phase transition from a solid-phase combination to a co-crystal morphology was observed at about 130° C. and a second phase transition from the co-crystal to the reaction product was observed at about 156° C. The color changes observed correspond to the phase transitions indicated in the DSC results.

In reaction 2, where 1,4,5,8-naphthalenetetracarboxylic dianhydride (NTCDA) and 3-aminobenzoic acid (ABA) were solvent drop-grinded with DMF in a 1:1 stoichiometric ratio, the co-crystal was heated, and the resulting product was characterized by TGA, IR, and PXRD. The condensation reaction product was generated by the following reaction:

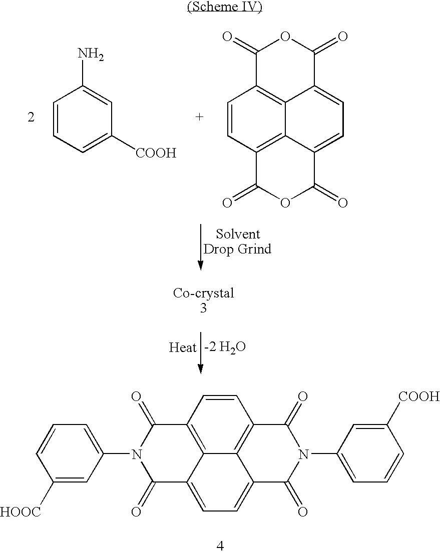

The product was characterized by TGA, IR, and PXRD and identified as 3,3′-(1,3,6,8-tetrahydro-1,3,6,8-tetraoxobenzo[3,8]phenanthroline-2,7-diyl)bis-benzoic acid. See FIGS. 18A-18O and Scheme IV shown above.

The reaction 2 DMF drop grind was analyzed by DSC over a temperature range of about 25° C. to about 350° C. is shown in FIG. 18L. A first phase transition from a solid-phase combination to a co-crystal morphology was observed at about 127° C. and a second phase transition from the co-crystal to the reaction product was observed at about 185° C.

The reaction 2 methanol drop grind was analyzed by DSC over a temperature range of about 25° C. to about 350° C. is shown in FIG. 18M. A first phase transition from a solid-phase combination to a co-crystal morphology was observed at about 156° C. and a second phase transition from the co-crystal to the reaction product was observed at about 167° C.

The reaction 25 co-crystal, afforded from a 1:1 mixture of chloroform and ethyl acetate, was analyzed for composition and structure. The molecular formula was determined to be C₁₂H₉N₂O₅ and the formula weight was determined to be 261.21. The crystal system was determined to be: Monoclinic; a=7.373(3) Å; b=13.969(6) Å; c=11.025(3) Å; β=93.695(8)°; V=1133.2(7) Å³; T=100(2) K; Space group: P21/n; Z=4; ρ_{calc}=1.531 Mg m-3, μ (Mo—Kα)=0.122 mm-1, 2623 reflections measured, 1361 unique reflections, [I>2σ(I)], R1-obs=0.0593, wR2-obs=0.1405. Crystal size=0.13×0.09×0.05 mm³.

The reaction 25 imide condensation reaction product (in DMF solvent) was analyzed for composition and structure. The molecular formula was determined to be C₂₄H₁₄N₄O₈ and the formula weight was determined to be 486.39. The crystal system was determined to be: Monoclinic; a=8.207(4) Å; b=16.594(8) Å; c=7.753(4) Å; β=92.169(9)°; V=1055.1(8) Å³; T=100(2) K; Space group: P21/c; Z=2; ρcalc=1.531 Mg m-3, μ (Mo—Kα)=0.118 mm-1, 2622 reflections measured, 985 unique reflections, [I>2σ(I)], R1-obs=0.0766, wR2-obs=0.1667. Crystal size=0.19×0.08×0.06 mm³.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained. As various changes could be made in the compositions and processes without departing from the scope of the invention, it is intended that all matter contained in the above description and shown in the accompanying drawing[s] shall be interpreted as illustrative and not in a limiting sense.

What is claimed is:

1. A process for the preparation of a condensation reaction product, the process comprising inducing a condensation reaction between a first reactant and a second reactant, the first and second reactants being different and members of a solid-phase combination, the condensation reaction producing a condensation reaction product and a small molecule by-product.

2. The process of claim 1 wherein the first reactant, second reactant, condensation reaction product and small molecule by-product are selected from one of combinations A1-H1 of the following table

| | | | Condensation | Small |
|---|---|---|---|---|
| | First | Second | reaction | molecule |
| Combination | Reactant | Reactant | product | by-product |
| A1 | ester | amine | amide | alcohol |
| B1 | acid halide | amine | amide | HX, X is a |
| | | | | halogen |
| C1 | carboxylic | amine | amide | water |
| | acid | | | |
| D1 | halide | amine | secondary | HX, X is a |
| | | | amine | halogen |
| E1 | carboxylic | alcohol | ester | water |
| | acid | | | |
| F1 | anhydride | amine | imide | water |
| G1 | aldehyde | amine | imine | water |
| H1 | ketone | amine | imine | water |
| I1 | lactone | amine | lactam | water |

3. The process of claim 1 wherein the condensation reaction product contains the residue of at least two first reactants or at least two second reactants.

4. The process of claim 1 wherein the first reactant and the second reactant are monomers and the condensation reaction product is a condensation polymer of the first and second reactants.

5. The process of claim 1 wherein the first reactant, second reactant, condensation reaction product and small molecule by-product are selected from one of combinations A2-H2 of the following table.

| | | | Condensation | Small |
|---|---|---|---|---|
| | First | Second | reaction | molecule |
| Combination | Reactant | Reactant | product | by-product |
| A2 | diester | diamine | polyamide | alcohol |
| B2 | diacid | diamine | polyamide | HX, X is |
| | halide | | | a halogen |
| C2 | dicarboxylic | diamine | polyamide | water |
| | acid | | | |
| D2 | halide | diamine | diamine | HX, X is |
| | | | | a halogen |
| E2 | dicarboxylic | diol | polyester | water |
| | acid | | | |
| F2 | dianhydride | diamine | polyimide | water |
| G2 | dialdehyde | diamine | polyimine | water |
| H2 | diketone | diamine | polyimine | water |

6. The process of claim 5 wherein the solid phase combination is in the form of a paste.

7. The process of claim 5 wherein the solid phase combination is in the form of a free-flowing particulate mass.

8. The process of claim 2 wherein the solid-phase combination is heated to a temperature of form about 25° C. to about 200° C. to induce the reaction.

9. A co-crystal comprising a first reactant and a second reactant, the first and second reactants being different and capable of reacting in a condensation reaction to produce a condensation reaction product and a small molecule by-product.

10. The co-crystal of claim 9 wherein the first reactant, second reactant, condensation reaction product and small molecule by-product are selected from one of combinations A1-H1 of the following table

| | | | Condensation | Small |
|---|---|---|---|---|
| | First | Second | reaction | molecule |
| Combination | Reactant | Reactant | product | by-product |
| A1 | ester | amine | amide | alcohol |
| B1 | acid halide | amine | amide | HX, X is a |
| | | | | halogen |
| C1 | carboxylic | amine | amide | water |
| | acid | | | |
| D1 | halide | amine | secondary | HX, X is a |
| | | | amine | halogen |
| E1 | carboxylic | alcohol | ester | water |
| | acid | | | |
| F1 | anhydride | amine | imide | water |
| G1 | aldehyde | amine | imine | water |
| H1 | ketone | amine | imine | water |
| I1 | lactone | amine | lactam | water |

11. The co-crystal of claim 10 wherein the condensation reaction product contains the residue of at least two first reactants or at least two second reactants.

12. The co-crystal of claim 10 wherein the first reactant and the second reactant are monomers and the condensation reaction product is a condensation polymer of the first and second reactants.

13. The co-crystal of claim 9 wherein the first reactant, second reactant, condensation reaction product and small molecule by-product, in combination, are selected from combinations A2-H2 of the following table

| | | | Condensation | Small |
|---|---|---|---|---|
| | First | Second | reaction | molecule |
| Combination | Reactant | Reactant | product | by-product |
| A2 | diester | diamine | polyamide | alcohol |
| B2 | diacid | diamine | polyamide | HX, X is |
| | halide | | | a halogen |
| C2 | dicarboxylic | diamine | polyamide | water |
| | acid | | | |
| D2 | halide | diamine | diamine | HX, X is |
| | | | | a halogen |
| E2 | dicarboxylic | diol | polyester | water |
| | acid | | | |
| F2 | dianhydride | diamine | polyimide | water |
| G2 | dialdehyde | diamine | polyimine | water |
| H2 | diketone | diamine | polyimine | water |
